(19) United States
(12) Patent Application Publication
(10) Pub. No.: US 2017/0147956 A1
(43) Pub. Date: May 25, 2017

(54) METHOD AND SYSTEM FOR CONFIGURING AND PROCESSING REQUESTS THROUGH WORKFLOW APPLICATIONS

(71) Applicant: Optymyze PTE, Ltd., Singapore (SG)

(72) Inventors: Mark A. STIFFLER, Chester, PA (US); Anne LUONGO, Chester, PA (US); Marissa ARNEY, Chester, PA (US); Vinit MANJARDEKAR, Chester, PA (US)

(21) Appl. No.: 15/422,120

(22) Filed: Feb. 1, 2017

Related U.S. Application Data
(63) Continuation of application No. 13/890,430, filed on May 9, 2013.

(51) Int. Cl. G06Q 10/06; G06F 3/0484; G06F 3/0482

(52) U.S. Cl. CPC G06Q 10/06316; G06Q 10/06311; G06F 3/0482; G06F 3/04847

(57) ABSTRACT

A computer-implemented method of creating a workflow application is disclosed, including the steps of presenting a graphical user interface via a display device, receiving a user input specifying a request type representing a framework of information to be provided by an end user for a request to be acted on, receiving a user input specifying a task assignment representing an entity to which a task is assigned, and associating the task assignment with the request type. The method further includes the steps of receiving a user input specifying an action to be performed on the request by the entity to which the task is assigned, associating the action with the task assignment, and presenting a diagram within the graphical user interface to visually represent the request type, task assignment, and action as individual nodes.

### CROSS-REFERENCE TO RELATED APPLICATIONS

This application is a continuation of U.S. patent application Ser. No. 13/890,430, filed on May 9, 2013, entitled “Method and System for Configuring and Processing Requests through Workflow Application,” currently pending, the entire contents of which are incorporated by reference herein.

### FIELD OF INVENTION

This application is generally related to methods and systems for configuring workflow applications, and more particularly related to a computerized method and system for configuring workflow applications in sales performance management solutions and processing user requests through such workflow applications.

### BACKGROUND

Businesses and other organizations often require various tasks or procedures to be carried by individuals, departments, or other actors, both within and outside of the organization. These sequences of tasks or procedures are commonly referred to as “workflows” or “workflow processes.” A workflow process is generally made up of a series of related operations that may include some form of input/output information, and action taken with respect to the input/output information. Broadly defined, a workflow is a process through which a task or piece of work is carried out from a starting to a finish point. The use of workflow processes are widespread in various industries, and may be embodied in manual or automated forms. For example, a company policy for approving expenses may be represented as a workflow process, in which a party submits an expense for approval, along with any required supporting documentation, to a party with the proper authority to approve the request. The authorized party then makes a decision regarding the request, thus completing the workflow process. Such a workflow process may be carried out entirely manually by the parties involved, or may be aided by a workflow system, such as special software, that allows the request and approval to be conducted electronically. Portions of the workflow process may also be automated by the system, such as automatic routing or decision making based on various parameters of the request.

Within the field of sales performance management (SPM), which includes a wide array of different and interrelated business applications, there is often a need to configure and manage a variety of workflow processes, which may operate independently or collectively to carry out tasks. SPM applications may be directed to the areas of sales compensation management (SCM), sales analytics, data management, reporting, customized alerts and dashboards, and other business operations. SPM solutions, including computer software, often include specific workflow systems for configuring and managing the organization's workflow processes. Together with other SPM applications, workflow systems allow SPM solutions to effectively manage a company's compensation plans, data analysis, and other operational functions, and provide different individuals within the company with customized information. Workflow systems used in SPM solutions generally include the following workflow process specifications: 1) the types of requests that can be entered by a user, including whether the request is related to information the user can access in the system, such as data or reports; 2) details regarding information the user must provide as part of their request; and 3) rules for routing the request to different users or other parties for review and disposition. In some cases, different companies may have workflow processes that are similar at a high level, but the details or those workflows processes may vary greatly, including what specific data is involved in the process, what options are provided to users that participate in the process, the steps of review that are involved, etc. In other cases, a company may have workflow processes that are unique to its organization and business.

In known workflow applications used in SPM solutions, workflow processes are fixed in nature, or only allow for minor modifications by a company that wishes to use those workflow processes. For example, a workflow process is usually designed and created to work in conjunction with a fix set of data, not any set of data that the company may need to manage or take action on. In addition, these “fixed” workflow processes generally require the user to enter information into one or more predefined forms. Although the labels used for fields on those forms may be customizable, the specific fields that are used are not. Furthermore, routing rules and other actions that can be taken within a workflow process are usually fixed, with minimum customization available to the company and users. In order to make significant changes to workflow processes in these known systems, custom coding and programming is required. This increases the cost and time required to implement workflow process changes, as well as the possibility of software errors and related issues. The need for custom code in developing and modifying workflow processes is highly burdensome for the user, as it makes it more difficult to create and update workflow processes as business requirements change, something that happens frequently in the SPM field.

Furthermore, known workflow systems are often processing based, meaning that task assignments, alerts, and record updates are not initiated or performed on a real-time basis, but rather are based on a periodic system initiated process. When a user enters a request in a processing based workflow system, the appropriate task assignments and other workflow process steps are not performed immediately in response to a request being entered. Instead, the workflow system must run a periodic process to check for requests, and will only act upon those requests when the process determines there is a request to be acted upon. Similarly, once an actor to whom a task is assigned takes action on a request, there is no automatic and immediate update of the task record or request record, as such updates are only performed once a periodic system process determines action has been taken. The same is true of any alerts sent to users such as the requestor, or actors that must take further action on the request. To mimic real-time assignments and record updates, known systems must run these periodic system inquiry processes frequently, such as every five to ten minutes. Doing so may interfere with other processing operations running on the same system, hog system resources, and still results in some amount of delay between when a request is entered or an action is taken and when assignments, updates, or alerts are generated as a result of those actions. Such processing based workflow systems are undesirable for organizations that require user requests to have the potential to be responded to immediately by individuals who are responsible for acting on those requests. Although the acting individual may choose not to respond to the request immediately, the system itself should not prevent this possibility or operate in an inefficient manner.

In view of the above, a need exists for technology that enables workflow processes to be easily configured and modified without using custom code, presented in an intuitive and business-oriented fashion, and fully integrated to work with any data and business application within a SPM system. A need further exists for a workflow system that supports real-time assignment of requests as soon as they are entered by a user, and other real-time functions in response to action that is taken on the requests, such as immediate user notifications.

### BRIEF SUMMARY OF THE INVENTION

A computer-implemented method of creating a workflow application in a sales performance management system is disclosed. The computer-implemented method includes the step of presenting a graphical user interface via a display device, the graphical user interface being configured to present guidance and receive user input related to the workflow application. The method further includes the steps of receiving a user input specifying a request type representing a framework of information to be provided by an end user for a request to be acted upon, and receiving a user input specifying a task assignment representing an entity to which a task is assigned for purposes of acting on the request, and associating the task assignment with the request type. The method further includes the steps of receiving a user input specifying an action to be performed upon the task by the entity to which the task is assigned, and associating the action with the task assignment. A diagram is presented within the graphical user interface to visually represent the request type, task assignment, and action as individual nodes.

A computer-implemented method of processing a user request through a workflow process in a sales performance management system is also disclosed, the method including the steps of presenting a first element of a graphical user interface via a display device, the first element of the graphical user interface being configured to present guidance and receive user input related to requests. The method further includes the steps of receiving a user input selecting a pre-defined request type representing the user request to be acted upon, presenting a request form via the first element of the graphical user interface to capture information pertaining to the user request, and receiving a user input of request information in the request form. Upon receiving the user input of request information, the method proceeds to creating in real-time a request record configured to store information related to the user request, creating in real-time a task record configured to store information related to a task to be performed upon the user request, and assigning in real-time the task to a pre-determined entity that must act upon the task. The method further includes the steps of presenting a second element of the graphical user interface that's configured to present guidance and receive user input related to assigned tasks and available actions, presenting an action form that's configured to capture information pertaining to the task and any action performed on the task, and receiving a user input of action information in the action form related to an action that the pre-determined entity has taken upon the task. Upon receiving the action information, the method updates in real-time the task record to reflect the action that the pre-determined entity has taken upon the task, and also updates in real-time the request record to reflect an appropriate request status.

A system for creating a workflow process in a sales performance management system and processing a user request through the workflow process is also disclosed. The system includes a processor, a storage device in communication with the processor, a display device in communication with the processor and configured to present a graphical user interface, an input device in communication with at least one of the processor, the storage device, or the display device, and a software stored in the storage device and executable by the processor. The software includes a workflow builder component configured to communicate with the graphical user interface, receive configuration user inputs, and use the configuration user inputs in creating the workflow process. The software further includes a diagram component configured to present a diagram within the graphical user interface to visually represent the workflow process, and a processing component configured to communicate with the graphical user interface, receive end user inputs, and use the end user inputs in processing a user request through the workflow process on a real-time basis.

For sake of brevity, this summary does not list all aspects of the present method, system, computer software product, and related technologies, which are described in further detail below and in the claims.

### BRIEF DESCRIPTION OF THE DRAWINGS

The foregoing summary, as well as the following detailed description of the preferred embodiments, will be better understood when read in conjunction with the appended drawings. For the purpose of illustrating the invention, there is shown in the drawings embodiments which are presently preferred. It should be understood, however, that the invention is not limited to the precise configurations shown.

FIG. 1 is a diagram illustrating the relationship between components of an embodiment of a workflow system;

FIG. 2 illustrates a simplified embodiment of a workflow system;

FIG. 3 illustrates a server based scalable embodiment of a workflow system;

FIG. 4 is a screenshot illustrating an embodiment of a graphical user interface of the workflow system of FIG. 1, 2, or 3;

FIG. 5 is a screenshot illustrating a feature of the graphical user interface shown in FIG. 4 related to creating workflow applications;

FIG. 6 is a screenshot illustrating a feature of the graphical user interface shown in FIG. 4 related to workflow application-level settings;

FIG. 7 is a screenshot illustrating an embodiment of a graphical user interface that may be used by an end user to view and perform actions on assigned tasks;

FIG. 8 is a screenshot illustrating a feature of the graphical user interface shown in FIG. 4 related to configuring a request form;

FIG. 9A is a screenshot illustrating a feature of the graphical user interface shown in FIG. 4 related to configuring validation conditions associated with a request;

FIG. 9B is a screenshot illustrating a sub-menu of the validation conditions feature shown in FIG. 9A;

FIG. 9C is a screenshot illustrating another sub-menu of the validation conditions feature shown in FIG. 9A;

FIGS. 9D-9F are screenshots illustrating additional sub-menus of the validation conditions feature shown in FIG. 9A that may be used to configure advanced conditions;

FIG. 10 is a screenshot illustrating a feature of the graphical user interface shown in FIG. 4 related to configuring the steps of a workflow process;

FIG. 11 is a screenshot illustrating a feature of the graphical user interface shown in FIG. 4 related to creating a task assignment of a workflow process;

FIG. 12 is a screenshot illustrating another feature of the graphical user interface shown in FIG. 4 related to configuring the steps of a workflow process;

FIG. 13 is a screenshot illustrating a further feature of the graphical user interface shown in FIG. 4 related to configuring the steps of a workflow process;

FIG. 14 is a screenshot illustrating a feature of the graphical user interface shown in FIG. 4 related to configuring a task assignment of a workflow process;

FIGS. 15-18 are screenshots illustrating sub-menus of the task assignment details feature shown in FIG. 14 that may be used to configure details of a task assignment;

FIG. 19 is a screenshot illustrating a feature of the graphical user interface shown in FIG. 4 related to configuring the name of an action of a workflow process;

FIG. 20 is a screenshot illustrating a feature of the graphical user interface shown in FIG. 4 related to configuring whether an action of a workflow process may be applied to multiple tasks;

FIG. 21 is a screenshot illustrating a feature of the graphical user interface shown in FIG. 4 related to configuring an action form;

FIG. 22 is a screenshot illustrating a feature of the graphical user interface shown in FIG. 4 related to visually representing the steps of a workflow process;

FIG. 23 is a screenshot illustrating a feature of the graphical user interface shown in FIG. 4 related to visually representing the steps of a workflow process having multi-task dependencies;

FIGS. 24 and 25 are screenshots illustrating features of the graphical user interface shown in FIG. 4 related to the use of entities and entity tables in request or action forms;

FIG. 26 is a screenshot illustrating an embodiment of a graphical user interface that may be used to enable the ability to enter requests by an end user;

FIGS. 27-30 are screenshots illustrating features of the graphical user interface shown in FIG. 4 related to email notifications;

FIG. 31 is a screenshot illustrating a feature of the graphical user interface shown in FIG. 4 related to setting up a task view;

FIG. 32 is a screenshot illustrating a feature of the graphical user interface shown in FIG. 4 related to adding or editing workflow processes;

FIG. 33 is a screenshot illustrating a feature of the graphical user interface shown in FIG. 4 related to adding or editing request types;

FIG. 34 is a screenshot illustrating an embodiment of a graphical user interface that may be used by an end user to enter a request based on a data record;

FIG. 35 is a screenshot illustrating a sample request form;

FIG. 36 is a screenshot illustrating a sample action form;

FIG. 37 is a tablet computer that may be utilized in the workflow systems of FIGS. 2 and 3;

FIG. 38 is a flow diagram illustrating a computer-implemented method of creating a workflow application in a SPM system;

FIG. 39 is a flow diagram illustrating additional optional sub-steps of the flow diagram of FIG. 38; and

FIG. 40 is a flow diagram illustrating a computer-implemented method of processing a user request through a workflow process in a SPM system.

### DETAILED DESCRIPTION OF THE PREFERRED EMBODIMENTS

It is to be understood that the figures and descriptions of the present application have been simplified to illustrate elements that are relevant for a clear understanding of the present invention, while eliminating, for the purpose of clarity, many other elements found in business software and computing systems. One of ordinary skill in the art may recognize that other elements and steps may be desired or required in implementing the present system, method, and computer software product. However, because such elements and steps are well known in the art, a discussion of such elements and steps would not facilitate a better understanding of the present invention and thus is not provided herein. The disclosure herein is directed to all such variations and modifications to such elements and steps known to those skilled in the art.

Certain terminology is used in the following description for convenience only and is not limiting. The words “left,” “right,” “upper,” “lower,” “top,” and “bottom” designate directions in the drawings to which reference is made. Additionally, the terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import.

Sales performance management (SPM) systems in the form of computer software allow large amounts of information to be processed accurately and quickly, and presented to members of an organization in a manner best suited to each individual's position and goals within the organization. SPM systems may include a number of different, but interrelated business applications that represent and carry out various business functions. For example and without limitation, these business applications may be used to determine the performance of individuals and sales channels within the organization, to analyze performance metrics in combination with other data to improve, recognize, and reward performance, and to improve the efficiency and productivity of sales operations and other business functions. Other examples of SPM business applications include general data management, which may include processes for extracting, loading, transforming, and validating data used by the SPM system, and analyzing data processing performance of the system. Sales analytics applications may be used to analyze and interpret various sales related data to determine specific issues and recommend areas for process or performance improvement. Additional business applications may be related to reporting capabilities, such as the reporting of sales and other business information through static reports as well as dynamically created reports in real-time. Individualized alerts and dashboards may be included in SPM systems to provide users with customized messages, data representations, what-if calculators, and other dynamic views that provide insight into business performance. In addition, a subset of SPM business processes may be specifically related to sales compensation management (SCM), which focuses on the management of sales compensation for salespeople and other sales channels. SCM applications may include solutions directed to the areas of compensation planning, merit adjustments, crediting and eligibility, commissions and variable pay, rewards and recognition, disputes and inquiries, auditing and compliance, and modeling and simulation of sales or compensation plans.

Workflow applications are an important part of such SPM systems, and may be used to define the requirements for initiating workflow processes, specify and manage the workflow routing processes, and analyze the effectiveness of workflow processes. Accordingly, it is desirable to integrate workflow functionalities within SPM systems to effectively manage SPM operations and processes, and work in conjunction with other business applications in the system. Workflow functionalities may be embedded with other applications to carry out various sequences of business operations, using the same data as those applications. Embodying workflow applications and other SPM applications in software is advantageous over homegrown solutions, such as manual processes or spreadsheet based systems, in that the software can store and process large amounts of data, reduce opportunities for error, automate certain steps, and be configured to reflect changes in business requirements. The present computer-implemented method, system, computer software product, and related technologies may be used in such SPM software to configure and manage workflow processes and provide an integrated and streamlined solution.

It is to be understood that although the present invention is described within the context of a general SPM system, the principles embodied herein may be broadly applied to any performance management or other business solution utilizing workflow processes. Accordingly, the term “sales performance management system” as used herein should not be interpreted as a system limited to or requiring the use of sales related processes or data. Similarly, while many of the examples in this application deal with sales and compensation related processes and information, one of ordinary skill in the art would appreciate that the present invention is not restricted to such applications, and may be used in a wide array of business solutions with various types of data and processes.

As discussed above, a workflow process generally refers to a sequence of tasks or procedures to be carried out by various entities. In the SPM context, workflow processes are often used to handle user requests related to business data or other business affairs related to the user. Such a workflow process enables an end user to initiate a request that one or more entities, usually within the same organization as the end user, need to take action on. The entity is usually an individual, but may also be a system component that automatically takes action based on predefined conditions. Going forward, the term “actor” will be used to refer to the entity that is assigned to act on a request. In an extremely simplified form, a workflow process may only require one actor to take a single action on the request to resolve it and conclude the process. However, in many cases a request may need to be acted on by more than one actor, usually in a specified order, to bring it to conclusion. There may also be conditions that determine who should act on the request based on attributes of the request or on prior actions taken on the request, as well as conditions that determine what actions can be taken at any given step. Furthermore, it is desirable to have validations at various steps of a workflow process to ensure that the right type of information is provided with the request, and that valid actions are performed on the request. Typically, requests of a workflow process are associated with specific data records within a SPM system, such as a request to make changes to key business data like employee information, or a request that disputes a data record like sales-related data. In many cases, approval of the request will result in the underlying data being updated. However, many requests are not related to preexisting data records and contain only user-supplied information, such as a request for general technical support, for expense reimbursement, or for other open-ended issues.

A workflow solution related to a SPM system often involves different steps for processing and resolving requests entered through the system, both in terms of the actors who are responsible for acting on the requests, and in terms of the different actions that can be taken by each actor. Different actions can result in different “paths” being followed to resolve a request. For example, in a workflow system that enables salespeople to dispute information related to sales transactions, the request entered for a dispute may be assigned to a different actor based on attributes of the original transactions or based on information entered by the user in the request. Known software solutions are not designed to configure a workflow system and individual workflow processes in an intuitive and easy to understand way.

In view of the above complexities and variations associated with workflow processes, it is desirable to provide a workflow system that can be integrated within a SPM system to utilize pre-existing information and functions in the SPM system such as data records, data views, customized user portals, and alerting capabilities. Such a workflow system must also be easily configurable and offer flexibility to accommodate a wide variety of workflow processes that may be required by an organization, but without the need for custom coding. The present application discloses methods, systems, and related technologies for achieving such a workflow system, which allows a configuration user (i.e., a user that creates and maintains workflow processes) to create highly flexible workflow applications in an intuitive and business-oriented manner, and processes end user requests through those workflow applications with real-time task assignments, alerts, and record updates. Furthermore, the various steps and available actions of each workflow process are depicted in a logical flow that makes business sense for the user. As used in this application, the term “real-time” refers to the system taking action immediately in response to a trigger condition being met or to certain user activity, as opposed to being based on a periodic system-initiated process during which the system checks for such trigger conditions, and should be understood to include activity that occurs in near real-time to accommodate normal system lag or delay.

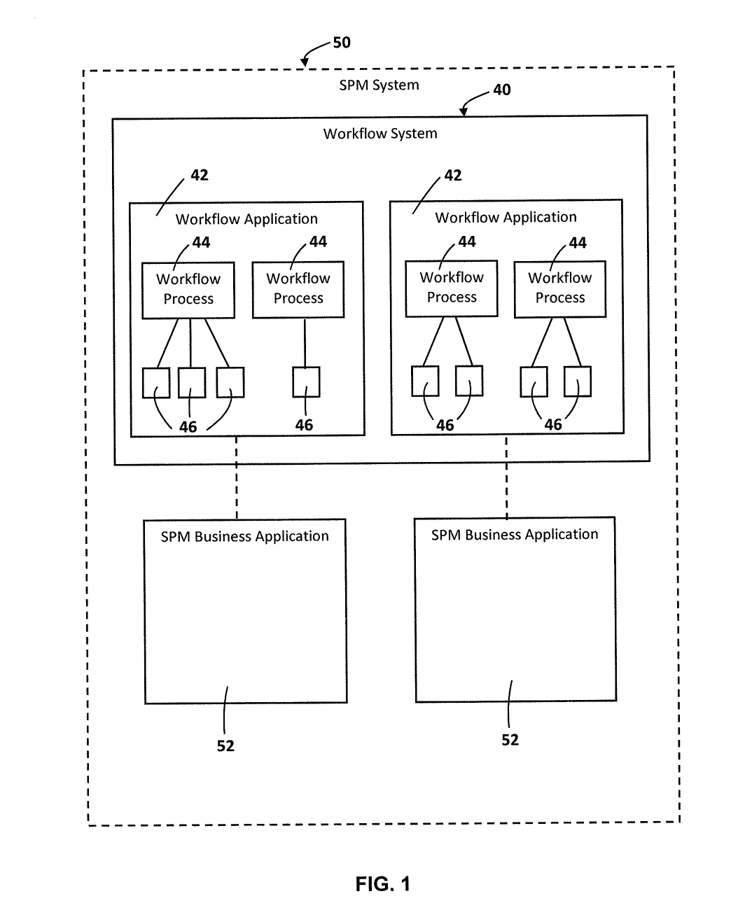

Although the term “workflow application” is generally understood to mean a software or software component that performs all workflow-related functions, sometimes within a larger system, this term as used herein has a different and more specific meaning. Instead of being a general software application, a “workflow application” in the present application is a set of one or more workflow processes that are created by a configuration user and grouped together into a single “application.” The grouping of different workflow processes into a single workflow application is determined by the configuration user, such as an administrator, and is often based on the type of data records or the specific SPM application upon which requests of those workflow processes are based. Accordingly, a SPM application that utilizes a workflow system according to the present application may include multiple workflow applications, each directed to a different category of potential user requests. For example, the configuration user can create a workflow application for “Sales Disputes” and link the sales disputes workflow application to a data view that displays a salesperson's sales data. Each of the workflow processes in the sales disputes workflow application relates to requests that make sense in the context of sales data, such as requests to dispute the date on which a sale occurred, the quantity sold, or the crediting of the sale to a salesperson. The sales disputes workflow application would not include workflow processes directed to other requests such as for an expense reimbursement, technical support, or employee information update. Similarly, a separate “employee data” workflow application may be linked to a data view or SPM application that displays employee information, and may include workflow processes that allow managers or other individuals to enter requests to change employee information, such as their positions, salary, or contact information. A “compensation” workflow application may be linked to compensation reports, so that a salesperson can enter requests to obtain information regarding how their compensation was calculated. In other words, different workflow applications may be associated with different business applications and data views in a SPM system or software, such as the sample systems shown in FIGS. 1-3, to provide an end user with context-specific options for entering requests.

A workflow application according to the present application may include one or more separate workflow processes, each of which may in turn be associated with one or more request types. FIG. 1 is a diagram illustrating the relationship between a workflow system 40, workflow applications 42, workflow processes 44, and request types 46. The workflow system 40 may be a standalone system, or may be integrated in and designed to work with data within a larger SPM system 50, which may contain a number of interrelated business applications 52. By using a workflow application builder component, which will be discussed in detail below, a configuration user may create one or more workflow applications 42. Each workflow application 42 may be associated with a component of a SPM business application 52 through which an end user may enter requests. Each workflow application 42 may include one or more workflow processes 44, each workflow process 44 representing the “flow” of steps and actors that a user request must be processed through. As used in this application, the reference to a user request being “processed” through a workflow refers generically to carrying out or resolving the request through one or more steps, and should not be interpreted as being limited to a specific software process or methodology, such as the periodic system initiated process describe above. Each workflow process 44 may be associated with one or more request types 46, each of which represents a type of request that may be entered by the end user. Each request type 46 includes a different request form that the end user must fill in when entering the request, the fields of the form being designed to capture information necessary to identify, describe, and provide supporting information relevant to the request. The details of each request type 46 are fully customizable by the configuration user, as will be described in detail below. A different workflow process 44 can be configured for each individual request type 46 if the request type 46 requires unique workflow steps. Alternatively, the same workflow process 44 can be configured for and associated with multiple request types 46 if the workflow steps for each request type 46 are the same, even though the information provided by the end user for each request type 46 is different, as long as the request is processed through the same flow of steps and actors. When a workflow application 42 is associated with a component of a SPM business application 52, such as a data view, a user portal, or a report, the configuration user has the option of making the workflow processes 44 of that workflow application 42 available to the end user. The end user may then access the available request types 46 from the component of the SPM business application 52.

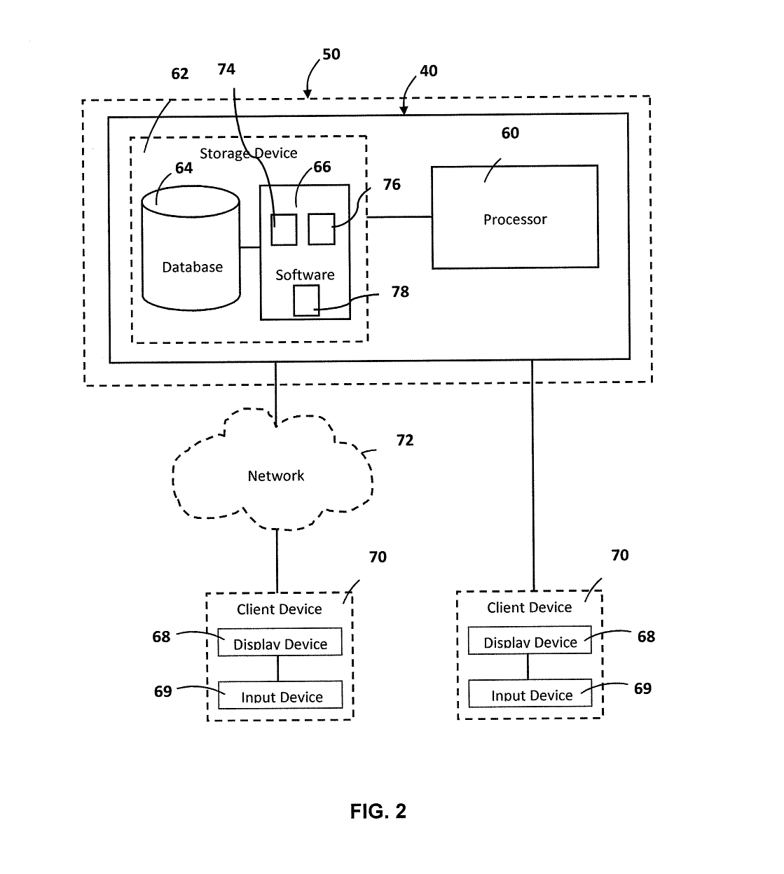

FIG. 2 illustrates an embodiment of a workflow system 40 according to the present application for creating a workflow application 42 in a SPM system 50, and processing a user request through a workflow process 44 within the workflow application 42. The workflow system 40 shown in FIG. 2 includes a processor 60, a storage device 62 in communication with the processor 60, a display device 68 in communication with the processor 60, and an input device 69 in communication with at least one of the processor 60, storage device 62, or display device 68. The workflow system 40 further includes a software 66 stored in the storage device 62 and executable by the processor 60. As discussed above, the workflow system 40 may be integrated within the SPM system 50, and may share system resources including, inter alia, the processor 60, the storage device 62, the display device 68, and the input device 69.

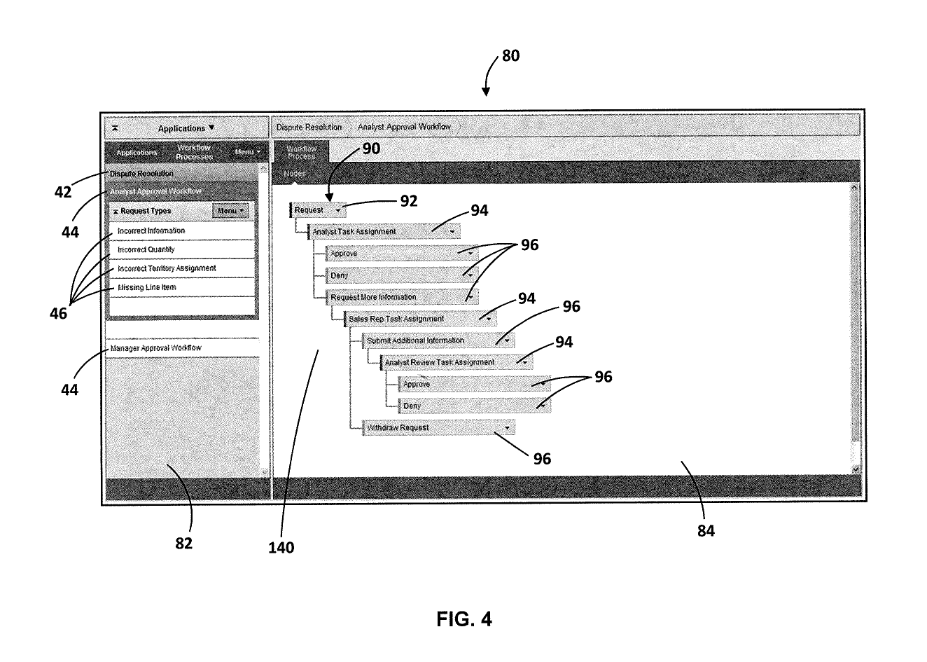

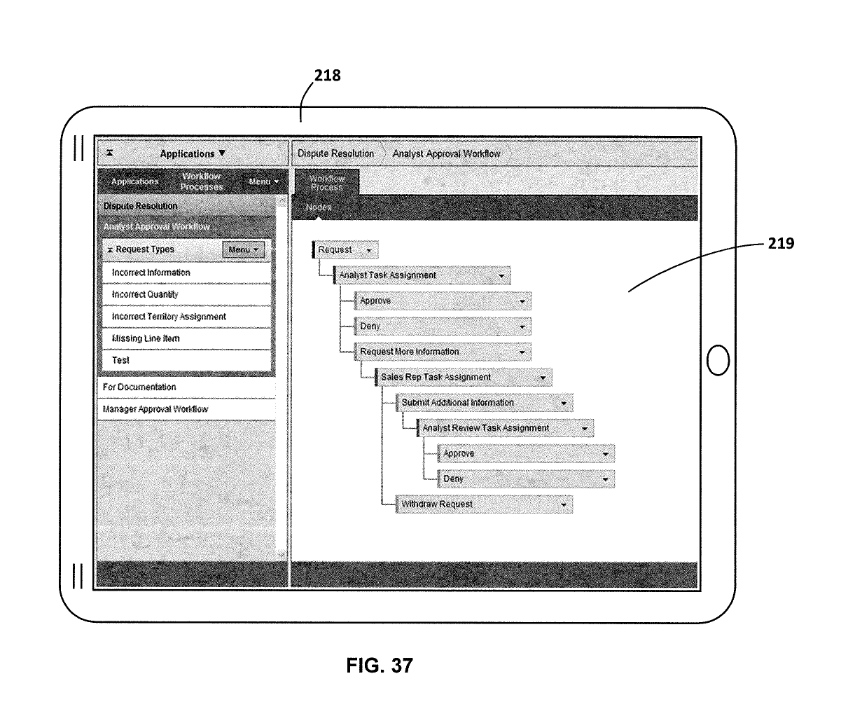

The processor 60 and the storage device 62 may be separate or part of the same machine. The processor 60 may further be associated with, or incorporated into, any suitable type of computing device, such as, for example and without limitation, a personal computer, a programmable logic controller, a server, or a mobile computing device. The storage device 62 may include a database 64 and the software 66, which may be stored in the same or separate storage components within the storage device 62 and may be in communication with each other. The database 64 may be configured to store information related to the workflow system 40 as well as information related to other business applications within the SPM system 50. The storage device 62 may be or include a memory device, such as random access memory (RAM), read only memory (ROM), flash memory, a cache, or any other suitable computer-readable medium. The storage device 62 may also be or include a hard drive, a solid-state drive (SSD), a magnetic recording apparatus, a magneto-optical medium, an optical medium, a diskette, a thumb drive, or any other kind of computer-readable medium or suitable device for electronic data storage. As shown in FIG. 2, the display device 68 and input device 69 may be part of a client device 70, which is in communication with at least one of the processor 60 or the storage device 62. Optionally, the display device 68 and input device 69 may be part of the same device, such as the touch screen display 219 of the tablet computer 218 shown in FIG. 37. The client device 70 may be directly associated with the processor 60 or storage device 62, such as through a direct connection or by being part of the same machine. Alternatively, the client device 70 may communicate with the processor 60 or storage device 62 through a network 72, such as a wide area network (WAN), local area network (LAN), or the internet. For example and without limitation, the processor 60 and the storage device 62 may be part of a server system that is physically separated from the client device 70. The display device 68 may be configured to present a graphical user interface that allows a user to interact with the present workflow system 40 and the SPM system 50, such as the graphical user interface 80 shown in FIGS. 4-37 and described in detail below.

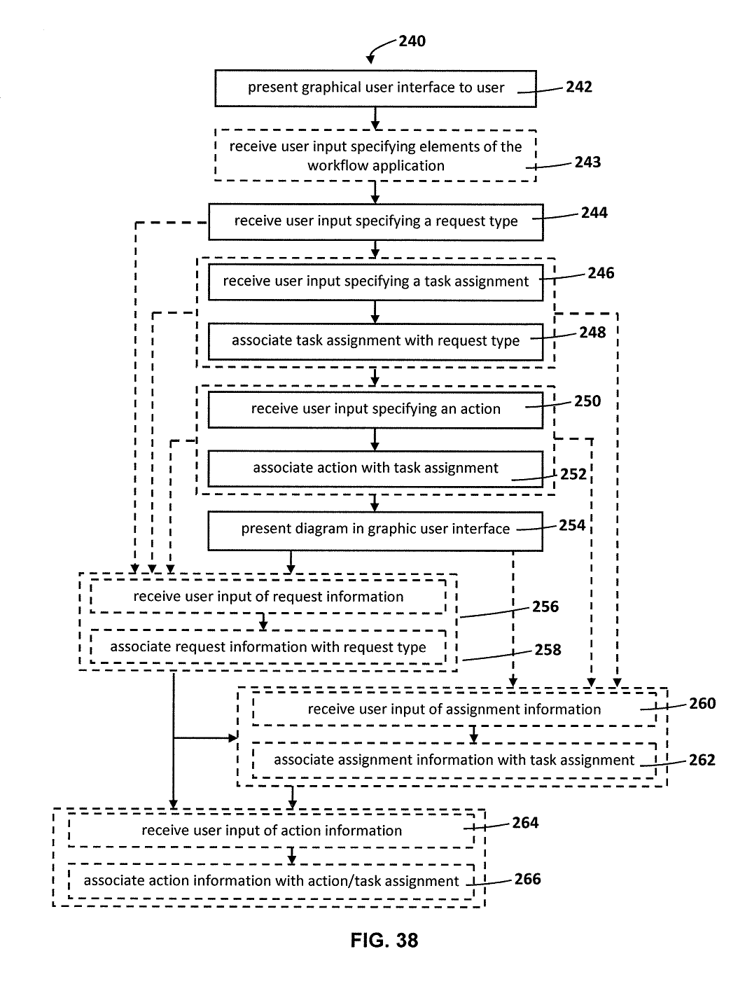

The software 66 includes a plurality of components configured to carry out functions associated with creating a workflow application 42 having at least one workflow process 44 and processing a user request through a workflow process 44 of the workflow application 42. For example and without limitation, the software 66 may be configured to carry out the method steps illustrated by the flow diagrams of FIGS. 38-40, which are described in detail below. Specifically, the software 66 may include a workflow builder component 74 configured to communicate with the graphical user interface 80, receive configuration user inputs, and use those configuration user inputs in creating the workflow application 42. The software 66 may further include a diagram component 76 configured to present a diagram within the graphical user interface 80 to visually represent the workflow process 44 of the workflow application 42, and a processing component 78 configured to process an end user request through the workflow process 44. For sake of simplicity, the workflow builder component 74 and diagram component 76 will be discussed in detail first, since a configuration user must create the workflow application 42 and the associated workflow process 44 before an end user can enter a request using the workflow application 42.

The workflow builder component 74 of the software 66 allows a configuration user to create highly customized workflow applications 42 that can be based on any type of data without the need for custom coding or complex configuration steps. Accordingly, workflow applications 42 can be built to an organization's specific needs and easily maintained should business requirements change over time. The diagram component 76 of the software 66 works in conjunction with the workflow builder component 74 to present the configuration user with an intuitive and user-friendly interface for creating workflow processes 44 within the workflow application 42, where each step of a workflow process 44 can be represented as a node in a workflow diagram, and the overall framework for the workflow process 44 can be laid out and visually represented before the details of each individual step are defined. Each workflow process 44 in a workflow application 42 is tied to one or more request types 46, which as discussed above represent the types of requests that an end user can submit to be processed through the steps of the workflow process 44. Within each workflow process 44, the steps include one or more task assignments, each of which may specify conditions for determining which actor is assigned to a task to act on a request. There may be an initial task assignment when a user request is first entered, and additional subsequent task assignments as actions are taken in response to the request, as is the case where the workflow process 44 includes multiple steps of review and approval. For each task assignment in a workflow process, the configuration user may specify one or more actions that may be performed by the actor assigned to the task. Each action may include an action form for the actor to fill in when performing the action, the fields in the form being configured to capture the necessary information to support the action taken.

FIG. 4 illustrates a sample graphical user interface 80 of the present workflow system 40, through which a configuration user may utilize the workflow builder component 74 and diagram component 76 of the software 66 to create a “Dispute Resolution” workflow application 42 having two different workflow processes 44—an “Analyst Approval” workflow and a “Manager Approval” workflow—as shown in a left hand pane 82 of the graphical user interface 80. One of ordinary skill in the art would understand that these are merely examples of workflow processes that may be created with the present workflow system 40, and should not be construed as being limiting in any way. The “Analyst Approval” workflow process 44 is associated with a number of different request types 46 that are each processed through the same flow of steps and actors, even though the information provided by the end user for each request type 46 is different. As shown in the left hand pane 82 of the graphical user interface 80 in FIG. 4, these request types 46 include an “Incorrect Information” request, an “Incorrect Quantity” request, an “Incorrect Territory assignment” request, and a “Missing Line Item” request. The target end user for these request types may be a salesperson, who may utilize this workflow application 42 to enter requests to update incorrect data in a SPM system 50 that the present workflow system 40 is associated with. As shown in a right hand pane 84 of the graphical user interface 80, the diagram component 76 of the software 66 may generate and present a diagram 90 that visually represents each step of the workflow process 44 selected from the left hand pane 82. In the example shown in FIG. 4, the diagram 90 that represents the “Analyst Approval” workflow process 44 is a flow diagram having a request node 92, three associated task assignment nodes 94 (Analyst Task Assignment, Sales Rep Task Assignment, and Analyst Review Task Assignment), and various actions nodes 96 associated with each task assignment node 94. Although not shown, the right hand pane 84 of the graphical user interface 80 may also present a summary flow diagram of the entire workflow application 42, instead of just one particular workflow process 44. As will be discussed in further detail below, a configuration user may utilize the workflow builder component 74 to create the framework of the workflow process 44, associate various request types 46 with the workflow process 44, and review the workflow process 44 as visually represented by the diagram component 76 via the diagram 90 before the details of each step in the workflow process 44 are defined.

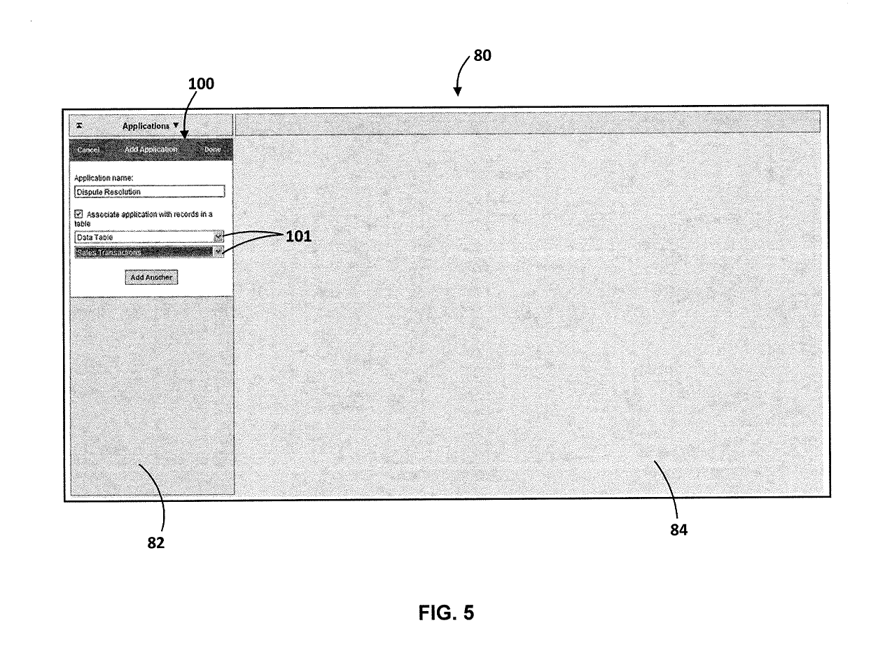

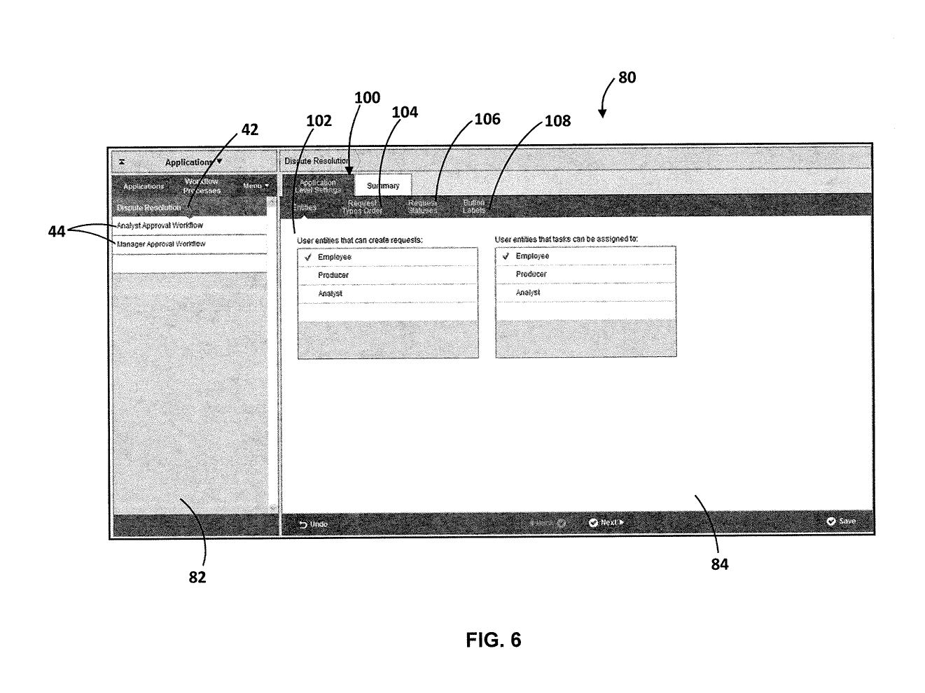

The graphical user interface 80 may operate in conjunction with the workflow builder component 74 to provide guidance, present options, and receive user input from a configuration user to create or modify a workflow application 42. Specifically, the graphical user interface 80 may be configured to provide a wizard or setup assistance interface that presents the configuration user with a sequence of setup components for creating or modifying the workflow application 42. For example and without limitation, the graphical user interface 80 may include an application settings element 100 that provides options and receives inputs for defining application-level settings of the workflow application 42, as shown in FIGS. 5-6. The application settings element 100 may include various features presented in both the left and right hand panes 82, 84 of the graphical user interface 80, with different options and fields in each pane. As shown in FIG. 5, a configuration user may create a new workflow application 42 by selecting the “add application” option presented in the left hand pane 82, and may input a custom name for the workflow application 42. If the workflow application 42 is based on data records that exist within the workflow system 40 or an associated SPM system 50, the configuration user may indicate the relationship by checking the “associate application with records in a table” box. Alternatively, the workflow application 42 may not be associated with any system data and is designed to handle open-ended requests, in which case the configuration user can proceed without further action. The workflow system 40 is preferably integrated with the SPM system 50 such that existing data records such as tables or report lists can be accessed by the workflow builder component 74, and can be selected using the application settings element 100, such as through one or more dropdown menus 101 as shown in FIG. 5. The configuration user may use a first dropdown menu to select whether the workflow application is based on a data table or a report list, and a second dropdown menu to select the specific data table or report list to be associated with the workflow application 42. When the workflow application 42 is based on a system data table or report list, the data fields from that data table or report list are available for use in configuring other elements of the workflow application. For example, values from a record in a data table can be used to populate fields in the associated request form. Accordingly, once the workflow application 42 has been associated with a data table or report list, that association cannot be later changed without greatly affecting the workflow processes 44 within the workflow application 42.

Once a workflow application 42 has been added to the workflow system 40, the configuration user may create additional workflow applications in the same manner as described above with respect to FIG. 5, or may specify application-level settings for a specific workflow application 42. For example and without limitation, the configuration user may select a workflow application 42 from the left hand pane 82 and utilize additional features of the application settings element 100 to define the selected workflow application 42. As shown in FIG. 6, the application settings element 100 may include features that are presented in the right hand pane 84 of the graphical user interface 80, such as in the form of a tabbed page. The application settings element 100 may also include an entities element 102, a request types order element 104, a request statuses element 106, and a button labels element 108, which may be presented in the form of sub-tabs.

The entities element 102 of the application settings element 100 is configured to present options and receive user input related to the entities that can create requests using the workflow application 42 and the entities that workflow tasks can be assigned to. The entities that can create requests and act on workflow tasks are usually individuals, but can also be system components. For example, a component of the workflow system 40 or the associated SPM system 50 can automatically initiate requests based on some predefined condition or business rule, such as when a data value reaches a certain threshold. Additionally, a system component can be assigned to act automatically on a workflow task by evaluating the information associated with the task against predetermined criteria. Where individuals are selected as those that can create requests and act on workflow tasks, the present workflow system 40 can take advantage of special entities that represent key business units and are associated with unique entity tables that can be accessed across different operations and applications of an SPM system. A method and system for representing and utilizing such entities are described in detail in U.S. patent application Ser. No. 13/602,423 for “METHOD OF REPRESENTING BUSINESS UNITS IN SALES PERFORMANCE MANAGEMENT USING ENTITY TABLES AND SYSTEM COMPRISING SAME,” which is incorporated as if fully set forth herein. Going forward, the terms “entity” and “entities” will refer to the entity concept as described in U.S. application Ser. No. 13/602,423, and correspond to key business units within the workflow and SPM systems 40, 50. The use of these special entities has significant benefits for the present workflow system 40, as will be described in detail below.

As shown in FIG. 6, the entities element 102 of the application settings element 100 may permit the configuration user to specify one or more entities that can create requests in the workflow application 42, and one or more entities that workflow tasks can be assigned to in the workflow application 42. Although the example shown in FIG. 6 only utilizes user entities that represent individuals or groups of individuals, the available options for requests and task assignment may also include system components. The entities element 102 shown in the right hand pane 84 of the graphical user interface 80 may display a list of available entities from which the configuration user can make a selection. By specifying the entities that can create requests and take action in the workflow application 42 before defining the rest of the workflow application 42, including individual workflow processes 44, the present workflow system 40 can better guide the configuration user through the configuration process and structure the application tables that store requests and tasks appropriately.

Request types 46 are defined by the configuration user when setting up individual workflow processes 44 within the workflow application 42, a process that will be described in detail below. Once all the request types 46 for a workflow application 42 have been defined, the request types order element 104 of the application settings element 100 may be used by the configuration user to specify the order of the complete set of request types 46 across all workflow processes 44 in the workflow application 42. This order determines the order in which the request types 46 appear as options in a request menu that is displayed to the end user to enable the end user to enter requests. Although the details of the request types order element 104 is not illustrated in the figures, one of ordinary skill in the art would understand that various graphical user interface elements may be used to enable the configuration user to view and reorder a list of available request types 46.

As requests are entered into the workflow system 40 and actions are taken on the requests, it is often desirable for an organization to track the different statuses of the request so that users may view a request and determine its progress. Accordingly, the application settings element 100 may include a request statuses element 106 that is configured to provide guidance, present options, and receive user input related to tracking request statuses. In many cases, an organization may wish to utilize a consistent set of request statuses across all workflow processes 44 within a workflow application 42. The request statuses element 106 enables the configuration user to specify the common set of request statuses that can be used for any workflow process 44 within the workflow application 42. The configuration user may manually input as many statuses as desired, using whatever names are required to meet the business needs of the workflow application 42. In addition, when defining an individual step in a workflow process 44, the configuration user may specify a request status that is not already included in the central list of request statuses. This new request status is then added to the central list and is subsequently available for use in any other workflow step. Although the details of the request statuses element 106 is not illustrated in the figures, one of ordinary skill in the art would understand that various graphical user interface elements may be used to provide a list of available request status names, and allow the configuration user to add, delete, rename, or reorder these request statuses.

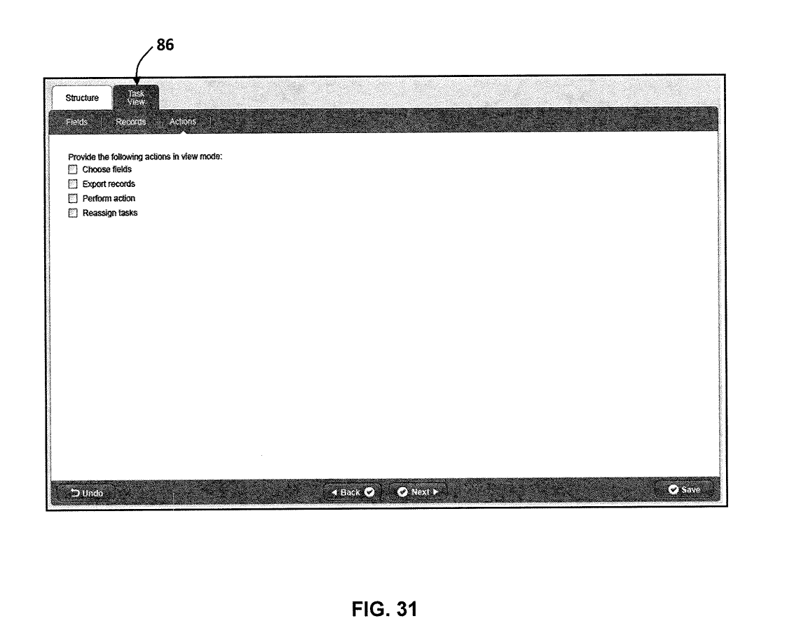

Another standard option that may be provided for a workflow application 42 in the present workflow system 40 is the ability to reassign tasks once they have been assigned to an entity. The graphical user interface 80 may include a task view setup element 86 configured to provide guidance, present options, and receive user input related to what is presented to or enabled for end users acting on task assignments. As shown in FIG. 31, the configuration user may also use the task view setup element 86 to specify the actions available in a task view of the end user, such as the ability to “choose fields,” “export records,” “perform actions,” and “reassign tasks.” The task view setup element 86 may also present a list of each entity that was selected by the configuration user as an entity that may have a task assigned to it, as discussed above with respect to the entities element 102 of the application settings element 100. The configuration user may then utilize the task view setup element 86 to select any one of the entities and specify which attributes of the entity should be displayed on a reassign task form for tasks assigned to that entity, and what labels should be used for each of these attributes on the form. As discussed in U.S. patent application Ser. No. 13/602,423, which is incorporated by reference, an entity “attribute” is data stored in the data table that is descriptive of the business unit represented by the entity. For example, where tasks are assigned to the “employee” entity, the entity attribute that may be selected to be displayed using the reassign tasks element may be the employee name, which would make more sense for the end user than employee ID numbers or another attribute associated with each instance of the employee entity.

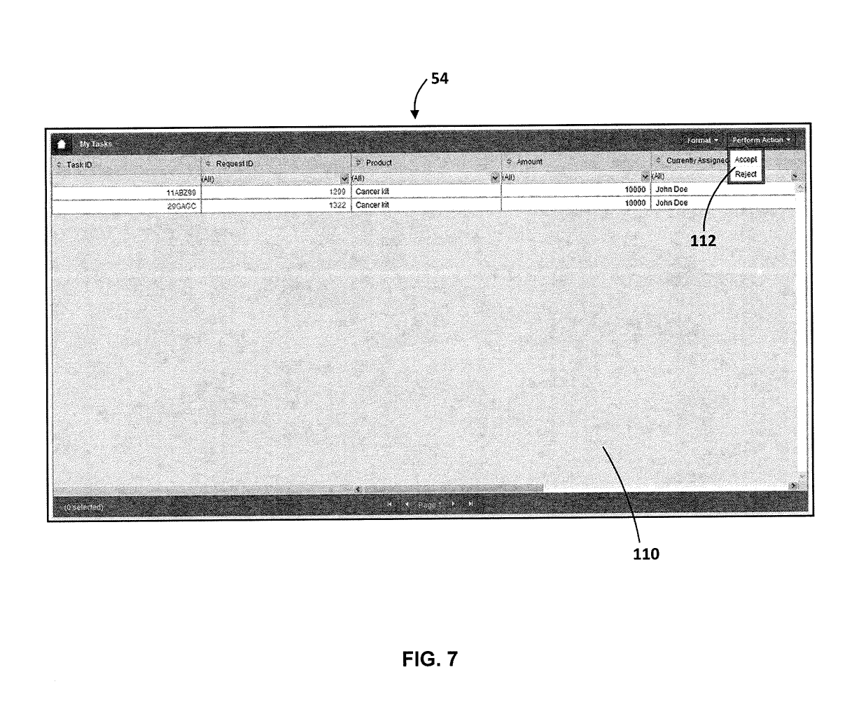

After the configuration user creates a workflow application 42 and the associated workflow processes 44 using the workflow builder component 74 of the software 66, different elements of the workflow application 42 may be presented to the end user as a menu of options, such as, for example and without limitation, through another business application 52 of the associated SPM system 50. For example, the SPM system 50 may include a customized user portal that presents the end user with various data views and report views configured to display information relevant to that end user. A menu of available request types may be displayed in such data views and report views to the end user, provided that the ability to enter workflow requests has been enabled, the request types 46 being associated with one or more workflow applications 42 related to the data therein. Alternatively, where the workflow application 42 is not based on existing data or reports, the menu of available request types may be displayed in a special request view configured to allow the end user to enter open-ended requests, provided that the ability to enter those workflow requests has been enabled for the request view. In addition, another menu of actions may be displayed in a special task view to end users that have been assigned to perform workflow tasks, provided that the ability to perform workflow actions has been enabled for that task view and end user. The request view and task view may be included, for example and without limitation, within the customized user portal. As shown in FIG. 7, a task view element 110 may be presented to an end user via a user portal graphical user interface 54 to display information regarding tasks that have been assigned to the end user. The action menu 112 may be accessed by a “Perform Action” button located within the task view element 110, from which the end user may select the action that should be performed for each of the listed tasks. Although not shown, the request types menu may similarly be accessed by an end user using a “enter request” button located within a data view or report view element containing data that the end user wishes to submit a workflow request for. To customize the text displayed on the buttons used by the end user to access the action menu 112 and request types menu from the user portal 54, the application settings element 100 may include a button labels element 108 that enables the configuration user to manually input custom names for those buttons. The labels for the action menu 112 and request types menu may read “Perform Action” and “Enter Request,” respectively, by default. However, the configuration user may use the button labels element 108 to change the labels to any text that better represents the business purpose of the workflow applications 42 associated with those requests and actions. For example, for a workflow application 42 designed to handle disputes of sales transaction data, the request types menu and action menu may be accessed using buttons custom labeled “Enter Dispute” and “Resolve Dispute,” respectively. Although the details of the button labels element 108 are not shown in the figures, one of ordinary skill in the art would understand that a variety of graphical user interface elements may be used to present options and receive user input for custom button names, such as via text boxes.

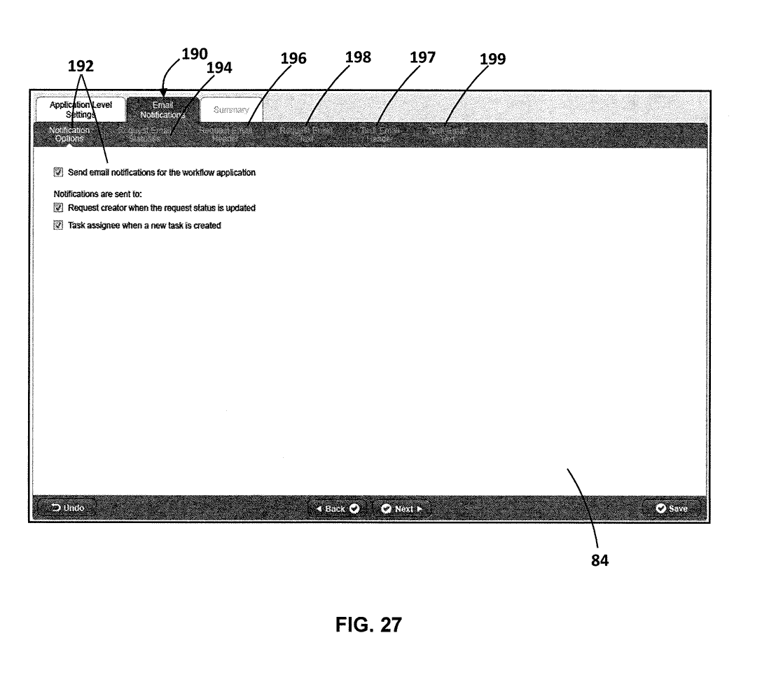

As part of, or separate from, the application settings element 100, the graphical user interface 80 may further include an email notification element 190, as shown in FIGS. 27-30. As described with respect to FIGS. 27-30, the email notification element 190 may be configured to provide application-level settings related to email notifications for a specific workflow application 42. Alternatively, the email notification element 190 may be configured to provide email notification settings that apply to specific request types or tasks within a workflow application 42. As shown in FIG. 27, the email notification element 190 may include features that are presented in the right hand pane 84 of the graphical user interface 80, such as in the form of a tabbed page. The email notification element 190 may also include a notification options element 192, a request email statuses element 194, a request email header element 196, a task email header element 197, a request email text element 198, and a task email text element 199, which may be presented in the form of sub-tabs. By using the settings provided in the email notification element 190, the configuration user may specify whether email notifications should be sent at certain points of a workflow process and the format and content of any such notifications.

The notification options element 192 of the email notification element 190 may be configured to present options and receive user input related to whether email notifications are enabled or not for a given workflow application 42, which the configuration user may select from the left hand pane 82 of the graphical user interface 80. As shown in FIG. 27, the notification options element 192 may include a checkbox that allows email notifications to be enabled for the selected workflow application 42. If email notifications are enabled, the configuration user may further specify the individuals to whom email notifications are sent. For example and without limitation, email notifications may be sent to the end user who created a request once that request status is updated, and may also be sent to the individuals assigned to tasks once a new task is created, as shown in FIG. 27. In addition, the notification options element 192 may include options to send email notifications related to requests or tasks to a list of email addresses explicitly specified by the configuration user.

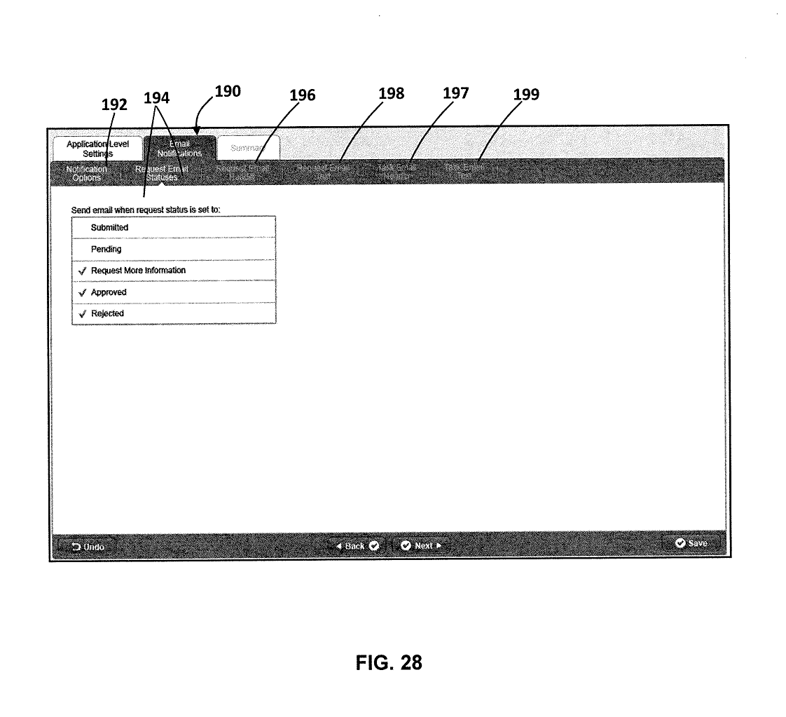

The email notification element 190 may be configured to selectively display additional elements only when the configuration user enables email notifications through the notification options element 192, such that the other sub-tabs are hidden until the checkbox for “send email notification for the workflow application” is checked. As shown in FIG. 28, the request email statuses element 194 may be configured to present options and receive user input related to which request statuses will trigger an email notification to be sent. Each request status defined in the system, such as by using the request statuses element 106 of the application settings element 100, may be displayed within the request email statuses element 194. The configuration user may then choose the request statuses that trigger email notifications, which may be visually represented by checkmarks, as shown in FIG. 28. As will be discussed in detail below, each action defined for the workflow application 42 may be configured to update the status of the associated request with a specified request status value in real-time. Once the request is updated with that request status value, an email notification may be sent to the appropriate individual or individuals in real-time.

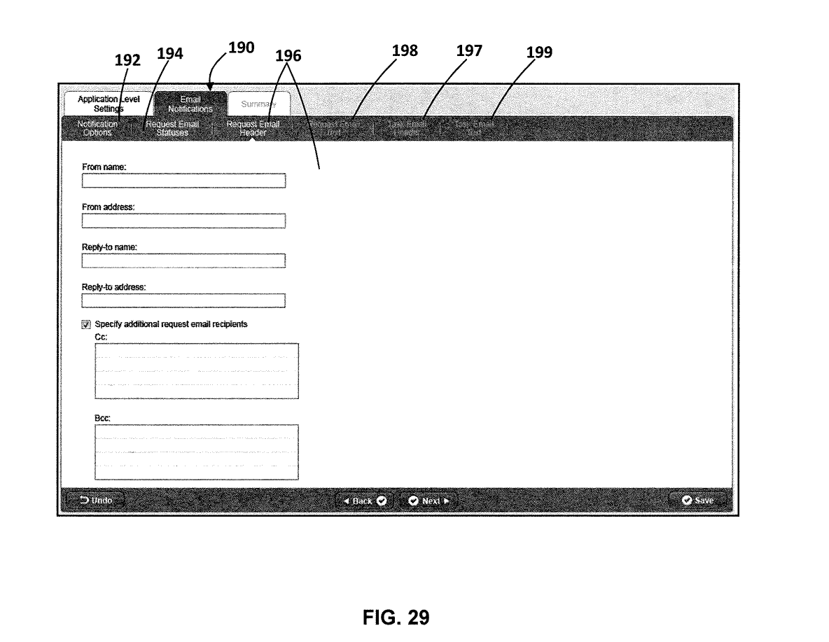

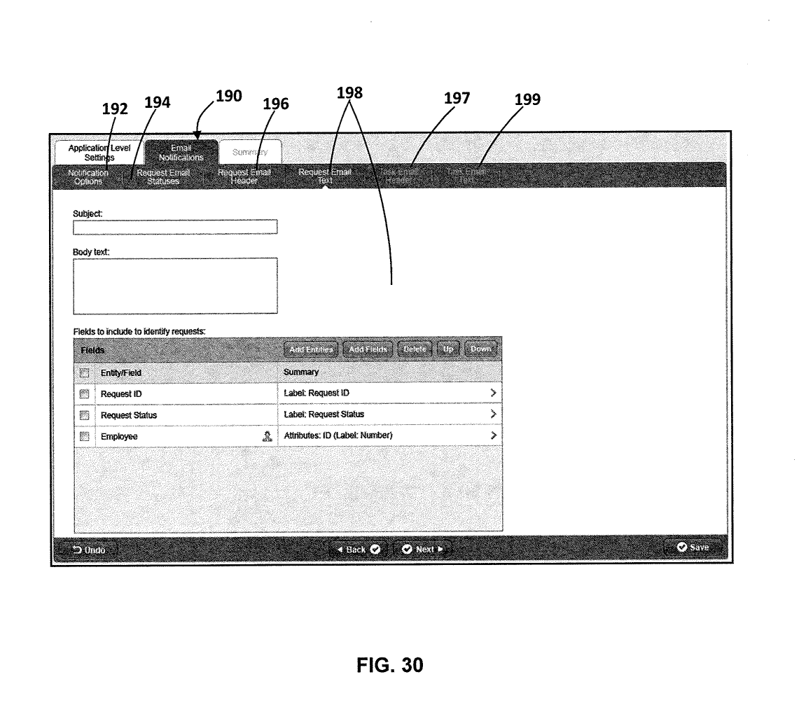

As shown in FIG. 29, the request email header element 196 may be configured to present options and receive user input related to the header of the notification emails sent as a response to an updated request status. The request email header element 196 may allow the configuration user to specify the “From” and “Reply-to” names and email addresses for the email notification, and specify additional email addresses to be included as CC or BCC recipients. Since the end user that entered the request is the primary intended recipient of the email notification, the configuration is not required to explicitly specify the recipient name and email address in the request email header element 196. As shown in FIG. 30, the request email text element 198 may be configured to present options and receive user input related to the content of the notification emails sent as a response to an updated request status. The configuration user may specify a subject line and body text to be included in any emails sent with a request's status has been updated. The request email text element 187 may further allow the configuration user to select specific fields and entities to include in the email, which help identify the request or requests that have been updated. In cases where an action is performed on more than one task at a time and results in more than one request's status being updated from that single action, the email notification would list more than one request record. In cases where an action is only performed on a single task, the email notification would only list a single request record. For example and without limitation, the fields or entities selected by the configuration user in the request email text element 198 may be presented in the body of the email notification as column headers in the email, with one or more appropriate request record's values listed under those column headers.

Where the configuration user enables email notifications for task assignees when a task is created in the notification options element 192, the email notification element 190 may be configured to selectively display the sub-tabs for the task email header element 197 and task email text element 199. The task email header element 197 and task email text element 199 may be configured to display the same options and receive similar user input as the request email header element 196 and request email text element 198, which have been discussed above in detail. Accordingly, the details of the task email elements 197, 199 will not be shown again in the figures or discussed here for simplicity's sake. One of ordinary skill in the art would appreciate that while the contents of the task email elements 197, 199 will be substantially identical to the request email elements 197, 198, the task email text element 199 may be configured to display a list of fields and entities used to identify the tasks that were created, as opposed to requests for which status values have been updated. Furthermore, one of ordinary skill in the art would recognize that the above description and FIGS. 27-30 are merely some examples of settings related to email notifications, and that additional settings may be included and presented using various graphical user interface elements, such as dropdown menus, check boxes, tables, text boxes, and other widgets.

After the configuration user has added one or more workflow applications 42, and optionally specified application-level settings for a specific workflow application 42, the configuration user may utilize the workflow builder component 74 to create one or more workflow processes 44 for the workflow application 42. As previously discussed, a workflow process 44 is made up of the workflow steps for one or more request types 46, and dictates the logical “flow” that a request based on those request types 46 must be processed through for resolution. A workflow process 44 may be configured for each individual request type 46 if the workflow steps vary for each request type 46. Alternatively, the same workflow process 44 may be associated with multiple request types 46 if the workflow steps are the same for all of those request types 46.

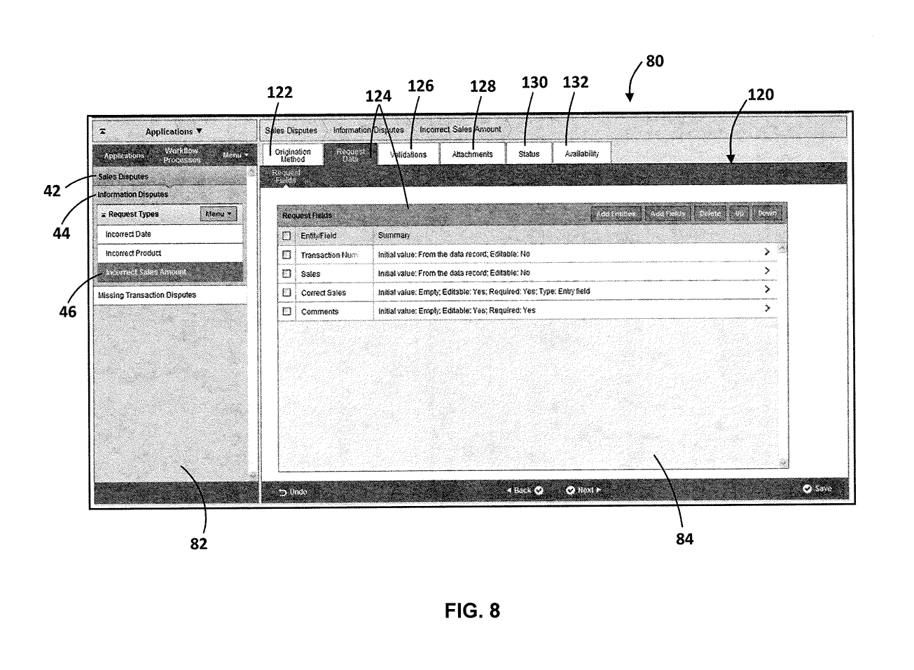

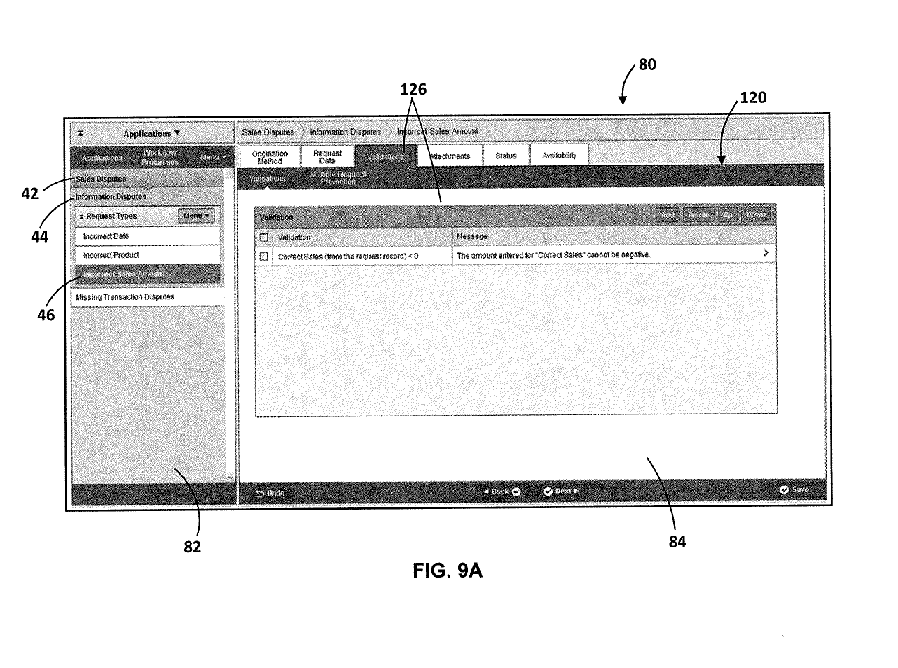

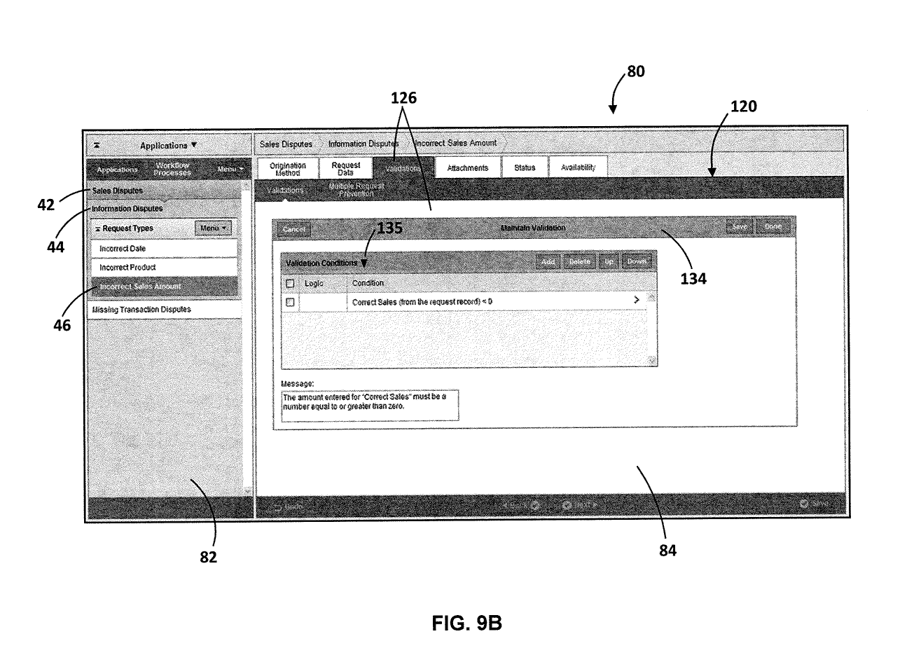

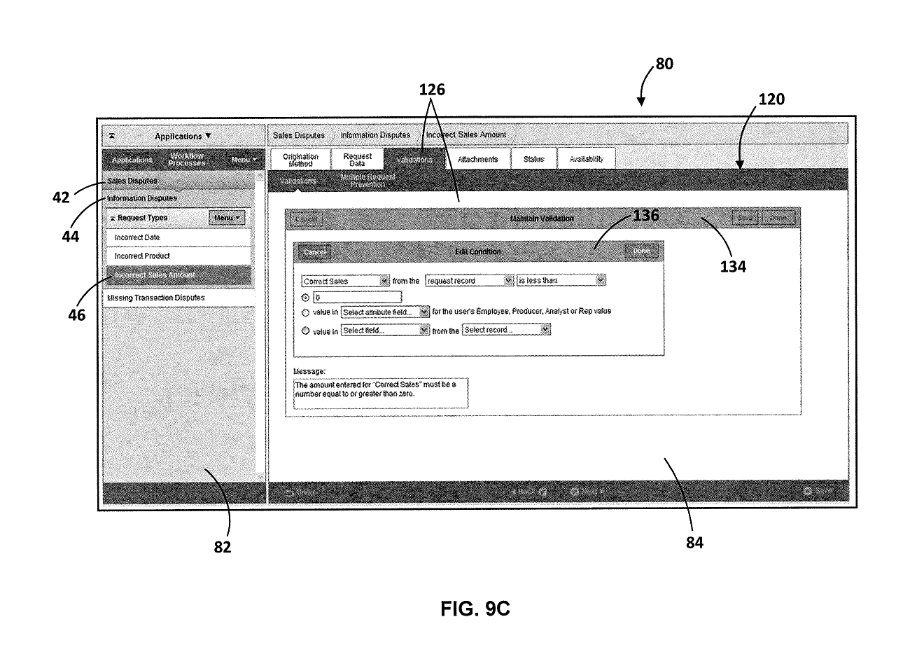

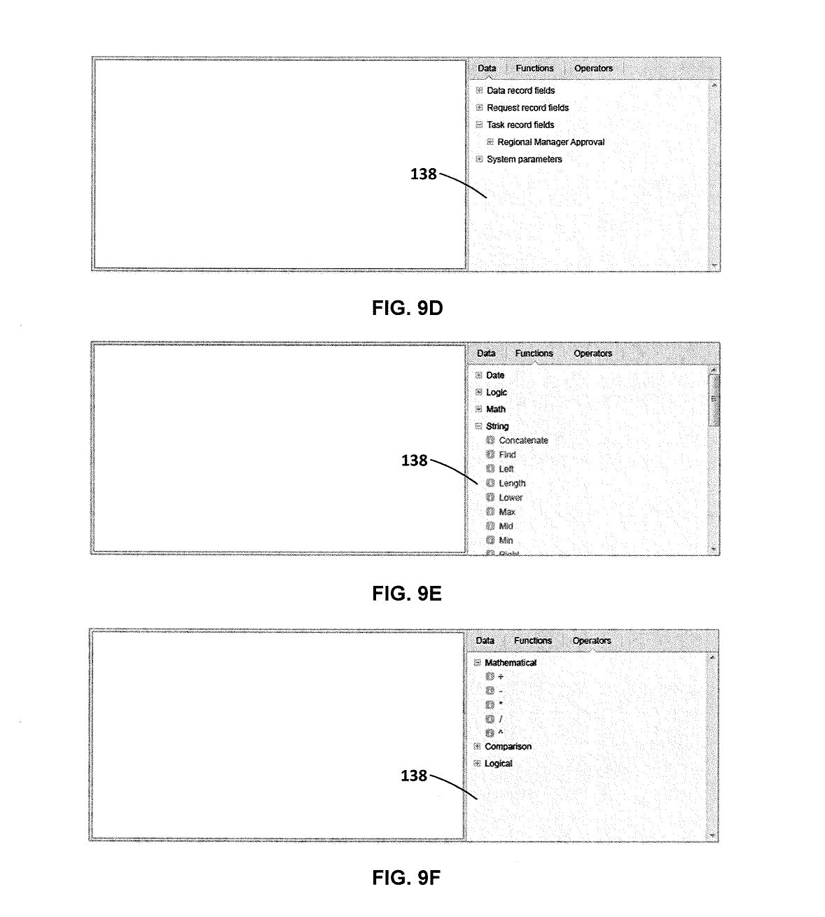

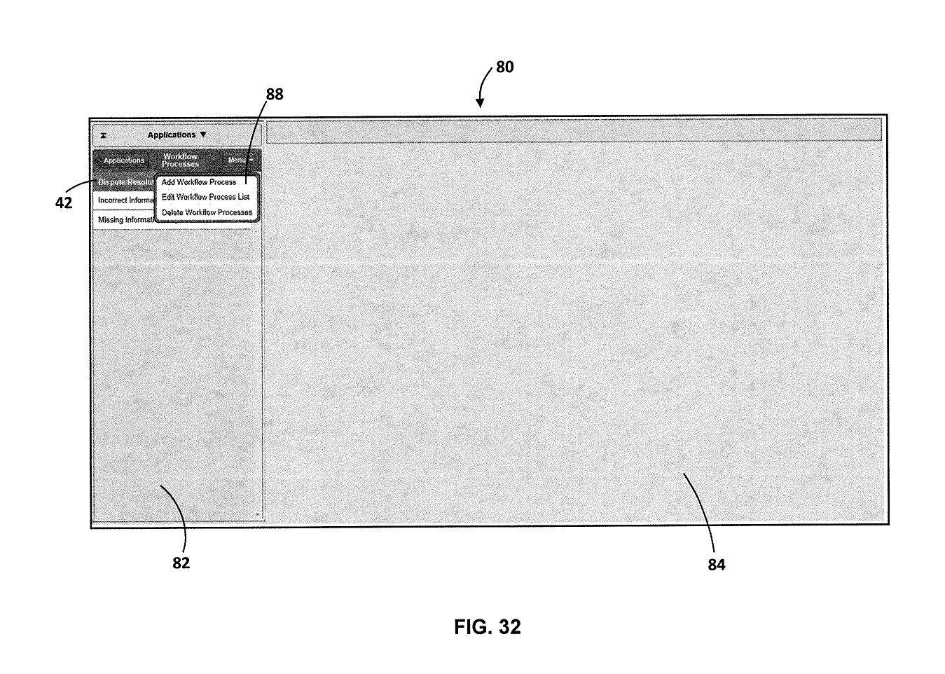

Utilizing the graphical user interface 80 shown in FIG. 4, the configuration user may add a workflow process 44 using a component of the application settings element 100, which may be presented in the left hand pane 82. An example is shown in FIG. 32, where the configuration user may use a workflow process dropdown menu 88 to add a workflow process 44 to the selected workflow application 42, edit the list of workflow processes 44 available for that workflow application 42, or delete a workflow process 44. Preferably, the graphical user interface 80 and the workflow builder component 74 are configured such that the configuration user may complete all, or at least the majority, of the configuration steps associated with creating one or more workflow applications 42 in the present workflow system 40 without leaving the graphical user interface 80 or having to access a different business application 52 of the associated SPM system 50. In other words, the same graphical user interface 80 is preferably configured to present the application settings element 100 and all other elements required for creating workflow applications 42, thus presenting the configuration user with a simple, user-friendly, and streamlined interface. After a new workflow process 44 is added by the configuration user and associated by the workflow system 40 with the corresponding workflow application 42, the configuration user may define each step in the workflow process 44. Preferably, the workflow process 44 is added using a menu presented in the left hand pane 82 of the graphical user interface 80, and each step in the workflow process 44 is configured using an intuitive diagram-based interface presented in the right hand pane 84, which may be configured to display a flow diagram 90 that visually represents each step of the workflow process 44 (e.g., the request, task assignments, and actions) as individual nodes 92, 94, 96, as shown in FIG. 4. The graphical user interface 80 may include a request maintenance element 120, separate from the flow diagram 90, which provides options and receives inputs for defining workflow process-level settings, as shown in FIGS. 8-9F. The request maintenance element 120 may be presented in both the left and right hand panes 82, 84 of the graphical user interface 80, with different options and fields in each pane.

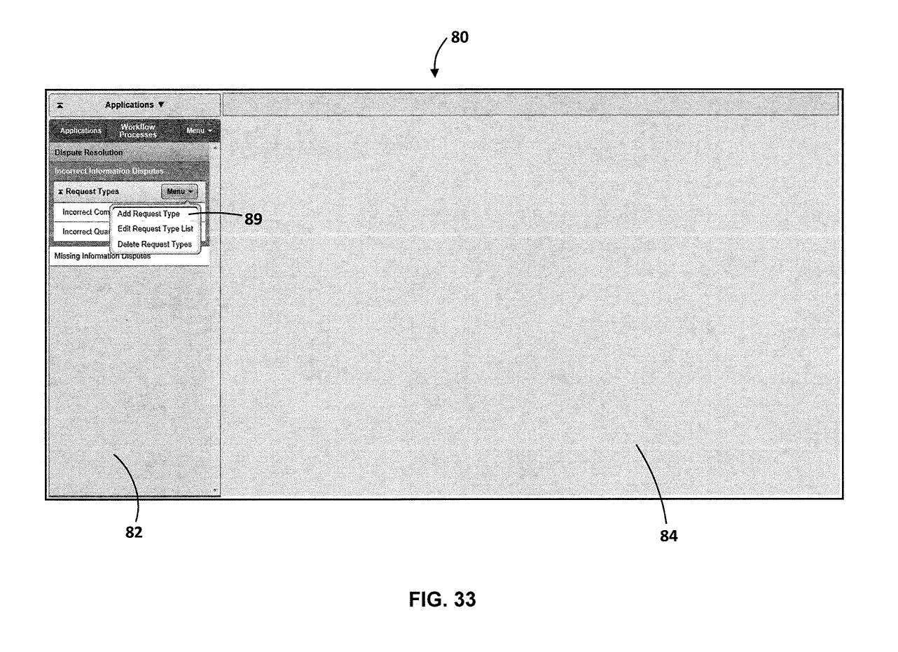

If desired, the configuration user may begin configuring the steps of the workflow process 44 before specifying the request types 46 the workflow process 44 is associated with. However, the information that is derived from the request types 46 will often be used in a later step of the workflow process 44, in which case it is advantageous to configure the individual request types 46 before defining the remaining details of the workflow process 44. As discussed above, each workflow process 44 of the workflow application 42 is associated with one or more request types 46, each of which is represented by a separate option in the request menu that is displayed to the end user to enable the end user to enter requests. Each request type 46 includes a different request form for the end user to fill in, the fields of the request form being configured to capture the information necessary to sufficiently identify, describe, and provide supporting information relevant to the request type 46. A request type 46 for a workflow process 44 may be added using a menu in the left hand pane 82 of the graphical user interface 80. In the example shown in FIG. 4, four different request types 46 have been created for the “Analyst Approval” workflow process 44. As shown in FIG. 33, the configuration user may add one or more request types 46 to a workflow process 44 by using a component of graphical user interface 80 presented in the left hand pane 82. In the example shown in FIG. 33, a request type dropdown menu 89 is provided for adding a request type 46 to the selected workflow process 44, editing the list of request types 46 available for that workflow process 44, or deleting a request type 46. Before adding a request type 46, the configuration user may proceed with specifying the overall framework of the associated workflow process 44, by creating task assignment nodes 94 and action nodes 96 that represent task assignments and actions to be taken, before defining the request type 46 and the details of the task assignments and actions. Alternatively, the configuration user may first utilize the request maintenance element 120 to define the request type 46 and the associated request form to be filled out by the end user when entering a request. The request maintenance element 120 may include features presented in the right hand pane 84 of the graphical user interface 80, such as in the form of a tabbed page. As shown in FIGS. 8-9F, the request maintenance element 120 may further include an origination method element 122, a request data element 124, a validations element 126, an attachments element 128, a status element 130, and an availability element 132, which may be presented in the form of sub-tabs.

The origination method element 122 of the request maintenance element 120 is configured to present options and receive user input related to how a request may be originated, i.e., whether a request based on the request type 46 may be created by an end user or by the system. For system-generated requests, the origination method element 122 may be used to set up various conditions and rules that would trigger an automatic system request, such as when a data value exceeds a predetermined limit. For user-generated requests, many of the request types 46 will be associated with existing data in the workflow system 40 or associated SPM 50 system, and thus will require the end user to select one or more data records in order to enter the request. For example, in a sales disputes workflow application 42, in order to enter a request that disputes the quantity sold in a particular sales record, the end user must first select that sales record. In some cases, a given request type 46 may be entered for more than one selected data record or report, and in other cases the request type 46 may be entered for only one data record or report. Where a workflow application 42 is based on existing data or reports, and a request type 46 of the workflow application 42 is user-generated, the origination method element 122 may provide an additional setting that allows the configuration user to specify whether an end user must select a data record in order to have this request type 46 as an option in the requests menu. If this setting is activated, then additional options may be provided to specify whether the end user may only select one record or report, or may select multiple records or reports for the request type 46. Although the details of the origination method element 122 are not shown, one of ordinary skill in the art would appreciate that a variety of graphical user interface elements may be utilized to achieve the above functionalities.

The request data element 124 of the request maintenance element 120 is configured to present options and receive user input for configuring the request form that appears when the end user selects the specified request type 46 from the request menu in a user portal view. The request form is designed to capture information that describes and supports the end user's request. As shown in FIG. 8, the request data element 124 may include a menu that enables the configuration user to include one or more data fields or entities that are required to capture the appropriate information for the request type 46. The ability to select special entities (as defined in U.S. application Ser. No. 13/602,423) in addition to regular data fields provides several benefits, as will be discussed below with respect to using an entity in a request or action form. One or more fields/entities may be added to the request form for the selected request type 46 using the “Add Fields” and “Add Entities” buttons of the request data element 124, as shown in FIG. 8. Additional buttons labeled “Delete,” “Up,” and “Down” may be included to permit the configuration user to delete a selected field/entity, or move it up or down in the list of field/entity for the request form.

Further detailed settings may also be provided for each selected field/entity. Although not shown in FIG. 8, the configuration user may “drill-down” into each listed field/entity, and specify additional details regarding how that field/entity is presented in the request form and what type of information must be provided by the end user. These details may then be presented in a “summary” section of each listed field/entity, as shown in FIG. 8. For example and without limitation, the configuration user may utilize the request data element 124 to enable a field/entity of the request form to be automatically filled in based on various related information, such as using data from a field of the data record that is selected by the end user as part of the request. If the setting for automatically filling in a field/entity is enabled, an additional setting may be provided to specify whether the end user may edit the data value that appears in the field/entity. In addition, the configuration user may specify whether the field/entity is required to enter the request, meaning whether it must be filled in before the request form can be saved in the workflow system 40, such as in the storage device 62. This setting may be available to the configuration user only where the field/entity is set to be editable by the end user. Furthermore, another setting may control whether the value entered in the field/entity should be stored with the request record associated with a request. Optionally, this setting may be enabled only if the field/entity is filled in automatically using a value from the related data record and the end user is not given the option to edit the value, because the related data record can be assessed by the workflow system 40 when an actor is viewing a request, and thus these values do not have to be stored with the request record for reference. Where the end user is given the option to edit the value in the field/entity, this setting may be turned on by default so that the user-entered value is always stored with the request record. Other potential settings include specifying whether a value for the field/entity may be manually entered by the end user, or may be selected by the end user from a predefined list. The use of a predefined list may facilitate entry by the end user and ensures that only valid data values are entered. The configuration user may also specify different labels to be displayed for a field in the request form, meaning that a single field/entity can be used in different contexts with customized labels that make the most sense for the request type 46. For example, a field that was originally labeled “Comments” in the system may be labeled by the configuration user as “Explanation” in the request form. One of ordinary skill in the art would recognize that these are merely some examples of settings that may be associated with each field or entity to be included in a request form, and that additional settings may be included and presented using various graphical user interface elements, such as dropdown menus, check boxes, etc. As shown in FIG. 8, after specifying the additional settings for each field or entity to be included in the request form, the configuration user may review or change those settings as they are summarized in the “Summary” section of the request data element 124.

The validations element 126 of the request maintenance element 120 is configured to present options and receive user input related to one or more validation conditions that may be checked for when the end user enters and saves a request. If one or more validation conditions are triggered by information the end user provides, or fails to provide, in the request form, the workflow system 40 may display an associated error message to the end user and the request record will not be saved. The validation conditions may be set up so that a return value of “True” triggers the error message. Alternatively, the system 40 may be set up such that a return value of “False” triggers the error message, depending on how the conditions are defined. As shown in FIG. 9A, the validations element 126 may include a menu that enables the configuration user to define one or more validation conditions and the associated error messages that appears when the condition is met. In the specific example shown in FIG. 9A, the validation condition is set up so that a return value of “True” triggers the error message. Various buttons labeled “New,” “Delete,” “Up,” and “Down” are presented via the validation element 126 of the graphical user interface 80, so that the configuration user may create, delete, or reorder validation conditions for the selected request type 46. The validation conditions may be performed in the order that they are listed in the validations element 126. Various methods and schemes may be used to set up validation conditions for the present workflow system 40, which are essentially logic statements that can be as simple or complex as warranted for the business needs at hand. For example and without limitation, the configuration user may define validation conditions using either “simple” or “advanced” condition options, which may be presented as part of the validations element 126 of the request maintenance element 120.

A “simple” condition may be expressed as a logic statement that compares the value of a field to a constant value or value from another field, using one of the standard comparison operators available for conditions. The available comparison operators may include the following: equal to; not equal to; less than; greater than; less than or equal to; and greater than or equal to. When the configuration user adds a validation condition by clicking the “Add” button of the validations element 126 (as shown in FIG. 9A) the validations element 126 may present a “Maintain Validations” element 134 (as shown in FIG. 9B) that enables the configuration user to define the validation condition using one or more simple “simple” or “advanced” conditions. The same “Maintain Validations” element may be accessed by the configuration user to modify a validation condition after it has been added. As shown in FIG. 9B, the configuration user may enter one or more conditions for defining the validation condition, which will be displayed within the “Maintain Validations” element 134 in a list, and an associated error message that is displayed to the end user when the validation condition is met. Although only one simple condition is shown in FIG. 9B, more than one simple condition may be specified for each validation condition, each simple condition being separated by an “AND” or “OR” logic value. Where a validation condition is made up of a strong of simple conditions, each must return with a value of “true” in order to trigger the validation condition and cause the error message to be displayed to the end user. To specify the details of each condition, the configuration user may select a condition from the list of conditions shown in FIG. 9B, and utilize an “Edit Condition” element 136 presented by the validations element 126 to define that condition. As shown in FIG. 9C, the edit condition element 136 may be presented as a window within the maintain validation element 134, and may include dropdown menus that aid the configuration user in setting up the simple condition.

An “advanced” condition is a more open-ended expression that may include multiple logic statements utilizing logic, math, or string functions. One of ordinary skill in the art would appreciate that there are numerous ways of building such advanced logic statements, and that the specific method and system described herein is merely one example thereof and should not be interpreted as being limiting in any way. Where advanced conditions are desired for setting up a validation condition, the present validations element 126 may include an “Expression Builder” element configured to provide options and receive user input related to defining advanced conditions. For example and without limitation, the expression builder element 138 may be accessed using a dropdown arrow 135 next to the “Validation Conditions” header of the maintain validation element 134, as shown in FIG. 9B. The expression builder element 138 may include various sub-tabs containing elements that may be used to set up each advanced condition. As shown in FIGS. 9D-9F, these sub-tabs may include various categories of data, functions, and operations, which the configuration user can use in countless combinations to create complex advanced conditions. Once one or more advanced conditions have been created using the expression builder element 138, the configuration user may organize those advanced conditions and create custom error messages using the maintain validation element 134, as shown in FIG. 9B and described above with respect to simple conditions.

The request maintenance element 120 may further include an attachments element 128, which may be presented as a sub-tab and is configured to present options and receive user input related to whether an end user entering a request is given the option to upload one or more files that are saved with the request as attachments. These attachments may be used to provide further information supporting the request. For example, where the request is for an expense reimbursement, useful attachments may include copies of receipts. Using the attachments element 128, the configuration user may specify whether a particular request type 46 does not allow attachments, allows attachments but does not require them, or requires at least one attachment. Any file included as an attachment with the request can be saved in the workflow or SPM system 40, 50, so that the file may be viewed along with the request record, such as by an actor accessing the request record from a customized portal view. Although the details of the attachments element 128 are not shown, one of ordinary skill in the art would recognize that a variety of graphical user interface elements may be utilized to achieve the above functionality.

The status element 130 of the request maintenance element 120 is configured to present options and receive user input related to the status that a request will be given once it is entered by the end user, and the various status values the request can be updated to have when actions are taken to resolve it. For example, the initial status for a request may be “New” or “Submitted,” and the request status may be updated as “In Progress,” “Approved,” or “Denied” as actions are taken to resolve the request. Using the status element 130, the configuration user may create custom status names to reflect the request status at various steps. The configuration user may define custom status names at a workflow application 42 level, such that the statuses are available for use for any request type 46 within the workflow application 42. Additionally, new status names may be entered by the configuration user when defining a specific request type 46, and those new status names are then made available from a central list of status values for the associated workflow application 42. Although the details of the status element 130 are not shown, one of ordinary skill in the art would recognize that a variety of graphical user interface elements may be utilized to achieve the above functionality.

The request maintenance element 120 may also include an availability element 132, which is configured to present options and receive user input regarding whether a specific request type 46 is listed in the request menu that is displayed to the end user, such as via a custom user portal. The option to set a request type 46 as unavailable and thus not displayed to the end user is useful in certain scenarios. For example, when a new request type 46 is being configured as part of a workflow application 42 that is being actively used, but that new request type 46 is not yet ready to be used by end users to enter requests. In addition, the configuration user may wish to make a request type 46 unavailable where a request type 46 is part of an active workflow application 42 but is no longer valid and should be removed, in which case setting the request type 46 as unavailable allows it to be removed from active use without affecting past or existing requests of that type. In contrast, simply deleting the request type 46 may also delete all associated existing requests of that type. Although the details of the availability element 132 are not shown, one of ordinary skill in the art would recognize that a variety of graphical user interface elements may be utilized to achieve the above functionality.

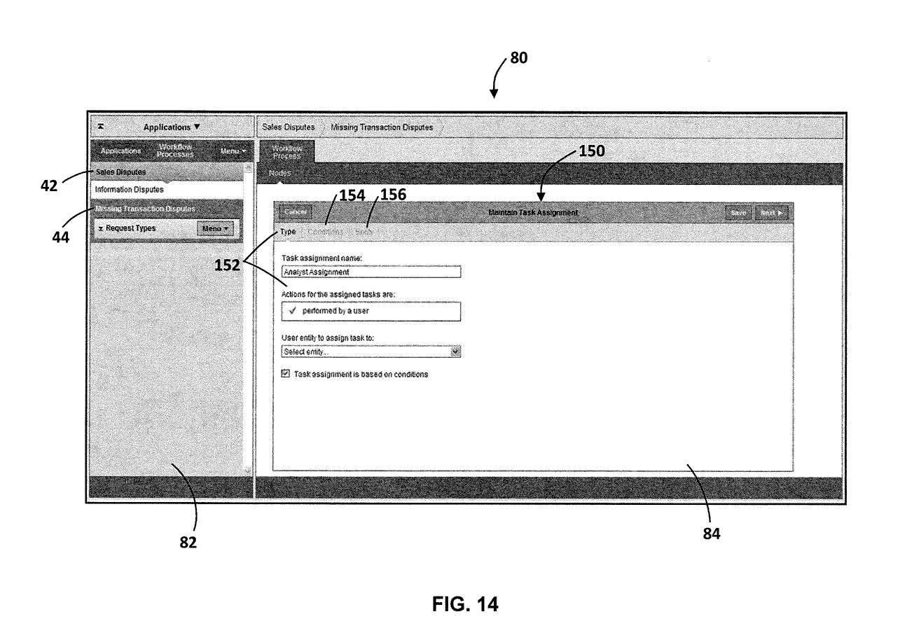

After specifying these workflow process-level settings, or optionally before doing so, the configuration user may set up each step of the workflow process 44 utilizing the workflow builder component 74 and the diagram component 76, which are configured to present a diagram within the graphical user interface 80 with additional menus for defining each workflow step. As discussed above and shown in FIG. 4, the configuration user may create one or more workflow processes 44 in a workflow application 42 using a menu in the left hand pane 82 of the graphical user interface 80, and then specify one or more request types 46 for each workflow process 44. These request types 46 may be presented as child objects of the workflow process 44 in the left hand pane 82. Each step of the workflow process 44 may then be configured using an intuitive diagram interface 140, which may be generated by the diagram component 76 of the software 66 and presented in the right hand pane 84 of the graphical user interface 80. The diagram interface 140 preferably includes the flow diagram 90 that displays the structure of the workflow process 44, with the workflow steps visually represented by individual nodes that are connected to each other depending on the relationships between those steps, as shown in FIG. 4. The diagram interface 140 may further include various maintenance elements, as described above and shown in FIGS. 14-21 and 24-31, which display various menus that may be used by the configuration user to specify the details of each workflow step.

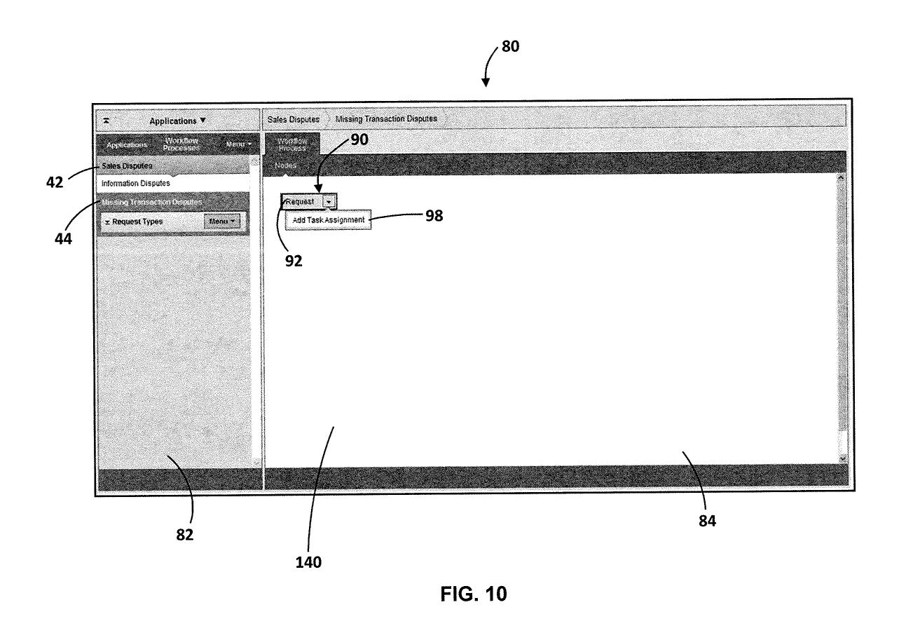

When a workflow process 44 is first added in the left hand pane 82 of the graphical user interface 80, the flow diagram 90 displayed in the right hand pane 84 only contains a single request node 92, from which a menu is accessible to begin building the steps of the workflow process 44. The request node 92 represents a request of any of the request types 46 specified for the selected workflow process 44, any of which will follow the same workflow steps. Any request types 46 that need to follow a different set of workflow steps must be defined in a separate workflow process 44 within the workflow application 42. As shown in FIG. 10, the request node 92 may include a dropdown menu 98 accessible by clicking an arrow located on the request node 92. The dropdown menu 98 may display two different types of workflow steps that may be added as nodes in the flow diagram—task assignment nodes 94 and action nodes 96. A task assignment node 94 represents a task that may be assigned to one or more actors for resolving the request, and an action node 96 represents an action that may be performed by an actor to whom a task has been assigned. The dropdown menu 98 may be configured to selectively display one of those workflow steps depending on context. In the example shown in FIG. 10, only the “add task assignment” option is shown in the dropdown menu 98, because it does not make sense to add an action (i.e., an action node 96) directly to the request node 92, as actions are only performed on tasks.

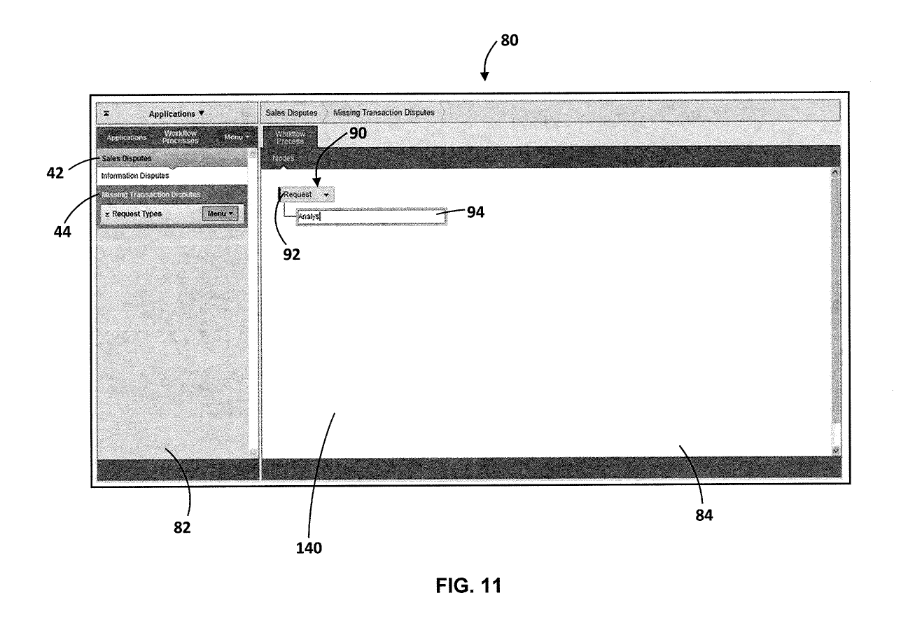

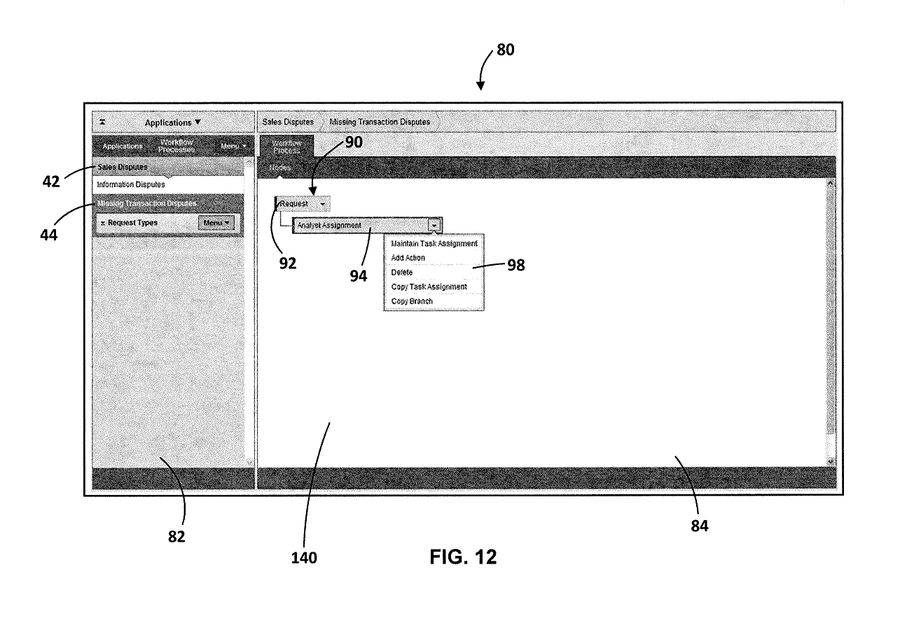

The specific example shown in FIGS. 10-14 is for creating a “Missing Transaction Disputes” workflow process 44 related to disputes regarding sales transaction data, but the steps described herein may be applied towards creating any workflow process 44 in the present workflow system 40. As shown in FIG. 10, the first step of building a workflow process 44 is to add one or more task assignments based on an end user request, so that the workflow system 40 can assign a task to one or more actors to handle the request when it is first entered in the workflow application 42. The configuration user may use the dropdown menu 98 to add a task assignment node 94 by selecting the “add task assignment” option, which as discussed above may be the only available option since the node to be added is based directly on the request node 92. As shown in FIG. 11, the configuration user may enter a custom name to describe the task assignment represented by the task assignment node 94. In example, the task assignment is named “Analyst Assignment” to indicate that the request should be assigned to a sales analyst. The task assignment node 94 is added to the workflow process 44 and visually represented in the flow diagram 90 of the diagram interface 140 merely by entering a name, without requiring the configuration user to define the details of the task assignment node 94 before adding other nodes. This allows the configuration user to create and review the entire structure of the workflow process 44 at a high level, before specifically defining each node. As shown in FIG. 12, after a node such as the task assignment node 94 has been added, the configuration user may use the dropdown menu 98 to specify the details of the task assignment node 94 (via the “Maintain Task Assignment” option), add an action node 96 that represents a available action to be taken on the task (via the “Add Action” option), delete the task assignment node 94 (via the “Delete” option), copy the task assignment node 94 (via the “Copy Task Assignment” option), or copy the entire branch of the workflow process 44 that is based on the task assignment node 94 (via the “Copy Branch” option). One of ordinary skill in the art would understand that these are merely some exemplary functions that may be offered to the configuration user via the dropdown menu 98, and that other workflow-related functions may be included using the dropdown menu 98 or other user interface.

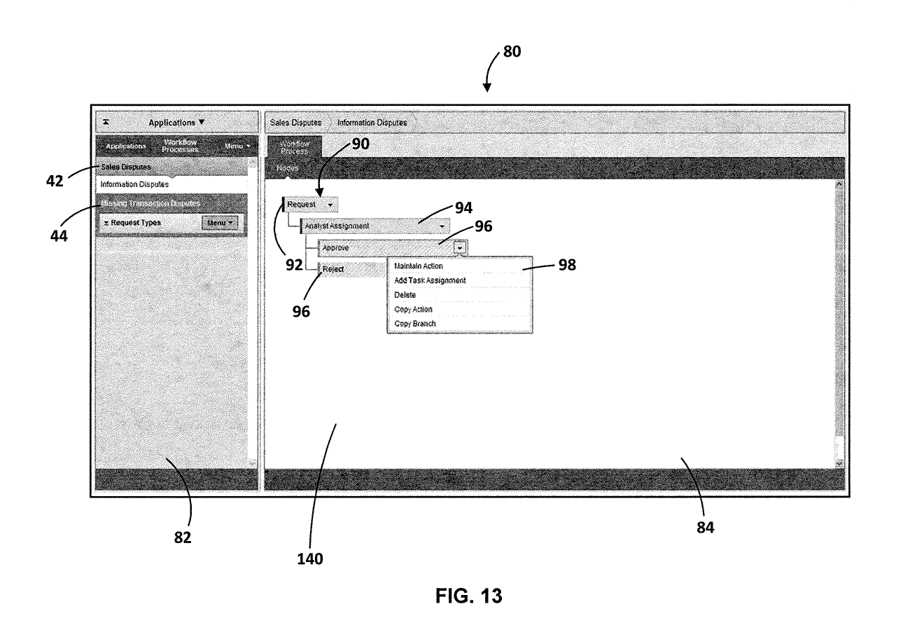

As shown in FIG. 13, the configuration user may utilize the “Add Action” option to add one or more action nodes 96 that represent actions that may be taken by the actor assigned to the task represented by the associated task assignment node 94. Similarly to adding a task assignment node 94, the configuration user only needs to enter a custom name to describe the action represented by the action node 96 to add it to the workflow process 44, without defining the details of the action nodes 96. In this example, an “Approve” action node 96 and a “Reject” action node 96 have been added, and their relationship to the “Analyst Assignment” task assignment node 94 is indicated by lines that connect the nodes in the flow diagram 90. The diagram interface 140 of the present workflow system 40 thus allows the configuration user to create workflow processes 44 in an intuitive and easy to understand manner, without becoming bogged down in the details at each step. Visually representing the structure of the entire workflow process 44 using the flow diagram 90 also enables the configuration user to easily modify the workflow process 44, using context-specific menus for additional functions related to each node.

As discussed above, a task assignment node 94 is used to specify the actor that is assigned to a task to act on a request. The assignment may be determined based on optional conditions, as well as entity relationships that may be stored in special entity assignment tables or hierarchy tables in the workflow or SPM system 40, 50. One or more task assignment nodes 94 may be based on a request node 92 to determine the initial task assignment(s) when a request is first entered in the workflow system 40 by an end user. In addition, one or more task assignment nodes 94 may be based on a preceding action node 96 to determine subsequent task assignment(s) as actions are taken on the preceding task in response to the request (e.g., for a workflow process 44 that requires multiple steps of review and response). After creating one or more task assignment nodes 94 for a workflow process 44, the configuration user may wish to define the details of the task assignment represented by each task assignment node 94. As shown in FIG. 12, the configuration user may access a task maintenance element 150 by selecting the “Maintain Task Assignment” option from the dropdown menu 98. For example and without limitation, the task maintenance element 150 may be presented as a “drill-down” menu, so that once the configuration user selects the “Maintain Task Assignment” option the flow diagram 90 shown in the right hand pane 84 of the graphical user interface 80 is replaced by the task maintenance element 150, as shown in FIG. 14. Once the configuration user is done using the task maintenance element 150, the user may exit this interface by selecting the “cancel” or “save” buttons shown in FIGS. 14-16, and the flow diagram 90 will be displayed in its place. The task maintenance element 150 may optionally include a task type element 152, a task conditions element 154, and a task entity element 156, which may be presented in the form of sub-tabs that are configured to present options and receive user input related to specific details of the task assignment.

The task type element 152, an exemplary embodiment of which is shown in FIG. 14, may be used by the configuration user to specify whether a task will be assigned to an individual (such as a user) or a system component for taking actions on. As discussed above, for most workflow applications 42 the actions to complete tasks will be performed by individuals. However, there may be some request types 46 that are so straightforward that no human intervention is required to respond, in which case it is appropriate to assign the task to a system component that can automatically complete the task based on some predetermined condition or logic. For example, in a sales disputes workflow application 42, certain fields of information about a customer may be displayed, such as the customer address, and one of the available request types 46 may be “Update Customer Address.” An organization may decide that no human review of such a request is required, and the workflow system 40 may simply respond to it, in which case the task for such a request is assigned to a system component and the associated actions specified for that task assignment will determine how the system component responds. The configuration user may specify whether the task represented by the selected task assignment node 94 is assigned to a user or system component by making a selection in the task type element 152, as shown in FIG. 14. Depending on whether a user or system component is selected, the task type element 152 may display context-specific choices for the specific actor that the task is assigned to. For example, where the task will be acted upon by a user, the configuration user may specify the type of user entity the task will be assigned to. The available user entities may be presented in a dropdown menu, and may consist of all of the entities that were selected in the entities element 102 of the application settings element 100 (shown in FIG. 6) as the entities that workflow tasks can be assigned to for that workflow application 42. For each given task assignment node 94, only one user entity should be assigned to take action, since each task assignment node 94 represents an individual task to be acted upon. If tasks need to be assigned to more than one user entity, then a separate task assignment node 94 should be configured for each task. The type of user entity selected in the task type element 152 may represent a category of users, such as “Employees,” or “Agents.” The configuration user may specify the specific value of the user entity (i.e., identify an individual from the category of users) using the task entity element 156 described below. As used herein, the term “value” when used in relation to entities refers to a specific instance of the entity, in most cases a specific individual. Regardless of whether the task assignment node 94 is associated with a user or system component, the configuration user may specify whether conditions are used to determine if and when the task represented by the task assignment node 94 will be assigned to the user or system component, such as by selecting a checkbox within the task type element 152, as shown in FIG. 14.

The task conditions element 154 may be configured to only be displayed if the “task assignment is based on conditions” checkbox of the task type element 152 is checked by the configuration user, thus helping streamline the task assignment setup process and eliminate showing irrelevant definition options. The task conditions element 154 may be used to specify one or more conditions that are used to determine when a task will be assigned to the user entity or system component specified to take action on the task. For example and without limitation, the task conditions element 154 of the task maintenance element 150 may include the same or substantially similar menus and functions as the validations element 124 that is used to create validation conditions for requests and shown in FIGS. 9A-9F. The process for setting up conditions for task assignments may be the same as or substantially similar to the process for setting up validation conditions for requests. Since the details of setting up validation conditions have already been discussed above with respect to the request maintenance element 120 and illustrated in the figures, they will not be repeated here for simplicity's sake. One of ordinary skill in the art would appreciate that the mechanisms for creating conditions may be presented in different user interfaces than the ones shown in FIGS. 9A-9F, without changing the inventive concepts embodied therein. The configuration user may apply a combination of simple and advanced conditions to each task assignment node 94, which allows for unlimited flexibility to configure complex routing rules for the workflow process 44. For example, in a sales disputes workflow application 42 that allows for requests to change the date of a sales transaction, the configuration user may wish to assign the request to different members of a sales operations group for approval depending on how far in the past the requested date is. A requested date that is more than 30 days prior to the current date could be assigned to a sales operations manager, while a requested date that is less than 30 days prior to the current date could be assigned to a sales operations analyst. The configuration user can easily achieve this requirement by creating two different task assignment nodes 94 that are associated with the same request node 92, each task assignment node 94 having a different condition that results in the task being assigned to a different user entity value.

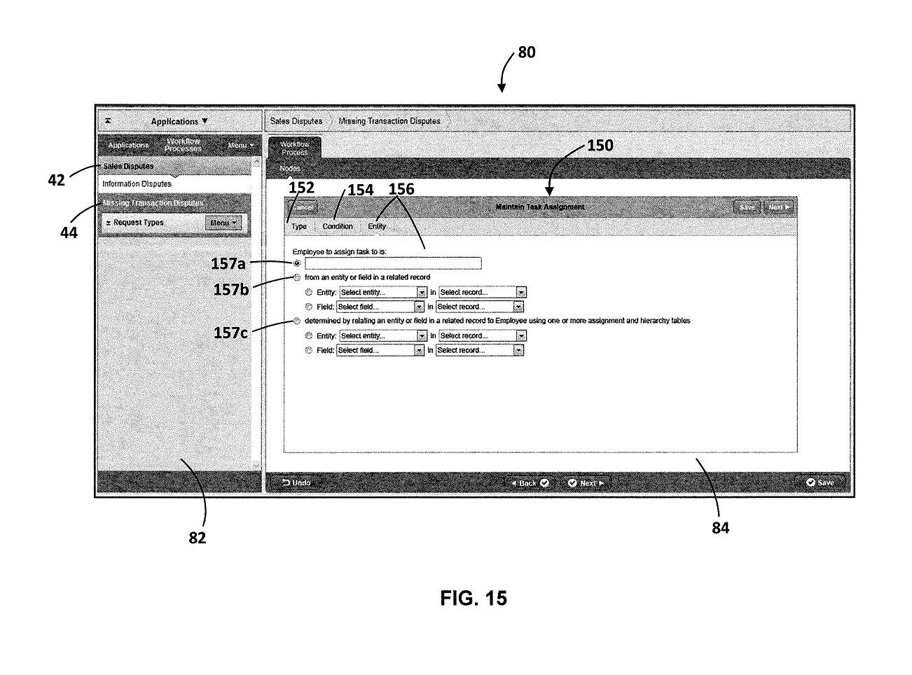

As shown in FIG. 15, the task maintenance element 150 may include a task entity element 156 that enables the configuration user to specify the value of the user entity that the task is assigned to (i.e., the specific individual that is assigned to act on the task). Alternatively, if the task is assigned to a system component rather than a user, there is no need to further specify which system component will take action on the task. Instead, conditions may be set up to determine when the system component will take action on the assigned task. The contents of the task entity element 156 may be context-specific and based on the configuration user's inputs in the task type element 152. For example, if the configuration user selected “Employees” as the entity that the task is assigned to in the task type element 152, the task entity element 156 may automatically prompt the configuration user to enter a value to identify a specific employee, as shown in FIG. 15. The task entity element 156 may also present the configuration user with different options for specifying an entity value (i.e., identifying an individual) that the task is assigned to. These options can support workflow processes 44 that are simple and relatively fixed in nature, as well as those that are more dynamic, and may be based on values in various other records related to the workflow process 44 and/or the use of entity assignments and hierarchy relationships.

As further shown in FIG. 15, the task entity element 156 may receive configuration user input for the entity value by using a fixed or constant value entered in a section shown as 157a. This option 157a is appropriate for certain workflow processes 44 where there is a single value of an entity (e.g., one specific employee) that is always assigned tasks for a given step in the workflow application 44. Alternatively, as shown by option 157b, the configuration user may also choose to use an entity value obtained from a field/entity in a “related record,” which (depending on what workflow step is being defined) may include the data record that the request is based on (if the request type 46 is based on a data record), the request record itself, or a prior task record. The difference between a request record and a task record will be discussed in detail below. The task entity element 156 may present the available field/entity and related records in dropdown menus to aid the configuration user in selecting an entity value. As an illustrative example, a sales transaction data record that the request type 46 is based on may contain a field that stores the employee entity who is the sales director responsible for that transaction. The configuration user may then choose that sales director employee entity value from the selected data record as the actor to whom the task should be assigned. Alternatively, as shown by option 157c, the configuration user may also obtain an entity value using one or more assignment or hierarchy tables that represent relationships between a field/entity in a related record and the entity of the task assignment. This option 157c may be used where the workflow system 40 utilizes the special business entities of U.S. patent application Ser. No. 13/602,423, which describes in detail how assignment and hierarchy tables may be used to define the relationships between multiple entities in a business-oriented manner. As an illustrative example, in a sales disputes workflow application 42, certain request types 46 may generate tasks that are assigned to the direct manager of the end user entering the request. In this case, the identity of the individual assigned to the task varies depending on which end user enters the request. Accordingly, this subordinate-manager relationship can be represented by an employee hierarchy table in the workflow or SPM system 40, 50, and the present system 40 may be configured to use the value of the employee end user who enters the request (which is stored in the request record) to look up and determine through the employee hierarchy table the appropriate manager to assign the task to.

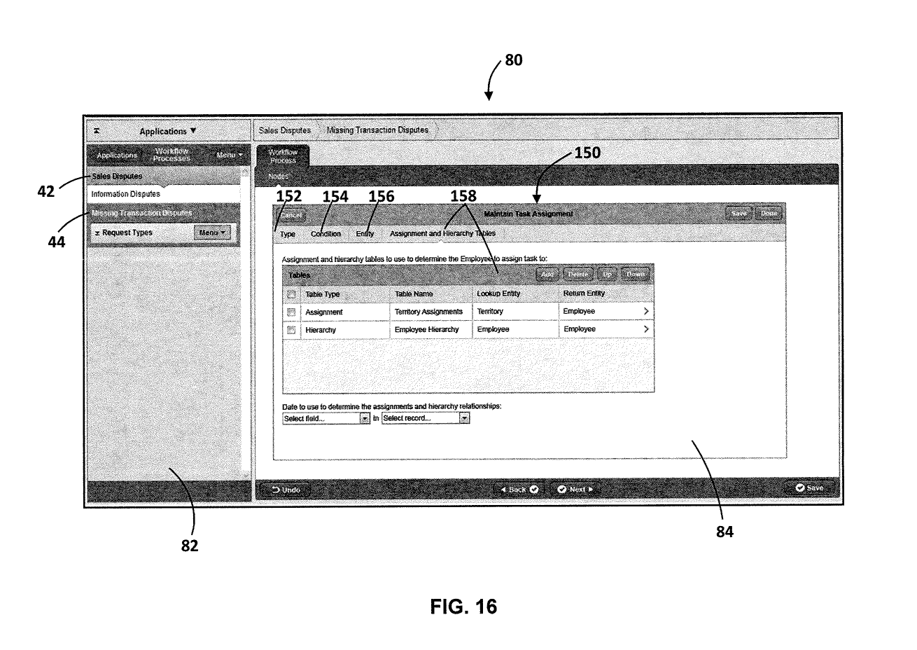

If the configuration user selects the third option 157c to use one or more assignment or hierarchy tables to specify the entity value for the task assignment, the task maintenance element 150 may selectively display additional elements for identifying those tables, such as in the form of sub-tabs. As shown in FIG. 16, the task maintenance element 150 may include a table selection element 158 that enables the configuration user to specify the specific entity assignment and/or hierarchy tables that should be used to determine the entity value to assign the task to. Using the table selection element 158, the configuration user may select any combination of entity assignment tables and/or hierarchy tables that already exist in the workflow system 40 or associated SPM system 50 to relate the entity value related to the request to the value of the entity that the task is assigned to. One or more of the assignment and/or hierarchy tables may be effective-dated, meaning that the relationships represented by those tables may only be valid during a specific time period, and may change over time. If this is the case, the configuration user may specify the effective date to use to determine the relationship between the entity value related to the request and the entity value for the task assignment. As shown in FIG. 16, the configuration user may specify this effective date by selecting a field in any related record that exists at the time of the task assignment, such as a field in the data record, a field in the request record, or a field in prior related task records.

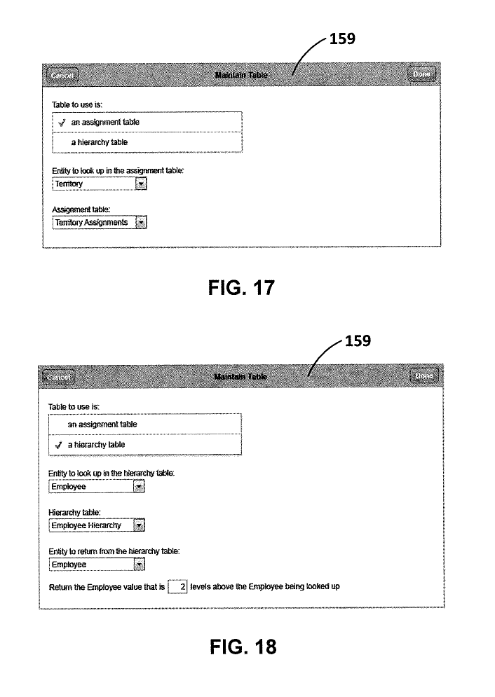

As an illustrative example, in a sales dispute workflow application 42, requests to change certain data records representing sales transactions may be handled by different sales operations specialists (employees) depending on the customer involved in the sales transaction. In this example, the customer is an entity in the sales transaction data record, and the sales operations specialist is the user entity that tasks are assigned to. To determine the specific employee entity value to assign a task to for such a request, two entity assignment tables may be used by the configuration user to set up the task assignment. The first assignment table relates the “customers” entity to the “sales operations positions” entity (which may include specialists, analysts, and other positions) assigned to the customers, and the second assignment table relates the “sales operations positions” entity to the “employee” entity (i.e., the employees that are assigned to those positions). The sales operations positions to employees entity assignment table may be effective-dated, and the date to use to determine the appropriate relationship may be a “Transaction Date” from the sales transaction data record associated with the request. In this manner, the present workflow system 40 allows individual sales operations specialists to be automatically assigned to tasks related to sales transaction record change requests, depending on the identity of the customer involved in the sales transaction.

Where multiple assignment or hierarchy tables are used to define a task assignment, the configuration user must specify an entity to “look up” in the tables, which narrows down the available assignment tables in the system to use. In the case of an entity hierarchy table, the user must also specify the entity to “return” from the look up. The “return” entity for an assignment table does not need to be specified for an assignment table because an assignment table by definition only contains two entities and represents the relationship between values of those entities, whereas a hierarchy table may include different entities, so the “return” value must be specified. In the example shown in FIG. 16, the configuration user has specified an assignment table and a hierarchy table to be used to determine the entity value for the task assignment. FIGS. 17 and 18 illustrate an exemplary maintain table element 159 that may be displayed to the configuration user when the user selects the “Add” button in the table selection element 158 shown in FIG. 16 to add an assignment or hierarchy table. As shown in FIG. 17, the configuration user may use the maintain table element 159 to add the “Territory Assignments” assignment table by selecting an assignment table, then specifying the “Territory” entity as the “Look up” entity. The maintain table element 159 may be configured to present the possible entity and table selections through drown down menus, and present context-specific options that are based on the configuration user's previous selections. For example, based on the configuration user's selection of the “Territory” entity, the drop-down menu that allows the configuration user to select a specific assignment table may be configured to only display assignment tables in the system that includes the “Territory” entity instead of all available assignment tables. Furthermore, as shown in FIG. 18, where the configuration user selects a hierarchy table as the type of table to be used, the maintain table element 159 may be configured to display additional options that were not available for an assignment table. In the example shown in FIG. 18, the configuration user may use the maintain table element 159 to add the “Employee” hierarchy table by first selecting a hierarchy table, then specifying the “Employee” entity as the “look up” entity, then selecting the “Employee Hierarchy” table as the specific hierarchy table to be used, and finally selecting the “Employee” entity as the “return” entity. As discussed above, the “return” entity is not presented as an option to the configuration user when selecting an assignment table, because there can only be one return entity in an assignment relationship. The maintain table element 159 shown in FIG. 18 also includes an option for the configuration user to specify how many levels the “return” entity is above the “look up” entity within the hierarchy. For example, if a task is to be assigned to an employee that is the second level manager of the end user (also an employee) entering the request, an employee hierarchy table may be used to determine the specific employee the task should be assigned to. By setting the hierarchy level at “2,” the system would first look up the employee who entered the request, then traverse two levels up to determine the person's second level manager for the task assignment.

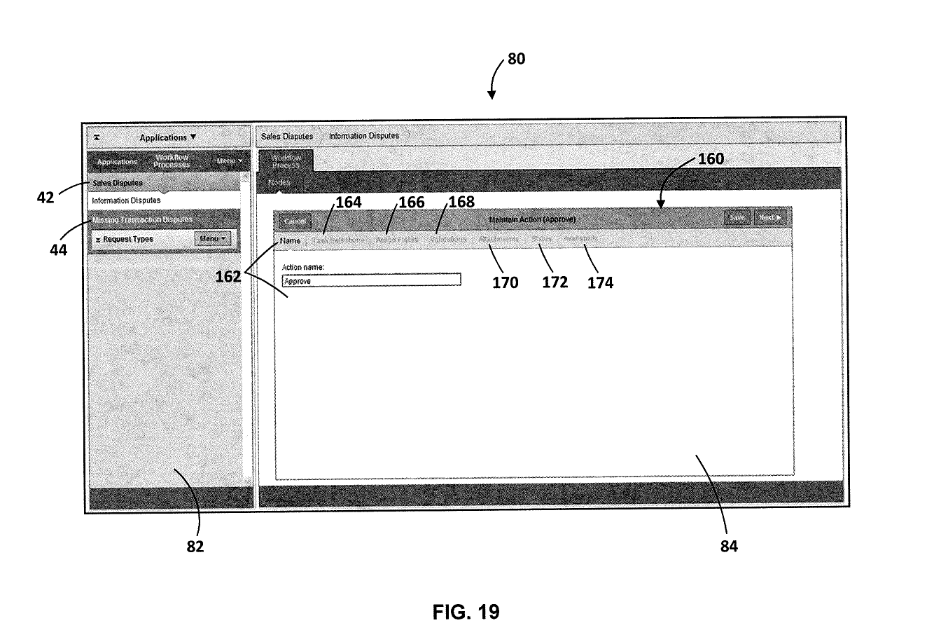

As discussed above with respect to FIG. 13, one or more action nodes 96 may be associated with a task assignment node 94 to represent one or more given actions that may be performed to complete tasks created by the associated task assignment node 94. A given task assignment node 94 may have as many associated action nodes 96 as necessary to represent the various responses available for that step of the workflow process. As shown in FIG. 7, each action node 96 specified for a given task assignment node 94 may be presented to the end user that is assigned to act on the task (i.e., the actor) as a separate option in an action menu 112, which may be part of a task view element 110 that display information regarding tasks assigned to the user. Each action available to the actor includes a separate action form for the actor to fill in, the fields of the action form being configured to capture information necessary to support the action. The information entered by the actor into the action form may be stored in the task record for the associated task assignment, forming part of a completed task record. After creating one or more action nodes 96 for a workflow process 44, the configuration user may wish to define the details of the action represented by each action node 96. As shown in FIG. 13, the configuration user may access an action maintenance element 160 by selecting the “Maintain Action” option from the dropdown menu 98. For example and without limitation, the action maintenance element 160 may be presented as a “drill-down” menu similar to the task maintenance element 150, such that once the configuration user selects the “Maintain Action” option the flow diagram 90 shown in the right hand pane 84 of the graphical user interface 80 is replaced by the action maintenance element 160, as shown in FIGS. 19-21. Once the configuration user is done using the action maintenance element 160, the user may exit this interface by selecting the “Cancel” or “Save” buttons shown in FIGS. 19-21, and the flow diagram 90 will be displayed in its place. The action maintenance element 160 may optionally include an action name element 162, a task selection element 164, an action fields element 166, an action validations element 168, an action attachments element 170, an action status element 172, and an action availability element 174, which may be presented in the form of sub-tabs that are configured to present options and receive user input related to specific details of the selected action.

FIG. 19 illustrates an exemplary embodiment of the action name element 162 of the action maintenance element 160. The action name element 162 may be configured to display the name of the action, which should have been specified by the configuration user when the action node 96 was added to the workflow process 33 through the diagram interface 140 and displayed in the flow diagram 90. Using the action name element 162, the configuration user may change the custom name for the action after the action node 96 has been created. This functionality is important because the name of the action node 96 will be the name that is displayed to the end user that is assigned to act on a task as an option in the action menu 112, as shown in FIG. 7.

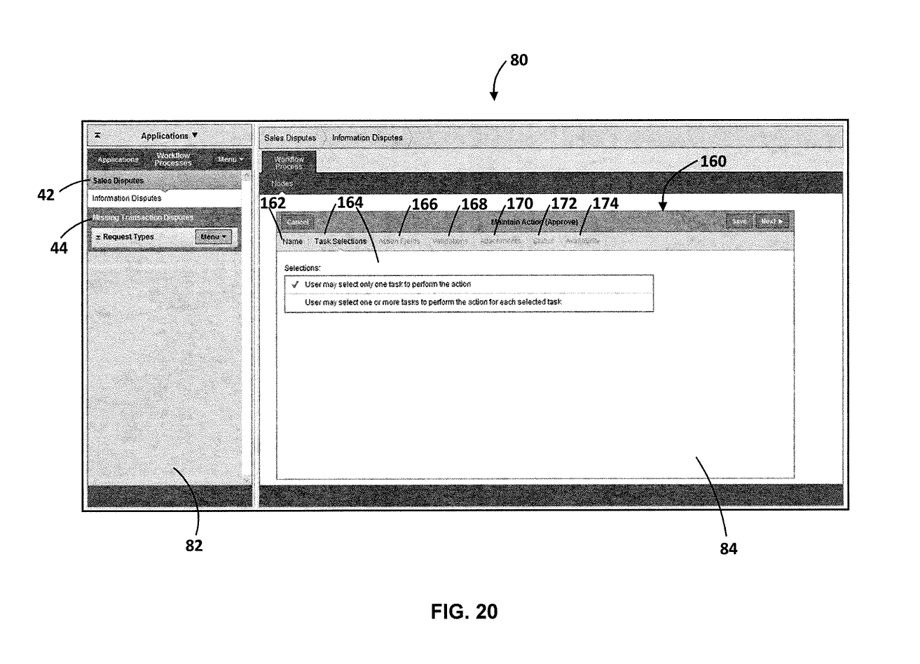

As shown in FIG. 20, the task selection element 164 of the action maintenance element 160 may be configured to provide options and receive user input regarding whether the end user assigned to act on a task may only perform the action on a single task, or may perform the action on multiple selected tasks. In many workflow applications 42 and processes 44, each task must be acted upon separately because the end user performing the action must provide in the action form information that is specific to the particular request that generated the task. For example, in a sales disputes workflow application 42, if the request that generated the task was a request to change information in a selected data record, then the action performed in response to the request must uniquely address the specific changes being requested. In contrast, in a workflow application 42 or process 44 where no information specific to the associated request is required for the end user to take action (e.g., where the end user only needs to approve/reject a request without entering any additional information into the action form), then one action may be performed on multiple selected tasks. In the latter example, the associated action form may be configured such that no fields of information from an associated request record or data record may be used in the action form, since each selected task has its own associated data record and request record, and they system cannot determine a single value for a field from one of those records to be used to populate the action form.

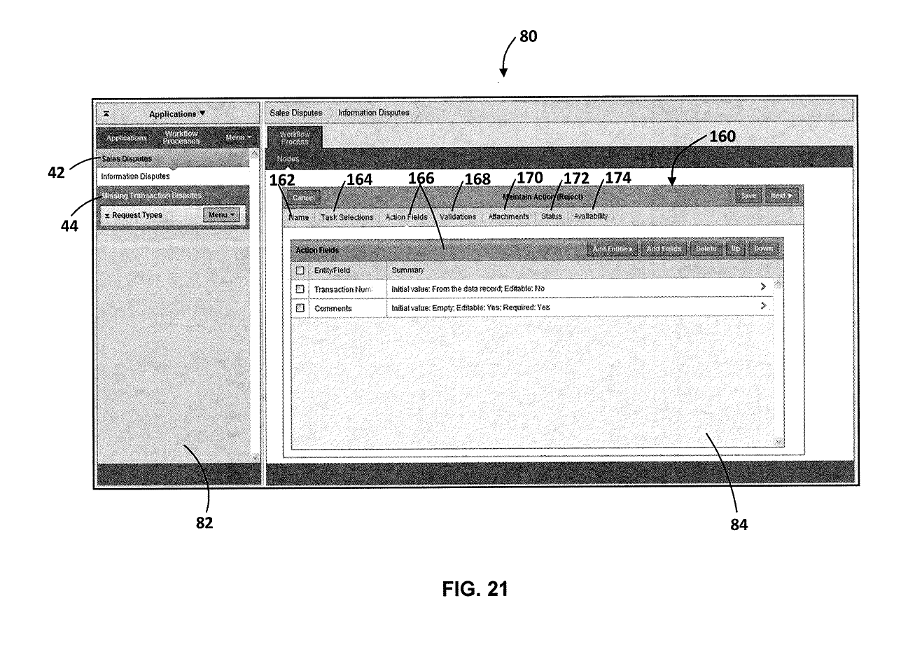

As shown in FIG. 21, the action fields element 166 of the action maintenance element 160 may be configured to provide options and receive user input for setting up the action form that is presented to an actor when the actor selects the action represented by the action node 96 being defined, for example by selecting the action from the action menu 112 that is presented via the task view element 110 of a custom user portal 54, as shown in FIG. 7. The action form is designed to capture information from the actor that is necessary to support the action. Using the action fields element 166, the configuration user may create a fully customized action form by adding, ordering, and defining various fields/entities to the form. Like the request data element 124 of the request maintenance element 120 shown in FIG. 8, the action fields element 166 of the action maintenance element 160 may be configured such that the configuration user may define additional details regarding each field/entity of the action form by “drilling-down” into each listed field/entity. These details may then be presented in a “Summary” section of each listed field/entity, as shown in FIG. 21. Although the exact user interface for defining the details of each field/entity of the action form is not currently shown, one of ordinary skill in the art would appreciate that a variety of interfaces may be used to present options and receive user input related to these details. When defining the action form, the configuration user may be presented with many of the same options as when defining the request form. For example and without limitation, the configuration user may utilize the action fields element 166 to enable a field/entity of the action form to be filled in automatically based on various related information, such as using data from an associated data record or request record. Further detailed settings may include an option to indicate whether a particular field/entity of the action record may be edited by the end user that is acting on the task, which may be limited to where the field/entity is filled in automatically. The configuration user may also specify whether a field/entity is required in order to complete the action, meaning whether the field/entity of the action form must be filled in by the actor before the action form can be saved. This option may be provided only if the field/entity is set to be editable by the actor. Furthermore, another setting may control whether the value entered in the field/entity should be stored with the completed task record associated with the task assignment and action. Optionally, this setting may be enabled only if the field/entity is filled in automatically using a value from the related data record, and the actor is not given the option to edit the value, because the related data record can be accessed by the workflow system 40 when an end user is viewing a completed task, and thus those values do not have to be stored with the task record for reference. In contrast, where the actor is given the option to edit the value in the field/entity of an action form, that value should be stored with the completed task record so it may be reviewed later by an end user. Other potential settings include specifying whether a value for the field/entity may be manually entered by the actor, or maybe selected by the actor from a predefined list. The use of a predefined list may facilitate entry of information by the actor and ensures that only valid data values are entered in the action form. The configuration user may also specify different labels to be displayed for a field in the action form, meaning that a single field/entity may be used in different contexts with customized labels that make the most sense for the action being defined. For example, in an action form for the action “Reject,” a field that was originally named “Comments” in the system may be labeled by the configuration user as “Reason for Rejection” in the action form. One of ordinary skill in the art would recognize that these are merely some examples of settings that may be associated with each field or entity to be included in an action form, and that additional settings may be included and presented using various graphical user interface elements, such as dropdown menus, check boxes, etc. As shown in FIG. 21, after specifying the additional settings for each field/entity to be included in the action form, the configuration user may review or change those settings as they are summarized in the “Summary” section of the action fields element 166.

The action validations element 168 of the action maintenance element 160 may be configured to present options and receive user input related to one or more validation conditions that may be checked for when the end user (i.e., actor) enters information into and saves an action form. Similar to the validation conditions discussed above with respect to the validations element 126 of the request maintenance element 120, the validation conditions associated with each action node 96 and the related action form may be set up so that a return value of “True” triggers an error message, meaning that if any of the validation conditions is met (evaluates to true), then an associated error message configured for that validation condition is displayed to the actor and the action form is not saved. The action validations element 168 may include the same or substantially similar interfaces and functions as the validations element 126 and associated menus shown in 9A-9F, which may be used by the configuration user to create one or more validation conditions using a combination of “simple” and “advanced” condition options. Since the details of setting up validation conditions have already been discussed above with respect to the request maintenance element 120, the task conditions element 154, and illustrated in the figures, they will not be repeated here for simplicity's sake. One of ordinary skill in the art would understand that the mechanisms for creating conditions may be presented in different user interface than the ones shown in FIGS. 9A-9F, without changing the inventive concepts embodied therein.

The action maintenance element 160 may further include an action attachments element 170, which may be presented as a sub-tab as shown in FIGS. 19-21 and be configured to present options and receive user input related to whether the end user performing the action is given the option to upload one or more files that are saved with the action form as attachments. These attachments may be used to provide further information supporting the action taken by the actor, and may be viewed later along with the completed task record, such as by an end user accessing the task record through a customized portal view. Using the action attachments element 170, the configuration user may specify whether the action represented by the action node 96 being defined does not allow attachments, allows attachments but does not require them, or requires at least one attachment. The details of the action attachments element 170 are not shown in the figures, as one of ordinary skill in the art would appreciate there are numerous ways of making these settings available to the configuration user.

The action maintenance element 160 may also include an action status element 172, which may be presented as a sub-tab as shown in FIGS. 19-21 and be configured to present options and receive user input related to the status that a request will be given once the action at issue is performed to completed the associated task. This provides the present workflow system 40 with the ability to perform real-time updates of the request status as actions are taken to resolve the request, which allows anyone with access to view the request to know at all times where a request is in the workflow process. Similar to the status element 130 of the request maintenance element 120 discussed above, the action status element 172 may allow the configuration user to define custom status names at a workflow application 42 level, such that the defined statuses are available for use for any action within the workflow application 42. Additionally, new status names may be entered by the configuration user when defining a specific action, and those new status names are then made available from a central list of status values for the associated workflow application 42. The details of the action status element 172 are not shown in the figures, as one of ordinary skill in the art would appreciate there are numerous ways of making these settings available to the configuration user.

As shown in FIGS. 19-21, the action maintenance element 160 may also include an action availability element 174 configured to present options and receive user input related to whether a specific action is listed in the action menu that is presented to the end user/actor, such as the action menu 112 shown in FIG. 7. The option to set an action as being unavailable and thus not displayed to the end user is useful in certain scenarios. For example, when a new action is being configured as part of a workflow application 42 or process 44 that is being actively used, but that new action is not yet ready to be used by end users to resolve tasks, the action should not be displayed until it is ready for use. Additionally, the configuration user may wish to make an action unavailable where the action is part of an active workflow application 42 or process 44, but is no longer valid and should not be used. In this case, setting the action as being unavailable removes it from active use without deleting it from the system 40, as deleting the action would negatively affect task records for past tasks where this action has been performed. The details of the action availability element 174 are not shown in the figures, as one of ordinary skill in the art would appreciate there are numerous ways of making these settings available to the configuration user.

In the manner described above, a configuration user may utilize the diagram interface 140 of the present workflow system 40 to create each step of a workflow process 44 by representing those steps as a request node 92 and one or more associated task assignment nodes 94 and action nodes 96 in a flow diagram 90. Either during or after setting up the structure of the workflow process 44, the configuration user may define the details of each node by utilizing various maintenance elements that may be presented as drill-down menus, including the request maintenance element 120, task maintenance element 150, and action maintenance element 160. In this manner, even complex workflow applications 42 and processes 44 may be easily created and modified, while allowing for a great degree of flexibility and customization. Each request entered by the end user is associated with a request record that is stored in the workflow system 40, while each task assignment and the one or more actions related to the task assignment is associated with a task record. These request and task records contain information related to the request, task assignment, and action performed on the request, and may be accessed by end users with the proper permission to review the progress or resolution of a request. As will be further discussed below, the present workflow system 40 is configured to update those request records and task records in real-time in response to end user activity, such as the entrance of a request or performance of an action, as well as create task assignments in real-time.

In certain workflow processes 44, separate tasks may be assigned to different user entities at the same time, and all of these tasks must be completed before a subsequent task can be assigned. This is known as a multi-task dependency. For example, a request to change a sales person's assignment to a new sales team may require the approval of both the sales person's current team leader and new team leader. Both team leader entities must approve the request for the new assignment, and then the request for the change is assigned to a sales operations director for final approval. In other words, the assignment of the final task is not dependent upon a single previous task and action, but rather upon two previous task and actions. In known workflow systems that do not support such multi-task dependencies, these workflow steps that should be handled in parallel must be performed and processed in a linear fashion. In the sales person assignment change example, the current team leader would need to approve the change request first before it is assigned to the new team leader for approval, or vice versa. In other words, the current team leader and new team leader would not be able to take action on the request concurrently.

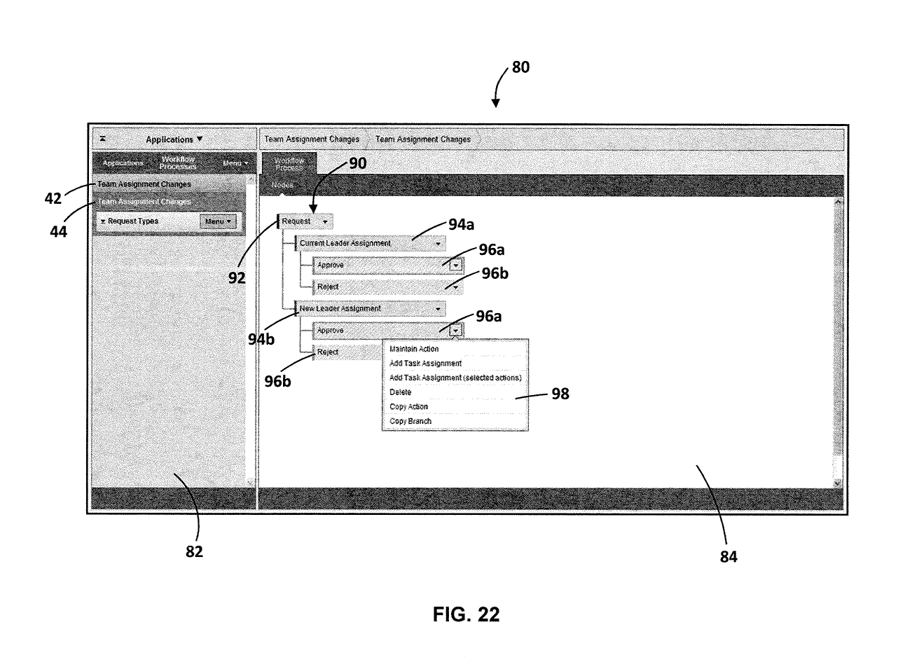

The present workflow system 40 supports such multi-task dependencies in workflow applications 42, and provides the configuration user with a simple and streamlined way of setting up these multi-task dependencies in workflow processes 44. For the sales person assignment change example discussed above, the configuration user may utilize the workflow builder component 74 and diagram component 76 of the software 66 to configure two different task assignments, each of which will create a task assigned to the appropriate team leader for action in real-time as soon as the request is entered by the end user. As shown in FIG. 22, the current leader task assignment and the new leader task assignment may be visually represented as first and second task assignment nodes 94a, 94b that are associated with the request node 92 in the flow diagram 90 displayed in the graphical user interface 80. As shown by the lines connecting the first and second task assignment nodes 94a, 94b to the request node 92, instead of the second task assignment node 94b being depending on the first task assignment node 94a, or vice versa, both task assignment nodes 94a, 94b are directly connected to the request node 92 such that the respective task assignments are created concurrently in real-time in response to an end user entering the request. Each of the first and second task assignment nodes 94a, 94b are further associated with an “Approve” action node 96a and a “Reject” action node 96b, which represent actions that may be taken on the task by the current leader and new leader. The configuration user may create and define each one of these nodes in the manner previously discussed with respect to FIGS. 4-21.

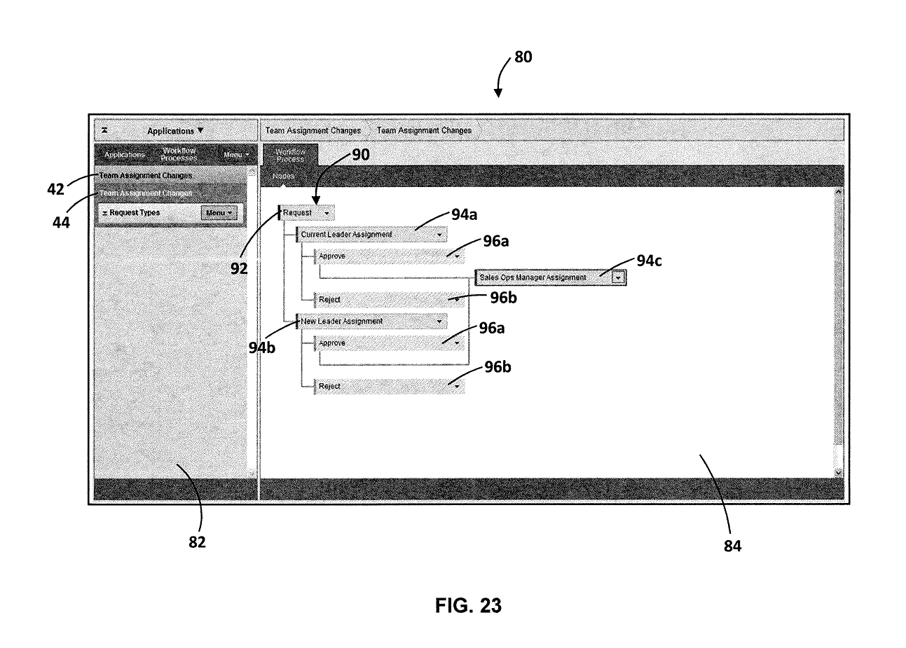

In order to create a third task assignment that is dependent on actions taken on the first and second tasks, the configuration user may select the proper action node 96a, 96b from each of the first and second task assignment nodes 94a, 94b, and access the dropdown menu 98 by clicking an arrow located on the action nodes 96a, 96b. In the sales person assignment change example shown in FIG. 22, both the current leader and new leader must approve the request before it is assigned to the sales operations manager. Accordingly, the configuration user may create this multi-task dependency in the workflow process 44 by selecting the “Approve” action nodes 96a for the first and second task assignment nodes 94a, 94b, and adding the next dependent task assignment by selecting the “Add Task Assignment (selected actions)” option, as shown in FIG. 22. The system 40 may be configured to allow multi-selection of nodes by the user merely clicking on each node, which highlights the node to be part of the multi-task dependency. This feature allows the configuration user to create a task assignment that is dependent on separate actions performed on more than one prior task assignment. The configuration user may create the third task assignment node 94c merely by entering a name for the task assignment node 94c, and may later define the details of that task assignment using the features of the task maintenance element 150 discussed previously. As shown in FIG. 23, the multi-task dependency is illustrated by the lines connecting the third task assignment represented by the “Sales Ops Manager Assignment” task assignment node 94c to the “Approve” action nodes 96a for the first and second task assignment nodes 94a, 94b. In other words, both the current team leader and the new team leader must perform the “Approve” action on the request before the third task assignment to the sales operation manager is created in the system. If the new team leader, for example, had elected to take the “Reject” action on the request, the third task assignment would not be created in the workflow system 40 and the sales operations manager would not be assigned to act on the request. The present workflow system 40 thus allows multi-task dependencies to be easily set up, visualized, and modified through an intuitive and user-friendly interface.

As discussed above with respect to the request data element 124 of the request maintenance element 120, special business units known as entities (as defined in U.S. application Ser. No. 13/602,423) may be used along with regular data fields in request forms and action forms that are designed to capture relevant information regarding requests and actions. By using these special entities as fields in request forms and action forms, the present workflow system 40 achieves several advantageous functionalities. For example and without limitation, where an entity associated with a preexisting entity table in the workflow or SPM system 40, 50 is used as the field of a request or action form, the entity allows up to date and accurate information to be presented to the end user filling out the request or action form, such as via a drop-down list. This is well suited to business units that are represented as entities, for which the entity values are frequently changed or added to, and thus are best maintained in a separate entity table instead of being a list of static values that can be manually entered for a drop-down list. For example, a request or action form may contain a field for “Customer,” and any value entered in the field by the end user must match a predefined list of customers in the system. Because the list of customers may be added to or changed frequently, and the business unit “Customer” is an entity with an existing entity table in the system, it is more efficient to use the entity table that contains the customer values as the source of the drop-down list for that field of the request or action form. The values in the “Customer” entity table may be periodically updated in various ways, such as through automated data load processes.

Utilizing entities as fields of a request or action form also allows a set of directly related fields in the form to be automatically filled in, where the end user only needs to fill in one entity field, and the system will populate the directly related fields with the correct data pulled from the entity table or entity assignment or hierarchy tables. For example, a customer may be represented by a unique entity ID such as a customer number, and also a customer name that is more easily recognizable by the end user entering a request or performing an action. The request or action form may be configured to allow the end user to select the customer name as the entity value in a field of the form, and have the corresponding customer number be automatically filled in another field by the system. Utilizing entities as fields of the form further allows the selection of available values in a set of directly related fields in the form to be automatically narrowed down. Using the previous example, in addition to a customer number and name, a customer may also be identified by a customer type. The request or action form may be configured to allow the end user to select the customer type as the entity value in a field of the form, and based on that input the system automatically filter the list of customer names for another field of the form down to only those customers within the selected customer type. This advantage also applies to fields that are not directly related to the entity field, but are nevertheless indirectly related, such that filling in an entity value in a field of the form results in the selection of available values in an indirectly related field being narrowed down. Continuing the previous example, an association may exist within the system between customers and products purchased by that customer. The request or action form may be configured to enable the end user filling out the form to select a customer name as the entity value in a field of the form, and based on that input the system filters the list of products for another field of the form down to only those products associated with that customer.

One of ordinary skill in the art would recognize that these are merely some of the advantages that may be achieved by using one or more entities in fields of a request or action form. The following example illustrates how a configuration user may set up a request or action form having one or more entities, the exemplary tables and description are related to a “Customer” entity and its association with a “Product” entity identified by a “Product Code.” The “Customer” entity is associated with an entity table stored in the workflow or related SPM system 40, 50. As shown in Table 1 below, the entity table (as defined in U.S. application Ser. No. 13/602,423) is configured to store data related to the customer entity, including an explicit entity ID field for “Customer Number” that uniquely identifies each instance of the customer entity. The entity table further includes an internal entity ID field (not shown) that is used by the system to retrieve the data values associated with each instance of the customer entity, as well as “Customer Name” and a “Customer Type” entity attribute fields each containing descriptive information regarding the customer entity.

TABLE 1

| Customer Number | Customer Name | Customer Type |
|---|---|---|
| 100 | Acme, Inc. | New |
| 150 | Allied Services | Existing |
| 050 | Black Technologies | New |
| 080 | CNC, Inc. | Existing |

As shown below in Table 2, each instance of the “customer” entity may be associated with an instance of a “Product” entity using an assignment table to show the relationship between each customer and the type of products they purchase.

TABLE 2

| Customer Number | Product Code |
|---|---|
| 050 | A |
| 050 | B |
| 080 | A |
| 080 | C |

In order for the above advantages with respect to automatic filtering or populating fields of a request or action form to be achieved, the entities used in fields of the request or action form must be associated with each other in an assignment table, such as the one shown in Table 2, or a hierarchy table. Otherwise, there is no clear association between values of two different sets of entities, and no central location to maintain or modify that association as the relationship between values of those entities change over time.

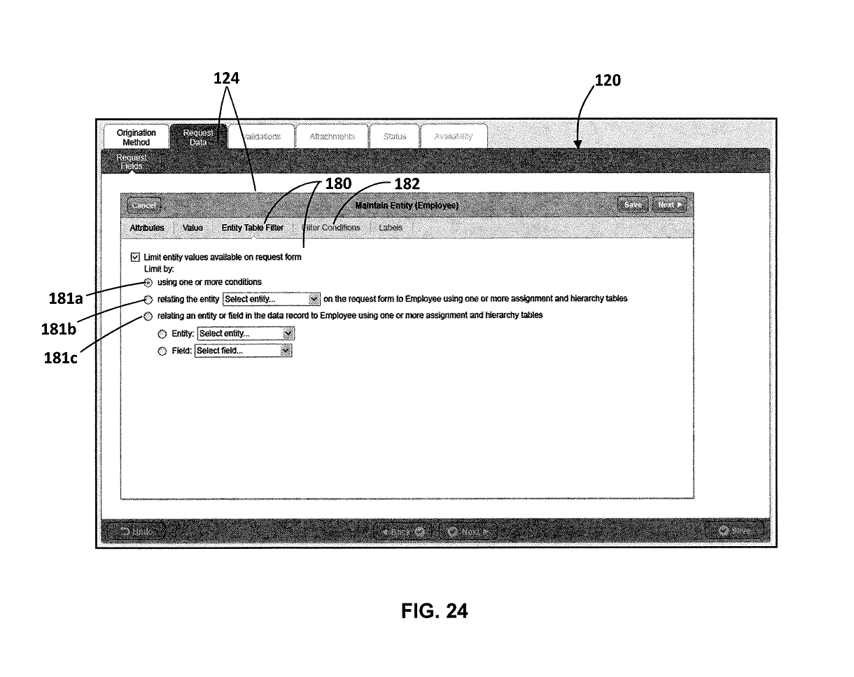

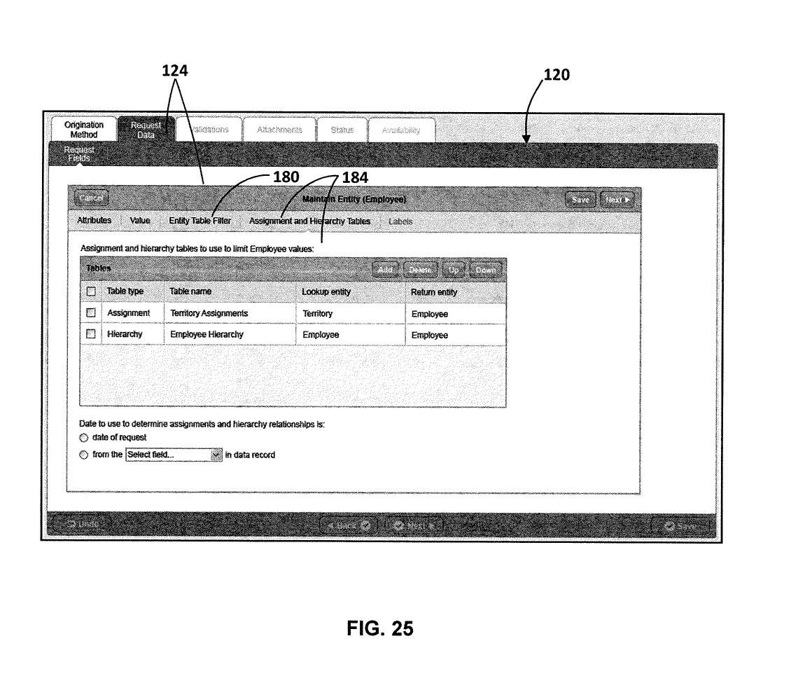

As discussed above and shown in FIG. 8, the request maintenance element 120 may include a request data element 124 that presents options and receives user input for configuring the request form. Similarly, the action maintenance element 160 for defining the details of each action node 96 may include an action fields element 166 for configuring the action form, as shown in FIG. 21. FIGS. 24 and 25 illustrate an exemplary interface that may be included in the request data element 124 or action fields element 166, and provides various elements that may be used to set up each feature of the request or action form. Although the interface shown in FIGS. 24 and 25 and discussed herein relates specifically to the request data element 124, one of ordinary skill in the art would understand that a substantially similar interface may be utilized for the action fields element 166. As shown in FIG. 24, the request data element 124 may include an entity table filter element 180 that is presented as a sub-tab and allows the configuration user to limit the values that may be selected for an entity used as a field in the request form. The configuration user may choose to limit the available entity values in different ways, such as by using one or more conditions, relating the entity used in the request form to another entity using one or more assignment or hierarchy tables, or relating an entity used in the request record to another entity using one or more assignment or hierarchy tables. If the configuration user selects the first option 181a of using one or more conditions, the request data element 124 may be configured to display a filter conditions element 182 presented as a further sub-tab. Although the details of the filter conditions element 182 are not shown, the element may include the same or substantially similar interfaces and functions as the validations element 124 that is used to create validation conditions for requests and shown in FIGS. 9A-9F. If the configuration user selects the second or third option 181b, 181c of using one or more assignment or hierarchy tables to limit the available entity values, the request data element 124 may be configured to display an assignment and hierarchy tables element 184 that is presented as a sub-tab, as shown in FIG. 25. The assignment and hierarchy tables element 184 is configured to present options and receive user input regarding the assignment or hierarchy tables to be used, and where the tables are effective-dated, the dates to use to determine the assignment and hierarchy relationships. As previously discussed with respect to using assignment and hierarchy tables to define a task assignment, the configuration user may utilize the assignment and hierarchy tables element 184 to specify which entity to “look up” in the tables and which entity to “return” from the lookup.

When a single entity is used as a field in a request or action form, the following capabilities may be provided to the configuration user when setting up the request or action form. The configuration user may specify whether the form should automatically display a drop-down list of available entity values in the field that utilizes the entity. For example, if the customer number (i.e., the unique entity ID for the “Customer” entity) is used on the request or action form, a drop-down list of customer number values may be provided in that field so the end user filling out the form does not have to look up and enter a customer number manually. As discussed above with respect to FIGS. 24 and 25, the configuration user may also filter or limit the values shown in the entity drop-down list based on a value in a related record, and its relationship to the entity used in the form based on one or more assignment or hierarchy tables. For example, if the related data record contains the “Customer” entity and the request or action form contains the “Product’ entity, then the list of values in the “Product” field's drop-down list may be limited based on the customer entity value in the related data record, using a “Customer” to “Product” assignment table. If the data record contains the customer number “050,” and the assignment table shown in Table 2 above is used to filter the available values for the “Product” entity, then the drop-down list displayed to the end user for the “Product” field of the request or action form would only contain the values “A” and “B” since those are the only products associated with customer number 050. The configuration user may also specify whether entity attribute values contained in an entity table should be displayed in the request or action form, and if so, what order they should be displayed in. This feature ensures that if an entity's unique entity ID is listed first in the form, selecting an entity ID value from a drop-down list in that field would cause all other entity attribute values for that instance of the entity to be filled in automatically. For example, if the “Customer Number” and “Customer Name” fields for the “Customer” entity are used in that order in the request or action form, selecting the value “100” in the “Customer Number” field will automatically cause “Acme, Inc.” to be filled in the “Customer Name” field, since that customer number uniquely identifies Acme, Inc. in Table 1. If an entity attribute other than the entity ID is listed first in the form, selecting an entity attribute value causes the values in the subsequent entity fields to be limited to only those values that are from entity records that contain the selected entity attribute. For example, if the “Customer Type” and “Customer Number” fields for the “Customer” entity are used in that order in the request or action form, selecting the value “New” in the “Customer Type” field will cause the list of values for the “Customer Number” field to be filtered down to “050” and “100,” since those are the only instance of the customer entity that match the “New” customer type.

Similarly, when more than one entity is used as a field in a request or action form, the configuration user may set up the form to filter the records in one entity (the “subsequent” entity in the form) based on a value selected in the other entity (the “preceding” entity), through the use of one or more assignment tables that relates the values of those two entities. For example, if the “Customer” and “Product” entities are both used in a request or action form, and the “Customer Number” and “Product Code” are used as fields in that order, the assignment table shown in Table 2 may be used to limit the records shown in the drop-down list for the “Product Code” field. If the end user selects the value “080” in the “Customer Number” field, the list of values for the “Product Code” field will be automatically filtered down to “A” and “C” since those are the only product codes associated with that specific customer.

After the configuration user creates and configures a workflow application 42 and one or more associated workflow processes 44 in the manner described above, the configuration user may make the workflow application 42 available to end users to enter requests and act on task assignments. As discussed above, the workflow application 42 is preferably associated with a business application 52 or customized view of the associated SPM system 50, so that the end user may enter requests that direct relate to the data shown in those business applications 52 or customized views. For example and without limitation, if the workflow application 42 is based on a set of data in a table of the associated SPM system 50, the configuration user may make the workflow application 42 and the ability to enter requests available in any data view that utilizes that data table. Similarly, if the workflow application 42 is based on a set of reports in a report list, the configuration user may enable requests to be entered in any reports view that utilizes that report list. The present workflow system 40 or associated SPM system 50 may also provide for a request view, which may be an interface that displays lists of requests to an end user, such as through a customized user portal 54. The request view may show an end user a list of requests that they entered, as well as requests that have been made available to the end user for review. The configuration user may configure the request view to display information related to a request, such as the data record or report on which the request is based, and information regarding actions taken on the request. For request types that are not based on existing data or reports, the request view may include options for entering open-ended requests. The present workflow system 40 or associated SPM system 50 may further provide for a task view, which may be an interface that displays lists of tasks to an end user, such as through a customized user portal 54. The task view may show an end user a list of requests assigned to them, as well as tasks assigned to others where the end user is a manger or administrator with access to such information. The configuration user may configure the task view to display information related to a task, such as the data record or report on which the associated request is based, associated request information such as those from the request form, other tasks associated with the same request, and information regarding actions taken on the tasks created for the request. The task view may also be configured to provide options for the end user to perform actions to complete the assigned tasks.

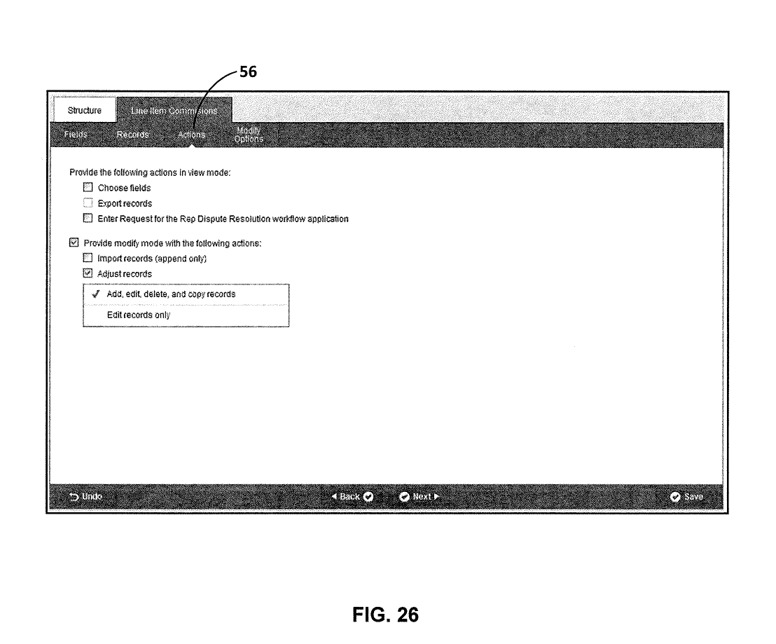

One of ordinary skill in the art would recognize that a variety of interfaces may be utilized to achieve the above functionalities. FIG. 26 illustrates an exemplary interface through which the configuration user may enable the option to enter requests based on a data view. As shown in FIG. 26, a permitted actions menu 56 may be provided as part of the interface for configuring a data view that displays a data table associated with a workflow application. The permitted actions menu 56 may be part of the graphical user interface 80 of the present workflow system 40, or may be part of a different graphical user interface utilized to access the associated SPM system 50. Using the permitted actions menu 56, the configuration user may specify actions that an end user may take on the displayed data table, include entering requests for the associated workflow application. An interface substantially similar to the permitted actions menu 56 may also be provided as part of a reports view, a request view, or a task view to enable the configuration user to control actions that are available to the end user.

As discussed above, the present workflow system 40 allows task assignments, record updates, and email notifications to be carried out on a real-time basis, such that as soon as a request is entered, a task is assigned, or an action is taken, the workflow system 40 automatically creates the necessary record updates and alerts so individuals involved in the workflow process are immediately made aware. Known solutions that rely on a periodic process for generating assignments, updates, and notifications are undesirable for workflows where immediate notifications and responses are important. Once a workflow application 42 and one or more associated workflow processes 44 have been set up in the present workflow system 40 by a configuration user in the manner described above and shown in the figures, one or more end users may utilize the workflow system 40 to enter and resolve requests in an efficient and user-friendly way.

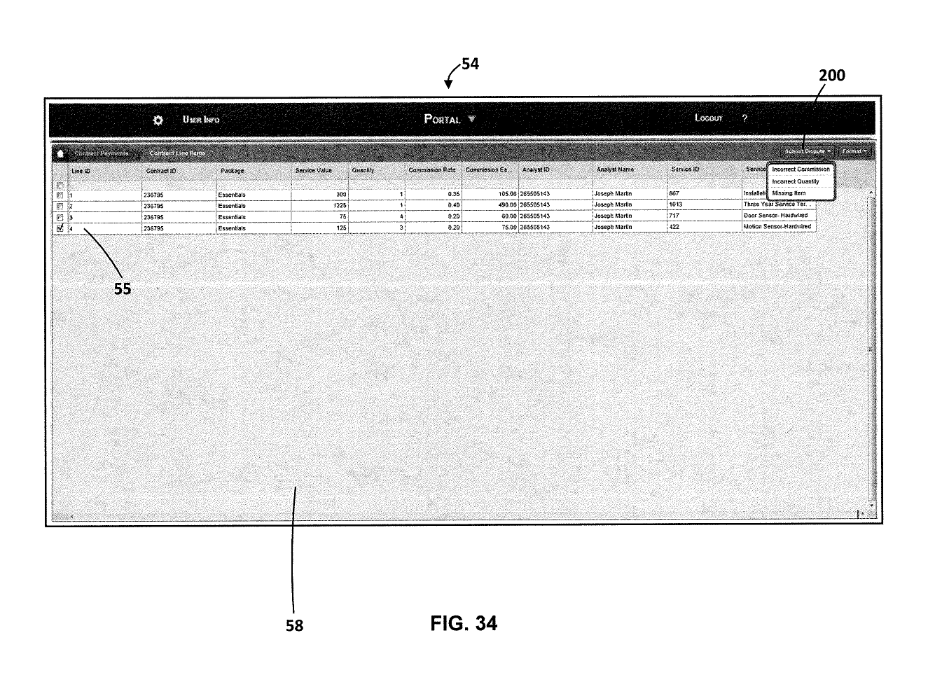

The ability to enter requests may be made available to the end user in a variety of ways, such as through a user portal or within any other element of the workflow system 40 or associated SPM system 50 where it would make sense for a user to enter a request related to information being presented in that element. If the request is based on existing data, the end user may select the applicable data record(s) and enter a request using a simple graphical user interface element similar to the action menu 112 shown in FIG. 7. In the example shown in FIG. 34, the end user may enter a request while viewing records presented in a data view 58 of a customized user portal 54. The data view 58 may be configured to display a plurality of data records that are relevant to the end user. In order to enter a request related to a data record, the end user may select that data record by checking a checkbox, as shown in FIG. 34, and then clicking the request button 200 displayed at the top right hand corner of the data view. Where the request is open ended, the end user may initiate the request in a special request view, which can be achieved using a variety of graphical user interface elements, as would be understood by one of ordinary skill in the art. Since open ended requests do not need to be linked to an existing data record, the request button 200 may be presented in the request view, which may list all the requests that an end user has entered.

As discussed above, the request button 200 may have a custom name defined by the configuration user using the button labels element 108 of the application settings element 100, so that the request button 200 is labeled to make the most sense within the context of a specific data view or request view. In the example shown in FIG. 34, the request button 200 is labeled with a custom name: “Submit Dispute.” After the end user selects a particular data record 55 in the data view 58 by checking the checkbox for that record, the end user may enter a request related to that data record 55 by clicking the Submit Dispute button 200, which may be configured to display one or more available request types 46 via a dropdown menu, similar to the action menu 112 shown in FIG. 7. In this case, the dropdown menu displays “Incorrect Commission,” “Incorrect Quantity,” and “Missing Item” as the available request types 46. As discussed above, the configuration user may specify which request types 46 are displayed in the request button 200 dropdown menu and in what order, by using the availability element 132 of the request maintenance element 120 and the request types order element 104 of the application settings element 100.

After the end user selects a data record 55 and a request type 46 based on that data record 55 by using the request button 200, the workflow system 40 may conduct one or more initial validation checks before presenting the end user with a request form for entering the request. For example and without limitation, if the selected request type 46 is defined to be linked to a record but the end user failed to select a data record using the checkbox, the workflow system 40 may be configured to display an error message alerting the end user to the problem. If the end user selects multiple data records where the selected request type 46 is defined to be linked to a single data record, or if the end user selections a large number of data records where the selected request type 46 is defined to be linked to a maximum number of data records, the workflow system 40 may also display an appropriate error message. Furthermore, if a data record has been modified in the time between when it was displayed to the end user in the data view 58 and when it was selected as the basis for a request, the workflow system 40 may alert the end user and require the data view 58 to be refreshed before a request based on that data record can be entered. One of ordinary skill would recognized that these are merely examples of the types of initial validations that can be performed before the end user is presented with a request form, and that many variations and additional features may be made to these validations.

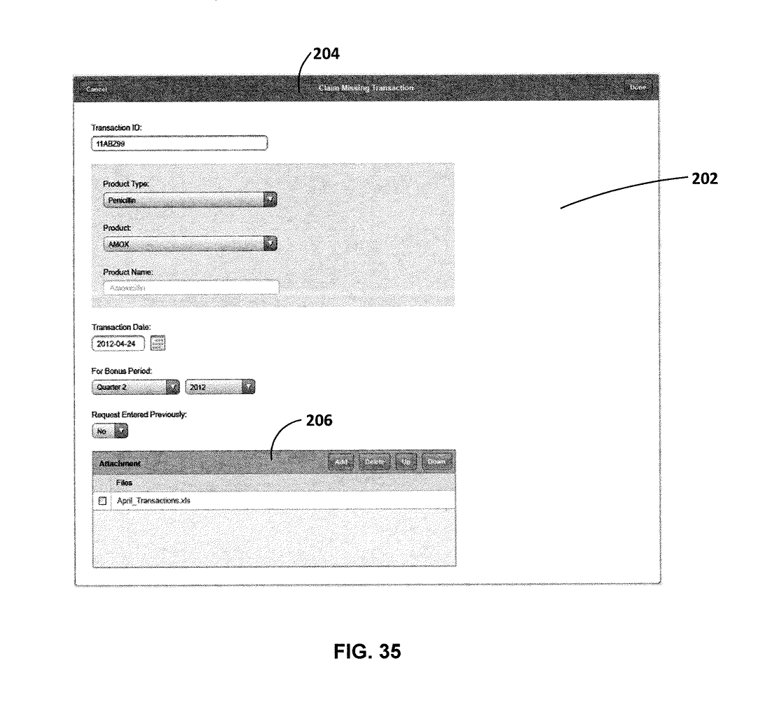

Once the workflow system 40 has conducted any necessary initial validation checks, the end user is presented with a request form having fields configured to capture the information necessary to sufficiently identify, describe, and provide supporting information relevant to the request type 46. As discussed above, where the request type 46 is based on or linked to a data record, some fields of the request form may be automatically filled out with information from the data record. In contrast, where the request type 46 is open ended and not associated with any preexisting data record, the end user may be required to fill out each field of the request form. The contents of the request form may vary depending on the specific request type 46 it is associated with, and may be determined at least in part by the configuration user using the request maintenance element 120. FIG. 35 illustrates an exemplary request form 202 for a request type 46 that is associated with a data record and permits the end user to include attachments with the request. The request form 202 may be displayed to the end user in the user portal 54 of the graphical user interface 80, such that after the end user selects the desired request type 46 using the request button 200, the data view 58 shown in FIG. 34 is replaced with the request form 202 shown in FIG. 35. As shown in FIG. 35, the request form 202 may include a header section 204 that displays the name of the request type 46, as well as options for the end user to cancel or submit the request. In the example shown in FIG. 35, the request form 202 is for a “Claim Missing Transaction” request type 46 that is associated with a data record related to transaction data. The request form 202 includes a number of fields related to the transaction record at issue, such as the transaction ID, product type, product name, transaction date, etc. Some of these fields may be automatically filled in based on information in the associated data record, while other fields may need to be manually filled out by the end user. The request form 202 further includes an attachment section 206 that enables the user to add one or more files that provide additional information regarding the request and are saved in the request record as attachments. After filling out the request form 202 and uploading any attachments, the end user may submit the request by clicking the “Done” button in the header section 204.

After the end user submits the request by filling out the request form 202, the workflow system 40 may perform one or more validations before creating a request record, saving the request form 202 in that request record, and creating any task assignments. As discussed above, using the validations element 126 of the request maintenance element 120, the configuration user may specify one or more custom validation conditions to be checked for when the end user enters and saves a request. If one or more of these custom validation conditions are triggered by information the end user provides, or fails to provide, in the request form, the workflow system 40 may display an associated error message to the end user without saving the request record. In addition to the custom validation conditions, the present workflow system 40 may include system validations that are performed on the request form 202. For example and without limitation, the workflow system 40 may check to determine whether a value has been entered for all required entities and fields in the request form 202, whether the entered value or values are valid for the data type of the entities and fields in the request form, and whether an attachment is present for a request type 46 where the attachment is required. The workflow system 40 may be configured to perform these system validations before any custom validation conditions, and to display corresponding error messages if any of the system validations result in an error. If any system or custom validations fail, the workflow system 40 may be configured to display an error message and cease performing any subsequent validations.

If the request passes all validations and the request type 46 is one that is associated with one or more existing data records, the workflow system 40 may be configured to retrieve all data records associated with the request and creating in real-time a request for each data record that has been retrieved. If the request type 46 is an open-ended request that is not associated with any existing data records, the workflow system 40 may be configured to create a single request. For each request created by the workflow system 40, the following information may be captured and stored in an associated request record saved in the storage device 62: a unique request ID value; the request type; the entity value for the end user entity creating the request (if the request is initiated by an end user and not by the system), i.e., the internal entity ID value; the user ID value of the end user creating the request, i.e., the textual value of the end user's ID; the request creation date and time; the initial status value set for the request; relevant data values from the entities and fields of the request form 202; and any attachments and related data. If a request record could not be successfully created or saved because of an exception that occurred during save (e.g., the data record is linked to an existing request that prevents new requests on the same data record, or an entity value to be captured no longer exists in the entity table), the workflow system 40 may be configured to display an error message.

Once at least one request has been successfully created and saved, the workflow system 40 creates, in real-time, a task record for each task assignment node 94 linked to the request node 92 that represents the request in the flow diagram 90 discussed above. As discussed above, task assignments may also be subject to various conditions, therefore the workflow system 40 will only create a task record in real-time in response to the creation of a request if those conditions for the task assignment are satisfied. By creating task assignments and task records in real-time in response to the creation of a request, the present workflow system 40 allows requests to be processed in a timely and efficient manner, and can alert individuals involved in the process immediately, which is desirable for time-sensitive requests and tasks. For each task assignment created by the workflow system 40, the following information may be captured and stored in the associated task record saved in the storage device 62: a unique task ID value; information relating to the task assignment node 94 for which the task record is being created; information relating to the workflow process 44 within which the task assignment node 94 is defined; the entity or system component that the task is being assigned to; and the task assignment or task record creation date and time. If an error occurs when creating a task assignment (e.g., the entity to which a task is assigned no longer exists in the entity table, or errors when evaluating assignment and hierarchy tables), the workflow system 40 may be configured to display an error message and may not create the request record, the task record, or either record.

As discussed above, the configuration user may set up email notifications using the email notification element 190 to alert end user when a request has been created, updated, or when action needs to be taken on tasks. For example, after a request is created successfully in the workflow system 40, a notification email may be sent in real-time to the end user that entered the request. The workflow system 40 may carry out certain email verifications before sending the notification email, such as checking whether the email notification settings is selected in the notification options element 192, and whether there are any errors in the information provided in the request email statuses element 194, request email header element 196, or request email text element 198. Similarly, after a task assignment and associated task record is created successfully in the workflow system 40, a notification email may be sent in real-time to the entity that is assigned to act on the task, based on the settings and conditions the configuration user has selected using the task email header element 197 and task email text element 199.

After the end user enters a request in the workflow system 40 and the associated request record and one or more task assignments and associated task records are created in real-time, the entities to whom the one or more tasks are assigned may then take action on the task. As discussed above and shown in FIG. 7, the user portal 54 may be configured to present a task view element 110 and displays information regarding tasks assigned to a user. The user to whom a task is assigned (i.e. actor) can select one of the task records displayed in the task view element 110, such as by clicking the record or checking a checkbox next to the record (not shown), and then click on the action menu 112 and select the action that the actor wishes to perform on the task. As further discussed above, the text displayed on the button for the action menu as well as the available actions listed in the action menu 112 may be customized by the configuration user using the button labels element 108 of the application settings element 100. In the example shown in FIG. 7, the action menu 112 is presented as a dropdown menu with the actions “Accept” and “Reject.” Similarly to what was described above with respect to FIG. 34 and the request button 200, the workflow system 40 may conduct one or more initial validation checks before presenting the actor with an action form for performing the selected action. For example and without limitation, if the actor selects an action from the action menu 112 without first selecting a task record, improperly selects multiple task records where the action can only be performed on a single task, or selects a task record on which an action has already been performed, the workflow system 40 may be configured to display a corresponding error message.

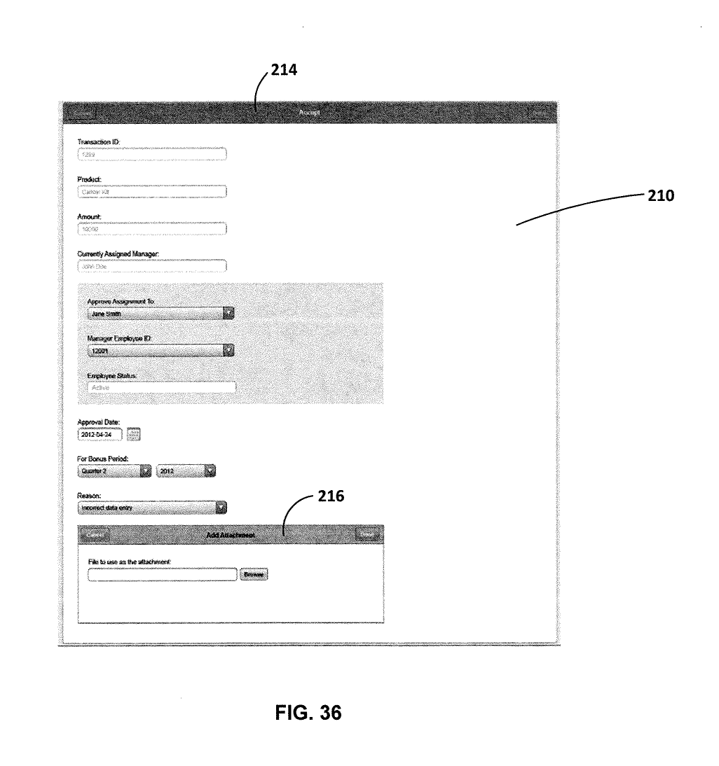

After the actor selects a task record and an available action listed in the action menu 112, the workflow system 40 may conduct one or more additional validations before displaying the action form. For example, if a single task record is selected and values from a related data record or different task record is required to populate a field in the action form, the workflow system 40 may validate that the required values can actually be retrieved. The workflow system 40 may also validate that the action definition as defined by the configuration user using the action maintenance element 160 does not contain any errors, and that proper entity, field, and user values are available for use. If these validations are met, the workflow system 40 may then display an action form to the actor. As discussed above, the action form is designed to capture information from the actor that is necessary to support the action, and may be customized by the configuration user using the action maintenance element 160. FIG. 36 illustrates an exemplary action form 210, which may be displayed to the actor in the user portal 54 of the graphical user interface 80, such that after the actor selects an action from the action menu 112, the task view element 110 shown in FIG. 7 is replaced with the action form 210 shown in FIG. 36.

As shown in FIG. 36, the action form 210 may include a header section 214 that displays the name of the action that has been selected, as well as options for the actor to cancel or submit the action. In the example shown in FIG. 36, the action form 210 is for an “Accept” action that is associated with a task assignment, which is in turn related to a request that may be associated with an existing data record. The action form 210 includes a number of fields related to the action at issue, such as transaction data, who an assignment should be approved to, approval date, reason for the action, etc. Some of these fields may be automatically filled in based on information in the associated task record, request record, or data record, while other fields may need to be manually filled out by the actor. The action form 210 further includes an attachment section 216 that enables the actor to add one or more files that provide additional information regarding the action and are saved with the task record as attachments. After filling out the action form 210 and uploading any attachments, the actor may perform the action on the task by clicking the “Done” button in the header section 214.

After the actor performs the action by filling out and submitting the action form 210, the workflow system 40 may perform one or more system validations and one or more custom validations specified by the configuration user before updating the task record and any associated request record with the action. For example and without limitation, the workflow system 40 may check to determine whether a value has been entered for all require entities and fields in the action form 210, whether the entered value or values are valid for the data type of the entities and fields in the request form, and whether an attachment is present for an action where the attachment is required. The workflow system 40 may also check to ensure that the definition of the action does not contain any errors, that the definition of the workflow process 44 that the action is a part of has not been changed since the action form 210 was accessed, and that if one or more task assignment nodes 94 are linked below the action node 96, the definition of such task assignments do not contain any errors. One or more of these system validations may be performed before any custom validations, and if any system or custom validations fail, the workflow system 40 may be configured to display an appropriate error message and cease performing any subsequent validations.

If the action passes all validations, the workflow system 40 may be configured to retrieve all task records that the action is being performed on, and updating those task records in real-time with information relating to the action that has been performed. The following information may be captured and stored in each associated task record saved in the storage device 62: the action performed; the user ID of the actor that performed the action; the date and time when the action was performed; relevant data values from the entities and fields of the action form 210; and any attachments and related data. In addition, the task record associated with the action is updated in real-time based on the action that was performed on the task, and is marked as completed. Furthermore, if the action being performed on a task also results in a change in the status of the request, such as when an action definitively resolves the request, the corresponding request record may also be updated in real-time with a request status based on the action. As discussed above, the configuration user may specify custom request status names using the action status element 172 of the action maintenance element 160. If an action could not be performed or the task record could not be successfully updated because of an exception that occurred during save (e.g., the selected task record was updated after being retrieved, or an entity value to be captured no longer exists in the entity table), the workflow system 40 may be configured to display an error message.

Once the action is successfully performed for at least one of the selected task records, the workflow system 40 determines whether any additional task assignments and corresponding task records need to be created. As discussed above with respect to the flow diagram 90 that visually represents a workflow process 44, the performance of an action may trigger a subsequent task assignment, which is represented in the flow diagram 90 by creating a task assignment node 94 directly below an action node 96, for example as shown in FIG. 4 where the “Sales Rep Task Assignment” task is triggered by the “Request More Information” action performed on a preceding “Analyst Task Assignment” task assignment node 94. If the subsequent task assignment has no conditions specified or all conditions are satisfied, the workflow system 40 may create in real-time a new task record for that task assignment. The workflow system 40 may also send in real-time any email notifications specified for that task assignment. For each new task record, the same categories of information already discussed above may be captured and stored within the task record. On the other hand, if the action being performed is the last action node 96 in the workflow process 44, such as the “Withdraw Request” action node 96 shown in the flow diagram 90 of FIG. 4, that action resolves the request 92 and concludes the workflow process 44. In that case, the workflow system 40 may in real-time update the task record as being complete, and update the associated request record with the appropriate request status value, such as “request withdrawn,” and send in real-time any email or other forms of notifications specified for that request 92.

One of ordinary skill in the art would appreciate that the graphical user interface 80, including the user portal 54, shown in FIGS. 4-36 is merely one possible embodiment presented for illustrative purposes, and is not intended to serve as limitations of alternative embodiments that would achieve the same purpose. In fact, the graphical user interface 80 may take numerous forms and configurations, and various modifications may be made without affecting its core functionalities. Furthermore, one of ordinary skill in the art would appreciate that although the components of the present workflow system 40 and software 66 are described separately with respect to each component's function, two or more of these components may be part of the same component, and may be executed simultaneously with each other. The components of the software 66 may be, for example and without limitation, in the form of software packages, software modules, software services, or software objects, and may be implemented or embedded within various virtual computer environments or hardware components.

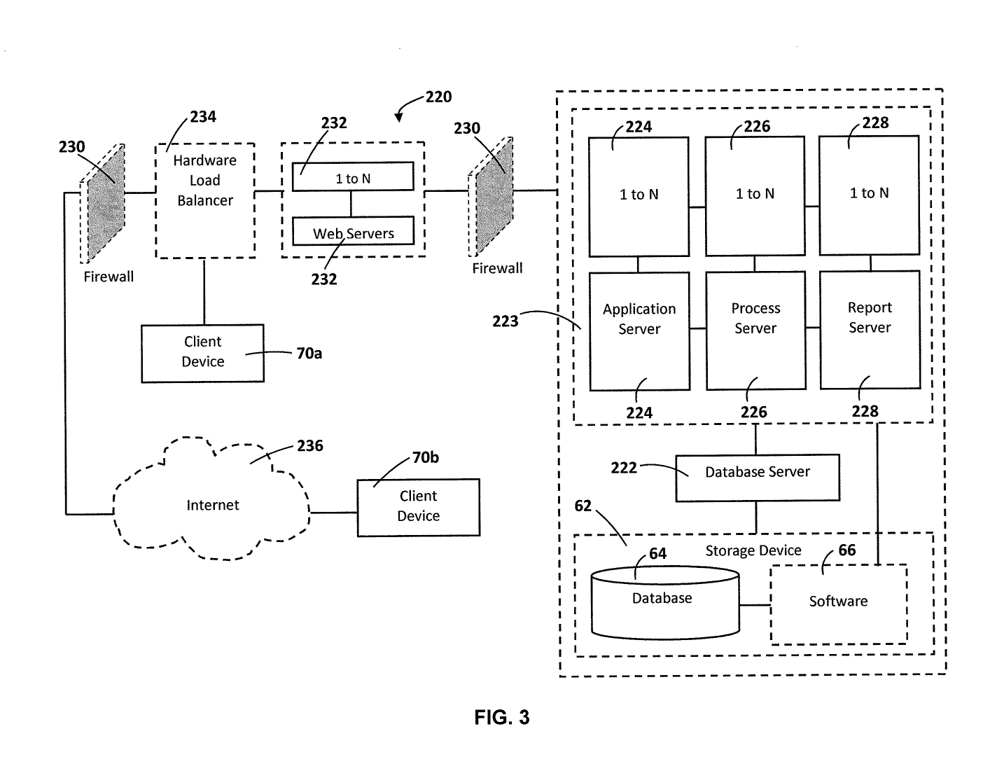

FIG. 3 illustrates an alternative embodiment of a scalable workflow system 220 according to the present application for creating a workflow application in a SPM system, and processing a user request through a workflow process within the workflow application. While the workflow system 40 shown in FIG. 2 represents a simplified configuration, the workflow system 220 shown in FIG. 3 represents a scaled installation that includes redundancy and may be exposed to the internet, which is well suited for environments where there are a large number of users or where there is need for extensive storage and processing capabilities. Elements shown in dotted lines represent optional components and groups within the workflow system 220. Since the workflow system 220 of FIG. 3 includes many of the same elements previously discussed with respect to the workflow system 40 of FIG. 2, the same reference numerals are used to identify the same elements described above. The workflow system 220 includes a storage device 62, which may contain a database 64 and software 66, which may be stored in the same or separate storage components within the storage device 62 and may be in communication with each other. The database 64 is configured to store information related to the workflow system 220 as well as information related to other business applications 52 within an associated SPM system 50. The software 66 includes the components described above with respect to the workflow system 40, which are not repeated here for the sake of brevity.

As further shown in FIG. 3, the storage device 62 may be in communication with a database server 222, which allows other elements of the workflow system 220 to access and read information stored in the database 64. The database server 222 may be in communication with one or more logic servers 223, each of which may be configured to perform a logical function. The logic servers 223 may include an application server 224, a process server 226, and a report server 228, each of which may be made up of a plurality of servers 1 to N and may include one or more processors 60. One of ordinary skill in the art would understand that each one of the servers described with respect to FIG. 3 may be made up of separate servers in communication with each other, or may be combined together on a single physical or virtual server. In addition, the storage device 62, database server 222, and logic servers 223 may all be part of the same physical device. The application server 224 may be configured to permit user interaction with the workflow system 220, and may be scaled as application servers 1 to N based on the number of users, including configuration users and end users. The process server 226 may be configured to perform data manipulations and other computing functions, and may be scaled as process servers 1 to N depending on the amount of processing load on the workflow system 40. The report server 228 may be configured to generate customized reports or other communications based on information in the workflow system 220, and may be scaled as report servers 1 to N based on the requirements of the workflow system 220. Instead of or in addition to being stored in the storage device 62 and accessed by the logic servers 223, the software 66 may be part of one or more of the application, process, and report servers 224, 226, 228.

The logic servers 223 may be in communication with one or more client devices 70, which may access the logic servers 223 through a network such as a local area network (LAN) or the internet. As discussed above with respect to the workflow system 40 of FIG. 2, the client device 70 may include a display device 68 and an input device 69 to allow the user to interact with the workflow system 220. The logic servers 223 may be in communication with a LAN client device 70a through an optional firewall 230, which may be software or hardware based and may be in communication with a web server 232. The web server 232 may be scaled as a plurality of web servers 1 to N, depending on the networking needs of the workflow system 220. Although not a required component of the workflow system 220, the web server 232 may be used to direct users accessing the workflow system 220 to the appropriate application servers 224. The web server 232 may be in communication with an optional hardware load balancer 234, which is a network appliance that balances the load across a plurality of web servers 232, or directly across a plurality of application servers 224 if the system 220 does not include a web server 232. If the workflow system 220 is implemented as a hosted solution where the storage device 62, database server 222, and logic servers 223 are hosted by an organization remotely fro the end users, the firewall 230, web server 232, and hardware load balancer 234 are preferably provided by the hosting organization. The logic servers 223 may further be in communication with an internet client device 70b through another optional firewall 230 that secures the workflow system 220 from the internet 236, through which a user may use the internet client device 70b to access the workflow system 220.

The flow diagram of FIG. 38 illustrates an embodiment of a computer-implemented method 240 of creating a workflow application in a SPM system. Reference numerals for the elements shown in FIGS. 1-37 and discussed above are used for the same elements below, and detailed descriptions of those elements are omitted for sake of brevity. The present method may be implemented, for example and without limitation, in the workflow systems 40, 220 shown in FIGS. 1-3, or in any other computer system having suitable processing and storage capabilities. Portions of the flow diagrams shown in dotted lines represent optional steps or groupings of steps. One of ordinary skill in the art would recognize that while each step of the flow diagrams of FIGS. 38-40 are shown and described separately, multiple steps may be executed in a different order than what is shown, in parallel with each other, or concurrently with each other.

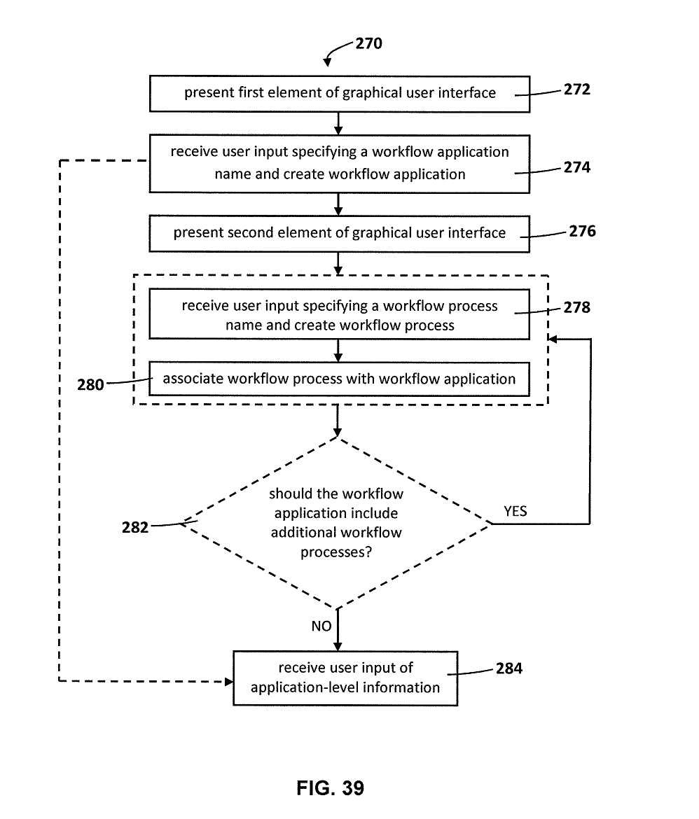

As shown in FIG. 38, the present computer implemented method of creating a workflow application 240 includes a step 242 of presenting a graphical user interface 80 to a configuration user that is setting up the workflow application 42, such as via a display device, and an optional step 243 of receiving a user input specifying elements of the workflow application, which will be described in further detail below and shown in FIG. 39. The present method 240 also includes a step 244 of receiving a user input specifying a request type 46 representing a framework of information to be provided by an end user for a request to be acted upon, a step 246 of receiving a user input specifying a task assignment representing an entity to which a task is assigned for purposes of acting on the request, and a step 248 of associating the task assignment with the request type. As discussed above, the user inputs specifying a request type 46 and a task assignment may be made by the configuration user through the graphical user interface 80, such as the one illustrated in the figures. The method 240 further includes a step 250 of receiving a user input specifying an action to be performed upon the task by the entity to which the task is assigned, a step 252 of associating the action with the task assignment, and a step 254 of presenting a diagram 90 within the graphical user interface 80 that visually represents the request type 46, task assignment, and action as individual nodes 92, 94, 96.

The method 240 may further include a step 256 of receiving a user input of request information related to the request type 46, and a step 258 of associating that request information with the request type 46. As discussed above, this request information may be provided by the configuration user using features of the request maintenance element 120, which may be provided as part of the graphical user interface 80. The steps 256, 268 of receiving the request information and associating the request information with the request type 46 may be performed at any point after the step 244 of receiving user input specifying the request type, as shown in FIG. 38. The method 240 may further include a step 260 of receiving a user input of assignment information related to the task assignment, and a step 262 of associating the assignment information with the task assignment. This assignment information may be provided by the configuration user using features of the task maintenance element 150, and these steps 260, 262 may be performed at any point of the method 240 after the step 246 of receiving user input specifying the task assignment. Similarly, the method 240 may include a step 264 of receiving a user input of action information related to the action to be performed upon the task by the entity to which the task is assigned, and a step 266 of associating the action information with the action specified at step 250 and/or the relevant task assignment that the action is associated with. As discussed above, this action information may be provided by the configuration user using features of the action maintenance element 160.

FIG. 39 illustrates a setup method 270 that may be part of the optional step 243 of receiving a user input specifying the elements of the workflow application. The setup method 270 includes a step 272 of presenting a first element of the graphical user interface 80 configured to enable a workflow application 42 to be added, a step 274 of receiving a user input specifying a workflow application name and creating the workflow application 42, a step 276 of presenting a second element of the graphical user interface 80 configured to enable a workflow process 44 to be added, a step 278 of receiving a user input specifying a workflow process name and creating the workflow process 44, and a step 280 of associating the workflow process 44 with the workflow application 42. As discussed in detail above, the workflow application 42 and workflow process 44 have a parent-child relationship, such that a single workflow application 42 may include multiple workflow processes 44, and certain attributes of the workflow application 42 apply to all associated workflow processes 44. As further shown in FIG. 39, the setup method 270 may also include a step 282 of checking whether the workflow application 42 should include additional workflow processes 44, which may be achieved for example by presenting the option of adding another workflow process 44 to the configuration user. If the workflow application 42 should include multiple workflow processes 44, the setup method 270 returns to the step 276 of presenting a second element of the graphical user interface 80 configured to enable a workflow process 44 to be added and subsequent steps 278, 280. If it is determined that the workflow application 42 should not include additional workflow processes 44 at this time, the setup method 270 proceeds to the step 284 of receiving a user input of application-level information related to the workflow application 42, which may be performed at any point after the step 274 of receiving a user input specifying a workflow application name and creating the workflow application 42. As discussed in detail above, this application-level information may be provided by the configuration user using features of the application settings element 100, which includes various features that may be presented via the graphical user interface 80.

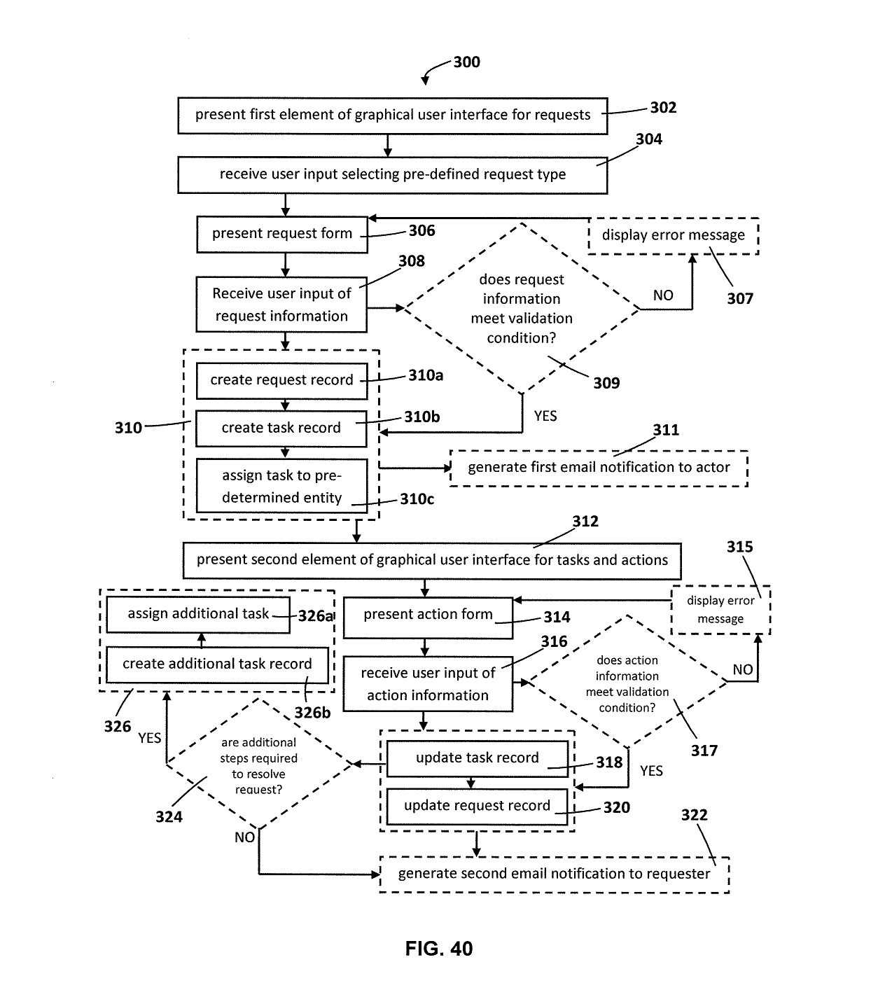

The flow diagram of FIG. 40 illustrates an embodiment of a computer-implemented method 300 of processing a user request through a workflow process in a SPM system. Reference numerals for the elements shown in FIGS. 1-37 and discussed above are used for the same elements below, and detailed descriptions of those elements are omitted for sake of brevity. The present method may be implemented, for example and without limitation, in the workflow systems 40, 220 shown in FIGS. 1-3, or in any other computer system having suitable processing and storage capabilities. Portions of the flow diagrams shown in dotted lines represent optional steps or groupings of steps. The method 300 of processing a user request through a workflow process in a SPM system may be used in conjunction with the method 240 of creating a workflow application shown in FIGS. 38-39 and discussed above, such that after a configuration user creates a workflow application 42 having one or more workflow processes 44, an end user's request is processed through one of those workflow processes 44 in accordance with the method 300 shown in FIG. 40.

As shown in FIG. 40, the present computer-implemented method 300 of processing a user request through a workflow process 44 in a SPM system includes a step 302 of presenting a first element of a graphical user interface 80 via a display device, the first element of the graphical user interface 80 being configured to present guidance and receive user input related to requests. The present method 300 further includes a step 304 of receiving a user input selecting a pre-defined request type 46 representing the user request to be acted upon, a step 306 of presenting a request form 202 via the first element of the graphical user interface 80, the request form 202 being configured to capture information pertaining to the user request, and a step 308 of receiving a user input of request information into the request form 202. The method 300 may also include an optional step 309 of checking whether the request information meets one or more pre-determined validation condition. If the request information does not pass validation, the method 300 proceeds to an optional step 307 of displaying an error message via the graphical user interface 80, without moving on to the remaining steps of the method 300. However, if the request information does pass the validation step 307, upon receiving the user input of request information, the method 300 may include the steps 310 of creating in real-time a request record configured to store information related to the user request (which may include the user input of request information), creating in real-time a task record configured to store information related to a task to be performed upon the user request, and assigning in real-time the task to a pre-determined entity that must act upon the task. As shown in FIG. 40, these steps 310 may be performed simultaneously as one step, or as separate steps 310a, 310b, 310c in any suitable order, not just the specific order shown. Furthermore, the validation step 309 may be part of any one of these steps 310 for creating a request record, creating a task record, and assigning the task.

The present method 300 further includes a step 312 of presenting a second element of the graphical user interface 80 via a display device, the second element of the graphical user interface 80 being configured to present guidance and receive user input related to assigned tasks and available actions that may be performed. The first and second elements of steps 302 and 312 may be presented in the same graphical user interface 80, or via different graphical user interfaces, which may in turn be presented via the same display device or different display devices. Since the user input selecting a pre-defined request type is usually supplied by a first user (the “end user”) and the pre-determined entity that must act upon the task is usually a different second user (the “actor”), the first and second elements of steps 302 and 312 are generally displayed via different display devices, since the end user and actor are likely to be using different computing devices. The method 300 also includes a step 314 of presenting an action form 210 via the second element of the graphical user interface 80, the action form 210 being configured to capture information pertaining to the task and any action performed on the task, and a step 316 of receiving a user input of action information in the action form 210 related to an action that the pre-determined entity has taken upon the task. As shown in FIG. 40, the method 300 may include an optional step 317 of checking whether the action information meets one or more pre-determined validation condition. If the action information does not pass validation, the method 300 proceeds to an optional step 315 of displaying an error message via the graphical user interface 80, without moving on to the remaining steps of the method 300. However, if the action information does pass the validation step 317, upon receiving the user input of action information, the method 300 proceeds to a step 318 of updating in real-time the task record to reflect the action that the pre-determined entity has taken upon the task, and an optional step 320 of updating in real-time the request record to reflect an appropriate request status. The validation step 317 may also be part of the step 318 of updating the task record.

As further shown in FIG. 40, upon assigning the task to a pre-determined entity in step 310c or combined step 310, the present method 300 may include an optional step 311 of generating in real-time a first email notification to that pre-determined entity (the “actor”), so that the actor can be immediately alerted to the task assignment. Similarly, upon updating the request record in step 320, the present method 300 may include an optional step 322 of generating in real-time a second email notification to the first user that entered the request (the “end user”), so that the end user can be immediately alerted to the updated status of the request. One of ordinary skill in the art would recognize that email notifications are merely one way through which the end user and actor may be alerted, and that other forms of alerts may be used with the present method 300, such as user portal alerts, dashboard alerts, mobile alerts, and other suitable means. In addition, the pre-determined entity that must act upon the task assignment does not have to be an individual, and can instead be a component of the SPM system that is configured to take action upon the task based on a set of business rules associated with the task. Upon receiving the action information, the present method 300 may also include the optional step 324 of determining whether any additional steps must be performed to resolve the user request, which may be carried out before, or as a part of, the steps 318, 320 of updating the task record and request record. If an additional step must be performed to resolve the user request, the method 300 proceeds to the steps 326 of creating in real-time an additional task record configured to store information related to an additional task to be performed upon the user request, and assigning in real-time the additional task to a pre-determined entity that must act upon the additional task, which may be individual steps 326a, 326b or part of a single step. The pre-determined entity that must act upon the additional task may be the same user or system component as the pre-determined entity that acted upon the first task, depending on how the configuration user set up the workflow process 44 and request type 46. If it is determined that no additional steps must be performed to resolve the user request, the method 300 may proceed to the step 322 of generating in real-time the second email notification to the end user that entered the request regarding its resolution.

The present invention may also be embodied in a computer software product that includes a non-transitory computer readable storage medium readable by a processor. The computer software product may be implemented in or utilized with, for example and without limitation, the workflow system shown in FIGS. 2-3, or any other computer system having suitable processing and storage capabilities. Reference numerals for the elements shown in FIGS. 1-40 and discussed above are used for the same elements below, and detailed descriptions of those elements are omitted for sake of brevity. A set of instructions for creating a workflow application 42 in a SPM system is stored on the non-transitory computer readable storage medium, the instructions including a first sequence which, when executed by a processor 60, causes the processor 60 to present a graphical user interface 80 via a display device 68, the graphical user interface 80 being configured to present guidance and receive user input related to the workflow application 42. The instructions further includes a second sequence which, when executed by the processor 60, causes the processor 60 to receive a user input specifying a request type 46 representing a framework of information to be provided by an end user for a request to be acted upon. The user input may be received from an input device 69 that may be part of a client device 70. A third sequence of instructions is executable by the processor 60 to receive a user input specifying a task assignment representing an entity to which a task is assigned for purposes of acting on the request, and a fourth sequence of instructions is executable by the processor 60 to associate the task assignment with the request type 46. The instructions also include a fifth sequence of instructions executable by the processor 60 to receive a user input specifying an action to be performed on the task by the entity to which the task is assigned, a sixth sequence of instructions executable by the processor 60 to associate the action with the task assignment, and a seventh sequence of instructions executable by the processor to present a diagram 90 within the graphical user interface 80 that visually represents the request type, task assignment, and action as individual nodes 92, 94, 96.

A further set of instructions for processing a user request through a workflow process 44 in a SPM system is stored on the non-transitory computer readable storage medium, the instructions including a first sequence which, when executed by the processor 60, causes the processor 60 to present a first element of a graphical user interface 80 via a display device 68, the first element of the graphical user interface 80 being configured to present guidance and receive user input related to requests. The instructions further include a second sequence of instructions executable by the processor 60 to receive a user input selecting a pre-defined request type representing the user request to be acted upon, a third sequence of instructions executable by the processor 60 to present a request forth 202 via the first element of the graphical user interface 80 that is configured to capture information pertaining to the user request, and a fourth sequence of instructions executable by the processor 60 to receive a user input of request information into the request form 202. A fifth sequence of instructions is executable by the processor, upon receiving the user input of request information, to create in real-time a request record configured to store information related to the user request, create in real-time a task record configured to store information related to a task to be performed upon the user request, and to assign in real-time the task to a pre-determined entity that must act upon the task. The instructions further include a sixth sequence of instructions executable by the processor 60 to present a second element of the graphical user interface 80 via a display device 68, the second element of the graphical user interface 80 being configured to present guidance and receive user input related to assigned tasks and available actions, a seventh sequence of instructions executable by the processor 60 to present an action form 210 via the second element of the graphical user interface 80 to capture information pertaining to the task and any action performed on the task, and an eighth sequence of instructions executable by the processor 60 to receive a user input of action information in the action form 210 relating to an action that the pre-determined entity has taken upon the task. Finally, the instructions include a ninth sequence of instructions executable by the processor 60, upon receiving the action information, to update in real-time the task record to reflect the action performed on the task, and to update in real-time the request record to reflect an appropriate request status.

One of ordinary skill in the art would appreciate that the workflow systems 40, 220 and methods 240, 300 illustrated and described herein are merely representatives of systems and methods that may embody the present invention, and that various other system types, configurations, and methods are also suitable for use with the invention. The software and hardware components described above with respect to systems 40, 220 may also take on other variations, modifications, and alternatives without departing from the spirit of the present application. Some examples and variations of these software and hardware components are discussed below.

The storage device 62 shown in FIGS. 2-3 may be or include a memory device such as a Dynamic Random Access Memory (D-RAM), Static RAM (S-RAM), other RAM, a flash memory, or any other suitable computer-readable medium. The storage device 34 may further be or include a hard disk, a solid-state drive (SSD), a magnetic recording apparatus, a magneto-optical medium, an optical medium such as a compact disc-read only memory (CD-ROM), a digital versatile disk (DVD), a Blue-Ray disk (BD), or any other type of computer-readable medium or suitable device for electronic data storage. As used herein, the term “computer-readable medium” broadly refers to any storage medium that may store or transfer information, including volatile, nonvolatile, removable, and non-removable media. Specifically, computer-readable medium may include a non-transitory computer readable storage medium.

The database 64 shown in FIGS. 2-3 may be spread across one or more non-transitory computer-readable mediums, and may be or include one or more relational databases, hierarchical databases, object-oriented databases, one or more flat files, one or more spreadsheets, and/or one or more structured files. The database 64 may be managed by one or more database management systems, which may be based on a technology such as, for example and without limitation, Microsoft SQL Server, MySQL, PostgreSQL, Oracle Relational Database Management System (RDBMS), a NoSQL database technology, or any other appropriate technologies. The database 64 may include a number of different types of data that are used by the present system, method, and computer software product.

As used herein, the Wan “processor” broadly refers to any unit, module, or machine capable of executing a sequence of instructions. The processor 60 shown in FIG. 2 and the process server 226 shown in FIG. 3 may be or include, for example and without limitation, a single-core or multi-core processor, a general purpose processor, a special purpose processor, a conventional processor, a Graphics Processing Unit (GPU), a digital signal processor (DSP), one or a plurality of microprocessors, one or more microprocessors associated with a DSP core, a controller, a microcontroller, one or more Application Specific Integrated Circuits (ASICs), one or more Field Programmable Gate Array (FPGA) circuits, any other type of integrated circuit (ID), a system-on-a-chip (SOC), a Complex Instruction Set Computer (CISC), a Reduced Instruction Set Computer (RISC), or a state machine.

The display device 68 that may be embodied in a client device 70 as shown in FIGS. 2-3 may be or include, for example and without limitation, a monitor or television display, a plasma display, a liquid crystal display (LCD), or a display based on a technology such as front or rear projection, light emitting diodes (LEDs), organic light-emitting diodes (OLEDS), or Digital Light Processing (DLP). The display device interface may operate using technology such as Video Graphics Array (VGA), Super VGA (S-VGA), Digital Visual Interface (DVI), High-Definition Multimedia Interface (HDMI), or any other appropriate technologies. A display device interface may be used to communicate display data from the processor 60 to the display device 68 to be displayed by the display device. The display device 68 may also be external to the client device 70 and coupled to the client device 70 via a display device interface.

The input device 69 that may be embodied in a client device 70 as shown in FIGS. 2-3 may be or include, for example and without limitation, a keyboard, mouse, trackball, pointing stick, touch screen, touch pad, stylus pad, or other suitable devices. The input device 69 may be configured to communicate with the processor 60 or the client device 70 using various peripheral device interface technologies, such as a Universal Serial Bus (USB), PS/2, Bluetooth, infrared, serial port, parallel port, or any other appropriate technologies.

The graphical user interface 80 shown in FIGS. 4-37 may be displayed to the user via the display device 68, and more specifically through a web browser module. The web browser module may include or communicate with one or more sub-modules that perform functionality such as rendering HTML (including HTML5), rendering raster and/or vector graphics, executing JavaScript, and/or rendering multimedia content. The web browser module and its sub-modules may also implement technologies such as Rich Internet Application (RIA), Adobe Flash, Microsoft Silverlight, or any other appropriate multimedia technologies. These multimedia technologies may be implemented using one or more web browser plug-in modules and/or by using one or more sub-modules within the web browser module itself.

The client device 70 shown in FIGS. 2-3 may be or include, for example and without limitation, a desktop computer, a laptop computer, a netbook, a tablet computer, a personal digital assistant (PDA), a cellular phone such as a smartphone, or any other appropriate device. The client device 70 may include the display device 68 and input device 69, as well as a processor, memory device, communication interface, peripheral device interface, display device interface, storage device, and various other components. FIG. 37 shows a tablet computer 218 that is a more specific example of the client device 70 of FIGS. 2-3. The tablet computer 218 may include a processor (not depicted), memory device (not depicted), storage device (not depicted), and touch screen display 219, which may possess characteristics of the display device 68 and input device 69, as described above with respect to FIGS. 2 and 3. The touch screen display 219 may receive user input using technology such as, for example and without limitation, resistive sensing technology, capacitive sensing technology, optical sensing technology, or any other appropriate touch-sensing technology. The touch screen display 219 may also be configured to display the graphical user interface 80, such as through a web browser interface.

Although the present system, method, and computer software product has been described using examples relating to sales performance management and sales compensation management, the features described above with respect to the present invention are also applicable to and may be used by, mutatis mutandis, any type of business organization, non-business organization, or individual for any suitable purpose.

Furthermore, while features and elements of the present system, method, and computer software product are described in particular combinations, it is to be appreciated that each feature or element can be used alone or in any combination with or without the other features and elements. Any single embodiment described herein may be supplemented with one or more elements from any one or more of the other embodiments described herein. Any single element of an embodiment may be replaced with one or more elements from any one or more of the other embodiments described herein. For example, each feature or element as described herein with reference to any one of FIGS. 1-40 may be used alone without the other features and elements or in various combinations with or without other features and elements from each or any combinations of the other figures from FIGS. 1-40. Each or any combination of features described herein with reference to FIGS. 1-40 may be considered optional. Sub-elements of the methods and features described herein with reference to FIGS. 1-40 may be performed in any arbitrary order (including concurrently) in any combination or sub-combination.

What is claimed is:

1. A method of creating a workflow application for use by an end user in a sales performance management system, the method comprising:
providing, on a display device, a graphical user interface configured to present guidance to a creator of the workflow application and receive creator input related to creation of the workflow application;
receiving, from the creator using the graphical user interface, a first input specifying a request type, the request type representing a framework of information to be selected by the end user for a request to be acted upon, the request type being provided as a menu option to the end user upon execution of the completed workflow application by the end user;
receiving, from the creator using the graphical user interface, a second input specifying a task assignment, the task assignment representing an entity to which a task is assigned by the creator for purposes of acting on the request selected by the end user during execution of the completed workflow application;
associating, by the creator using the graphical user interface, the task assignment with the request type;
receiving, from the creator using the graphical user interface, a third input specifying an action to be performed upon the task by the entity to which the task is assigned by the creator;
associating, by the creator using the graphical user interface, the action with the task assignment; and
presenting, to the creator via the graphical user interface, a diagram that visually represents the request type, task assignment, and action as individual nodes and that visually represents the association between the request type and the task assignment and the association between the task assignment and the action.

2. The method of claim 1, wherein the receipt of the first, second, and third inputs includes receiving a custom creator-specified name for the request type, task assignment, or action.

3. The method of claim 1, further comprising:
receiving, from the creator using the graphical user interface, request information related to the request type and associating the request information with the request type;
receiving, from the creator using the graphical user interface, assignment information related to the task assignment and associating the assignment information with the task assignment; and
receiving, from the creator using the graphical user interface, action information related to the action and associating the action information with the action.

4. The method of claim 3, wherein the receiving of the request information, task assignment information, and action information includes displaying a maintenance element of the graphical user interface and receiving a user input of information via the maintenance element

5. The method of claim 3, wherein the receiving of the request information, task assignment information, and action information is performed after the receipt of the first, second, and third inputs.

6. The method of claim 3, wherein at least one of the request information, the task assignment information, or action information comprises pre-existing information within the sales performance management system.

7. The method of claim 1, wherein the diagram within the graphical user interface comprises a flow diagram, and the nodes representing the request type, task assignment, and action are connected by lines that visually represent associations between the request type, task assignment, and action.
